(19) United States
(12) Patent Application Publication
(10) Pub. No.: US 2026/0251961 A1
(43) Pub. Date: Aug. 27, 2026

(54) CAMERA ACTUATOR AND CAMERA MODULE INCLUDING SAME

(71) Applicant: LG INNOTEK CO., LTD., Seoul (KR)

(72) Inventor: Sung Guk LEE, Seoul (KR)

(21) Appl. No.: 18/872,622

(22) PCT Filed: Jun. 2, 2023
(86) PCT No.: PCT/KR2023/007634

§ 371 Date: Dec. 6, 2024

(30) Foreign Application Priority Data
Jun. 9, 2022 (KR) 10-2022-0070214
Jun. 10, 2022 (KR) 10-2022-0070848

(51) Int. Cl. G03B 17/17

(52) U.S. Cl. CPC G03B 17/17

(57) ABSTRACT

An embodiment of the present invention provides a camera actuator comprising: a housing; a mover that includes a holder and an optical member disposed on the holder; a driving unit for moving the mover, and a tilting guide unit which is disposed between the housing and the mover and guides the tilting of the mover. The housing includes a housing wall portion disposed on a side portion corresponding to a light-emitting surface of the optical member, the optical member changes the path of light from a first direction to a second direction, and the housing wall portion at least partially overlaps with the holder in the second direction.

### TECHNICAL FIELD

The present invention relates to a camera actuator and a camera module including the same.

### BACKGROUND ART

A camera is a device that captures images or videos of a subject, and is mounted on portable devices, drones, vehicles, and the like. In order to improve image quality, a camera module may have an image stabilization (IS) function for compensating for or preventing image shaking caused by the movement of the user, an auto-focusing (AF) function for automatically adjusting the distance between an image sensor and a lens to align the focal length of the lens, and a zooming function for photographing a distant subject by increasing or decreasing the magnification using a zoom lens.

However, in performing a hand-shake prevention function within the camera module, a collision absorption structure is required to suppress damage or the like of a mover generated due to collision. Furthermore, a structure that can easily control the moving radius of the mover is required, and there is also an increasing demand for preventing inflow of foreign substances into the camera module, suppressing leakage flux, and increasing posture holding force.

In addition, when all the zooming function, AF function, and OIS function are included in the camera module, there is a problem in that flare or the like occurs as some of light goes out of the effective area according to change in the path of light of the OIS.

### DISCLOSURE

### Technical Problem

An object of the present invention to solve the technical problems is to provide a camera actuator and a camera device with improved reliability owing to absorption of impact that occurs during the driving for OIS.

In addition, the present invention may provide a camera actuator and a camera device that easily prevent inflow of foreign substances.

In addition, the present invention may provide a camera actuator and a camera device that suppress leakage flux and improve the holding force.

In addition, the present invention may provide a camera actuator and a camera device with minimized flare generation.

In addition, the present invention may provide a camera actuator with minimized optical problems that occur by an optical member in an OIS camera actuator, and a camera device including the same.

Another object of the present invention to solve the technical problems is to provide a camera actuator that can be applied to an ultra-slim, ultra-small, and high-resolution camera.

The problems to be solved in the embodiment are not limited thereto, and it can be said that the objects or effects that can be grasped from the solutions of the problems or embodiments described below are also included.

### Technical Solution

A camera actuator according to an embodiment of the present invention comprises: a housing; a mover including a holder and an optical member disposed on the holder; a driving unit for moving the mover; and a tilting guide unit disposed between the housing and the mover to guide tilting of the mover, wherein the housing includes a housing wall unit disposed on a side unit corresponding to a light-emitting surface of the optical member, the optical member changes a path of light from a first direction to a second direction, and the housing wall unit is at least partially overlapped with the holder along the second direction.

The camera actuator may further comprise: a first magnetic body disposed in the housing; and a second magnetic body disposed to face the first magnetic body, wherein the tilting guide unit may be pressed toward the mover by a repulsive force of the first magnetic body and the second magnetic body.

The housing may include a first member disposed on one side, the mover may include a second member penetrating the first member, and the tilting guide unit may be disposed between the first member and the mover.

the first member may include a second groove located on an outer side surface, the second member may include a first groove facing the second groove, the first magnetic body may be disposed in the second groove, and the second magnetic body may be disposed in the first groove.

The second magnetic body, the first magnetic body, and the tilting guide unit may be sequentially disposed along the second direction.

The distance between the first magnetic body and the second magnetic body may be larger than the distance between the holder and the housing wall unit.

The camera actuator may further comprise a plate disposed the outer side the first member.

The area of the plate may be larger than the area of the first member or the area of the second member, and the plate may be a non-magnetic body.

The plate is a magnetic body, and the second magnetic body may have a polarity the same as that of the first magnetic body on a side facing the first magnetic body, and have a polarity different from that of the plate on a side facing the plate.

The housing wall unit may not be overlapped with the optical member along the second direction.

The driving unit may include a first magnet, a second magnet facing the first magnet, and a third magnet disposed between the second magnet and the second magnet.

The housing wall unit may be overlapped with at least one among the first magnet and the second magnet along the second direction.

The housing wall unit may not be overlapped with the second member in the second direction.

The housing wall unit may include a housing extension unit extended to the top of the holder.

The distance between the housing extension unit and the holder may be smaller than the distance between the first member and the second member.

When the housing wall unit is in contact with the holder, the first member may be separated from the second member.

The holder may include a first holder outer side surface adjacent to the first magnet and a second holder outer side surface adjacent to the second magnet, and the housing wall unit may be overlapped with the first holder outer side surface or the second holder outer side surface in the second direction.

The housing wall unit may not be overlapped with the first magnetic body and the second magnetic body in the second direction.

A camera actuator according to an embodiment of the present invention comprises: a housing; a mover including a holder and an optical member disposed on the holder; a driving unit for moving the mover; and a tilting guide unit disposed between the housing and the mover to guide tilting of the mover, wherein the housing may include a first member disposed on one side, the mover may include a second member penetrating the first member, the camera actuator may further comprise a plate disposed in the first member, the camera actuator may further comprise a first magnetic body disposed in the first member; and a second magnetic body disposed in the second member to face the first magnetic body, wherein the tilting guide unit may be pressed toward the mover by a repulsive force of the first magnetic body and the second magnetic body.

The plate is adjacent to the second magnetic body rather than the first magnetic body, and may form an attractive force with the second magnetic body.

A camera actuator according to an embodiment of the present invention comprises: a housing; a mover including a holder and an optical member disposed on the holder; and a tilting guide unit disposed between the housing and the mover to guide tilting of the mover, wherein the holder includes an inclined surface facing the optical member and a plurality of holder grooves extended along at least one among one side or the other side of the inclined surface.

The optical member may include an incident surface, a reflection surface, and a light-emitting surface in contact with the reflection surface and the incident surface.

The plurality of holder grooves may include first holder grooves extended along one side of the inclined surface.

The inclined surface may face the reflection surface.

The inclined surface may be disposed to be spaced apart from the reflection surface by a predetermined distance.

The first holder groove may include a first groove region overlapped with the effective area of the light-emitting surface, and a second groove region not overlapped with the effective area of the light-emitting surface.

The area of the first groove region may be larger than the area of the second groove region.

The second groove region may surround the first groove region.

The separation distances between adjacent first holder grooves may be the same.

The first holder groove may include a first groove surface and a second groove surface in contact with the first groove surface.

The first groove surface may be side by side with the light-emitting surface, and the second groove surface may be side by side with the incident surface.

The first distance may be larger than the second distance, the first distance may be the distance between the edge where the first groove surface and the second groove surface meet and the reflection surface, and the second distance may be the minimum distance between the first groove surface or the second groove surface and the reflection surface.

The angle formed by the first groove surface and the second groove surface may be 80 to 110 degrees.

The plurality of holder grooves may include a second holder groove extended along the other edge of the inclined surface.

The optical member may include a prism.

### Advantageous Effects

According to an embodiment of the present invention, a camera actuator and a camera device with improved reliability owing to absorption of impact that occurs during the driving for OIS are implemented.

In addition, the present invention may implement a camera actuator and a camera device that easily prevent inflow of foreign substances.

In addition, the present invention may implement a camera actuator and a camera device that suppress leakage flux and improve the holding force.

In addition, the present invention may implement a camera actuator and a camera device with minimized flare generation.

In addition, the present invention may implement a camera actuator with minimized optical problems that occur by an optical member in an OIS camera actuator, and a camera device including the same.

The technical problem to be solved by the present invention is to implement a camera actuator that can be applied to an ultra-slim, ultra-small, and high-resolution camera.

The various and beneficial advantages and effects of the present invention are not limited to the descriptions provided above, and will be more easily understood in the process of explaining specific embodiments of the present invention.

### DESCRIPTION OF DRAWINGS

FIG. 1 is a perspective view showing a camera module according to an embodiment.

FIG. 2 is an exploded perspective view showing a camera module according to an embodiment.

FIG. 3 is a view taken along the line AA′ in FIG. 1.

FIG. 4 is a perspective view showing a first camera actuator according to an embodiment.

FIG. 5 is an exploded perspective view showing a first camera actuator according to an embodiment.

FIG. 6a is a perspective view showing a first housing of a first camera actuator according to an embodiment.

FIG. 6b is a perspective view showing the first housing of FIG. 6a in a different direction.

FIG. 6c is a front view showing a first housing of a first camera actuator according to an embodiment.

FIG. 6d is a rear view showing a first housing of a first camera actuator according to an embodiment.

FIG. 6e is a top view showing a first housing of a first camera actuator according to an embodiment.

FIG. 7a is a perspective view showing an optical member of a first camera actuator according to an embodiment.

FIG. 7b is a top view showing an optical member of a first camera actuator according to an embodiment.

FIG. 7c is a side view showing an optical member of a first camera actuator according to an embodiment.

FIG. 8a is a perspective view showing a holder of a first camera actuator according to an embodiment.

FIG. 8b is a bottom view showing a holder of a first camera actuator according to an embodiment.

FIG. 8c is a front view showing a holder of a first camera actuator according to an embodiment.

FIG. 8d is a rear view showing a second member of a first camera actuator according to an embodiment.

FIG. 8e is a bottom view showing a second member of a first camera actuator according to an embodiment.

FIG. 8f is a perspective view showing a holder of a first camera actuator according to another embodiment.

FIG. 8g is a bottom view showing a holder of a first camera actuator according to another embodiment.

FIG. 8h is a front view showing a holder of a first camera actuator according to another embodiment.

FIG. 8i is a rear view showing a second member of a first camera actuator according to another embodiment.

FIG. 8j is a bottom view showing a second member of a first camera actuator according to another embodiment.

FIG. 8k is a perspective view showing a holder and an optical member according to a first embodiment.

FIG. 8l is a perspective view and a cross-sectional view showing a holder and an optical member according to a first embodiment.

FIG. 8m is a side view showing a holder and an optical member according to a first embodiment.

FIG. 8n is a perspective view showing a holder according to a first modified embodiment.

FIG. 8o is a side view showing a holder and an optical member according to a first modified embodiment.

FIG. 8p is a perspective view showing a holder and an optical member according to a second modified embodiment.

FIG. 8q is a perspective view and a cross-sectional view showing a holder and an optical member according to a second embodiment.

FIG. 8r is a side view showing a holder and an optical member according to a second embodiment.

FIG. 8s is a side view showing a holder and an optical member according to a second modified embodiment.

FIG. 8t is a perspective view showing a holder and an optical member according to a third embodiment.

FIG. 8u is a perspective view and a cross-sectional view showing a holder and an optical member according to a third embodiment.

FIG. 8v is a perspective view and another cross-sectional view showing a holder and an optical member according to a third embodiment.

FIG. 8w is a side view showing a holder and an optical member according to a third embodiment.

FIG. 8x is a side view showing a holder and an optical member according to a third modified embodiment.

FIG. 8y is a view explaining the effect of a holder and an optical member according to an embodiment.

FIG. 9a is a perspective view showing a tilting guide unit of a first camera actuator according to an embodiment.

FIG. 9b is a perspective view showing the tilting guide unit of FIG. 9a in a different direction.

FIG. 9c is a view taken along the line FF′ in FIG. 9a.

FIG. 10 is a view showing a first driving unit of a first camera actuator according to an embodiment.

FIG. 11a is a perspective view showing a first camera actuator according to an embodiment.

FIG. 11b is a view taken along the line PP′ in FIG. 11a.

FIG. 11c is a view taken along the line QQ′ in FIG. 11a.

FIG. 11d is a rear view showing a first camera actuator according to an embodiment.

FIG. 11e is a top view showing a first camera actuator according to an embodiment.

FIG. 12a is a perspective view showing a first camera actuator according to an embodiment.

FIG. 12b is a view taken along the line SS′ in FIG. 12a.

FIG. 12c is an exemplary view showing movement of the camera actuator shown in FIG. 12b.

FIG. 13a is a view taken along the line RR′ in FIG. 12a.

FIG. 13b is an exemplary view showing movement of the camera actuator shown in FIG. 13a.

FIG. 13c is a view showing collision of a housing wall unit with respect to movement of the first camera actuator shown in FIG. 13a.

FIG. 14 is a perspective view showing a second camera actuator according to an embodiment.

FIG. 15 is an exploded perspective view showing a second camera actuator according to an embodiment.

FIG. 16 is a view taken along the line DD′ in FIG. 14.

FIGS. 17a, 17b, and 17c are perspective views showing a second housing in a second camera actuator according to an embodiment.

FIGS. 18 and 19 are views each explaining the operation of a lens assembly according to an embodiment.

FIG. 20 is a view explaining the operation of a second camera actuator according to an embodiment.

FIG. 21 is a schematic view showing a circuit board according to an embodiment.

FIG. 22 is a perspective view showing a first lens assembly, a first bonding member, a second bonding member, and a second lens assembly according to an embodiment.

FIG. 23 is a perspective view showing a mobile terminal to which a camera module according to an embodiment is applied.

FIG. 24 is a perspective view showing a vehicle to which a camera module according to an embodiment is applied.

### MODE FOR INVENTION

As the present invention may have various modifications and various embodiments, specific embodiments will be illustrated and described in the drawings. However, this is not intended to limit the present invention to the specific embodiments, and should be understood to include all modifications, equivalents, and substitutes included in the spirit and technical scope of the present invention.

Although terms that include ordinal numbers, such as second, first, and the like, may be used to describe various components, the components are not limited by the terms. The terms are used only to distinguish one component from another. For example, a second component may be named a first component, and similarly, a first component may also be named a second component without departing from the scope of the present invention. The term and/or includes any combination of a plurality of related items described herein or any item among a plurality of related items described herein.

When it is mentioned that a component is “connected” or “coupled” to another component, it should be understood that it may be directly connected or coupled to another component, but there may be other components provided in between. On the other hand, when it is mentioned that a component is “directly connected” or “directly coupled” to another component, it should be understood that there are no other components in between.

The terms used in this application are used only to describe specific embodiments and are not intended to limit the present invention. Singular expressions include plural expressions unless the context clearly indicates otherwise. In this application, it should be understood that terms such as “include”, “have”, and the like are intended to specify the presence of a feature, number, step, operation, component, part, or combination thereof described in the specification, and do not exclude in advance the possibility of the presence or addition of one or more other features, numbers, steps, operations, components, parts, or combinations thereof.

Unless otherwise defined, all terms used herein, including technical or scientific terms, have the same meaning as commonly understood by those skilled in the art. Terms defined in commonly used dictionaries should be interpreted as having a meaning consistent with the meaning in the context of the relevant art, and will not be interpreted in an ideal or excessively formal sense unless clearly defined in this application.

Hereinafter, embodiments will be described in detail with reference to the attached drawings. Regardless of the symbols in the drawings, the same reference numerals are given to identical or corresponding components, and redundant descriptions thereof will be omitted.

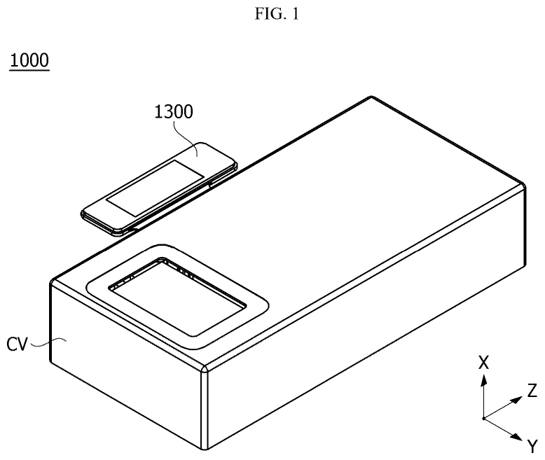

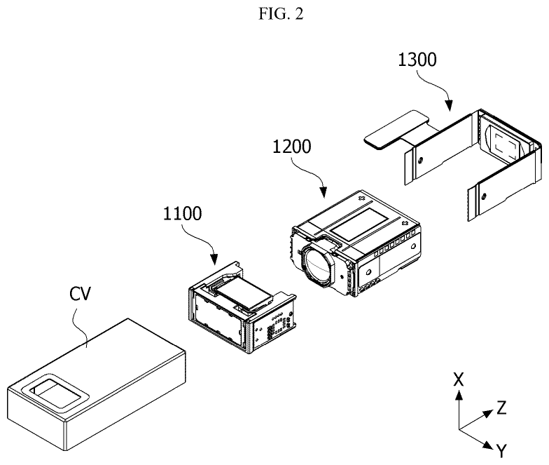

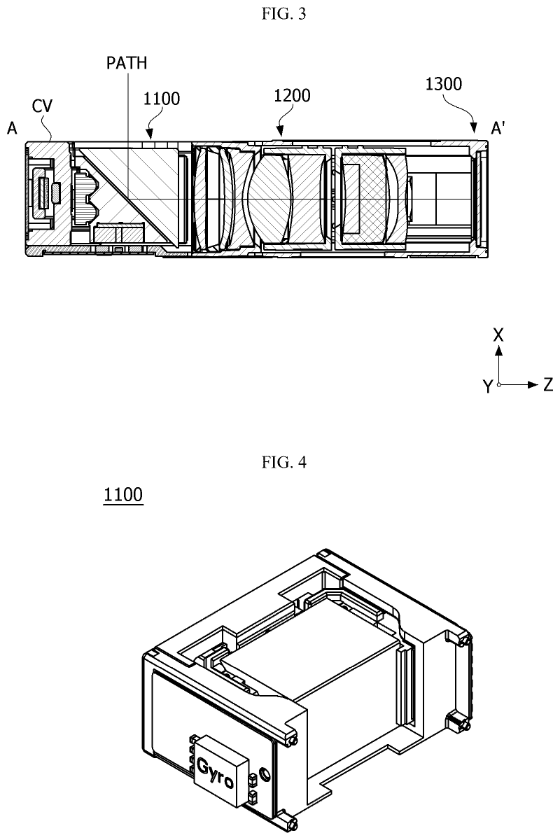

FIG. 1 is a perspective view showing a camera module according to an embodiment, FIG. 2 is an exploded perspective view showing a camera module according to an embodiment, and FIG. 3 is a view taken along the line AA′ in FIG. 1.

Referring to FIGS. 1 and 2, a camera module 1000 according to an embodiment may be configured of a cover CV, a first camera actuator 1100, a second camera actuator 1200, and a circuit board 1300. Here, the first camera actuator 1100 may be used interchangeably with a first actuator, and the second camera actuator 1200 may be interchangeable with a second actuator.

The cover CV may cover the first camera actuator 1100 and the second camera actuator 1200. The coupling force between the first camera actuator 1100 and the second camera actuator 1200 can be improved by the cover CV.

Furthermore, the cover CV may be made of a material that performs electromagnetic wave blocking. Accordingly, the first camera actuator 1100 and the second camera actuator1200 inside the cover CV can be protected easily.

In addition, the first camera actuator 1100 may be an Optical Image Stabilizer (OIS) actuator. For example, the first camera actuator 1100 may move an optical member in a direction perpendicular to the optical axis (axis of incident light).

The first camera actuator 1100 may include a fixed focal length lens disposed in a predetermined barrel (not shown). The fixed focal length lens may be referred to as a “single focal length lens” or a “single lens”.

The first camera actuator 1100 may change the path of light. As an embodiment, the first camera actuator 1100 may change the path of light vertically through an internal optical member (e.g., a prism or mirror). For example, the optical member may change the direction of light from a first direction (X-axis direction) to a third direction (Z-axis direction). Alternatively, the optical member may change the direction of light from a first axis to a second axis. Through the configuration like this, although the thickness of the mobile terminal is reduced, as a lens larger than the thickness of the mobile terminal is disposed inside the mobile terminal, the magnification, auto-focusing (AF), zooming, and OIS functions may be performed by changing the path of light.

However, it is not limited thereto, and the first camera actuator 1100 may change the path of light a plurality of times vertically or at a predetermined angle.

The second camera actuator 1200 may be disposed at the rear end of the first camera actuator 1100. The second camera actuator 1200 may be coupled to the first camera actuator 1100. In addition, the coupling therebetween may be accomplished in various ways.

In addition, the second camera actuator 1200 may be a zoom actuator or an Auto Focusing (AF) actuator. For example, the second camera actuator 1200 may support one or a plurality of lenses and perform an auto-focusing function or a zooming function by moving the lenses according to a control signal of a predetermined control unit.

In addition, one or a plurality of lenses moves independently or individually along the optical axis.

The circuit board 1300 may be disposed at the rear end of the second camera actuator 1200. The circuit board 1300 may be electrically connected to the second camera actuator 1200 and the first camera actuator 1100. In addition, the circuit board 1300 may be provided in plurality.

A camera module according to an embodiment may be configured of a single or a plurality of camera modules. For example, the plurality of camera modules may include a first camera module and a second camera module.

In addition, the first camera module may include a single or a plurality of actuators. For example, the first camera module may include the first camera actuator 1100 and the second camera actuator 1200.

In addition, the second camera module may be disposed in a predetermined housing (not shown) and include an actuator (not shown) capable of driving a lens unit. The actuator may be a voice coil motor, a micro actuator, a silicon actuator, or the like, and may be applied in various ways such as an electrostatic method, a thermal method, a bimorph method, and an electrostatic force method, but it is not limited thereto. In addition, in this specification, the camera actuator may be referred to as an actuator or the like. In addition, a camera module configured of a plurality of camera modules may be installed in various electronic devices such as a mobile terminal and the like. Furthermore, the actuator may be a device that moves or tilts a lens or an optical member. However, it will be described below in a concept that the actuator includes a lens or an optical element. Furthermore, the actuator may be referred to as a ‘lens transport device’, ‘lens moving device’, ‘optical member transport device’, ‘optical member moving device’, or the like.

Referring to FIG. 3, a camera module according to an embodiment may include a first camera actuator 1100 performing an OIS function, and a second camera actuator 1200 performing a zooming function and an AF function.

Light may enter the camera module or the first camera actuator through an open area located on the top surface of the first camera actuator 1100. That is, light enters inside the first camera actuator 1100 along the optical axis direction (e.g., X-axis direction, based on incident light), and the path of light may be changed to the vertical direction (e.g., Z-axis direction) through the optical member. In addition, the light may pass through the second camera actuator 1200 and enter the image sensor IS located at one end of the second camera actuator 1200 (PATH). In this specification, the Z-axis direction or the third direction is described as the optical axis direction as follows.

In this specification, the bottom surface means one side in the first direction. In addition, the first direction is the X-axis direction in the drawing and may be interchangeable with the second axis direction or the like. The second direction is the Y-axis direction in the drawing and may be interchangeable with the first-axis direction or the like. The second direction is a direction perpendicular to the first direction. In addition, the third direction is the Z-axis direction in the drawing, and may be interchangeable with the third-axis direction or the like. In addition, the third direction is a direction perpendicular to both the first direction and the second direction. Here, the third direction (Z-axis direction) corresponds to the direction of the optical axis, and the first direction (X-axis direction) and the second direction (Y-axis direction) are directions perpendicular to the optical axis. In addition, in the description of the second camera actuator 1200 below, the optical axis direction is the third direction (Z-axis direction), and it will be described below based thereon.

In addition, in the present specification, the inner side may be a direction toward the first camera actuator from the cover CV, and the outer side may be in a direction opposite to the inner side. That is, the first camera actuator and the second camera actuator may be located inside the cover CV, and the cover CV may be located outside the first camera actuator or the second camera actuator.

In addition, through the configuration like this, the camera module according to an embodiment may improve the spatial limitation of the first camera actuator and the second camera actuator by changing the path of light. That is, the camera module according to an embodiment may extend the path of light while minimizing the thickness of the camera module in correspondence to the change in the path of light. Furthermore, it should be understood that the second camera actuator may also provide a wide range of magnification by controlling the focus or the like in the extended path of light.

In addition, the camera module according to an embodiment may implement OIS by controlling the path of light through the first camera actuator, and according thereto, occurrence of decent or tilt phenomena can be minimized, and the best optical characteristics can be obtained.

Furthermore, the second camera actuator 1200 may include an optical system and a lens driving unit. For example, the second camera actuator 1200 may have at least one among a first lens assembly, a second lens assembly, and a third lens assembly disposed therein.

In addition, the second camera actuator 1200 may be provided with a coil and a magnet to perform a high-magnification zooming function and an auto-focusing function.

For example, the first lens assembly and the second lens assembly may be moving lenses that move through a coil, a magnet, and a guide pin, and the third lens assembly may be a fixed lens, but it is not limited thereto. For example, the third lens assembly may perform the function of a focator that forms an image at a specific point, and the first lens assembly may perform the function of a variator that forms again the image formed by the third lens assembly, which is a focator, at another point. Meanwhile, in the first lens assembly, the change in the magnification may be large as the distance to the subject or the image distance has changed significantly, and the first lens assembly, which is a variator, may play an important role for changing the focal length or the magnification of the optical system. Meanwhile, the image point where an image is formed in the first lens assembly, which is a variator, may change slightly according to the position. Accordingly, the second lens assembly may perform a position compensation function for the image formed by the variator. For example, the second lens assembly may act as a compensator that accurately forms the image point where the image is formed in the first lens assembly, which is a variator, at an actual image sensor position. For example, the first lens assembly and the second lens assembly may be driven by the electromagnetic force generated by the interaction of the coil and the magnet. The descriptions provided above may be applied to the lens assembly described below. In addition, the first to third lens assemblies may move along the optical axis direction, i.e., the third direction. In addition, the first to third lens assemblies may move in the third direction independently or to be dependent on each other. In the present invention, the first lens assembly and the second lens assembly may move along the optical axis direction. In addition, the third lens assembly may be located at the front end of the first lens assembly or the rear end of the second lens assembly. In addition, the third lens assembly may not move in the optical axis direction. That is, the third lens assembly may be a fixed unit. In addition, the first and second lens assemblies may be movable units.

Meanwhile, when an actuator for OIS and an actuator for AF/zoom are disposed according to an embodiment of the present invention, magnetic interference with the magnet for AF/zoom can be prevented when the OIS is driven. As a first driving magnet of the first camera actuator 1100 is disposed to be separated from the second camera actuator 1200, magnetic interference between the first camera actuator 1100 and the second camera actuator 1200 can be prevented. In this specification, the OIS may be interchangeable with the terms such as hand-shake correction, optical image stabilization, optical image correction, shake compensation, or the like.

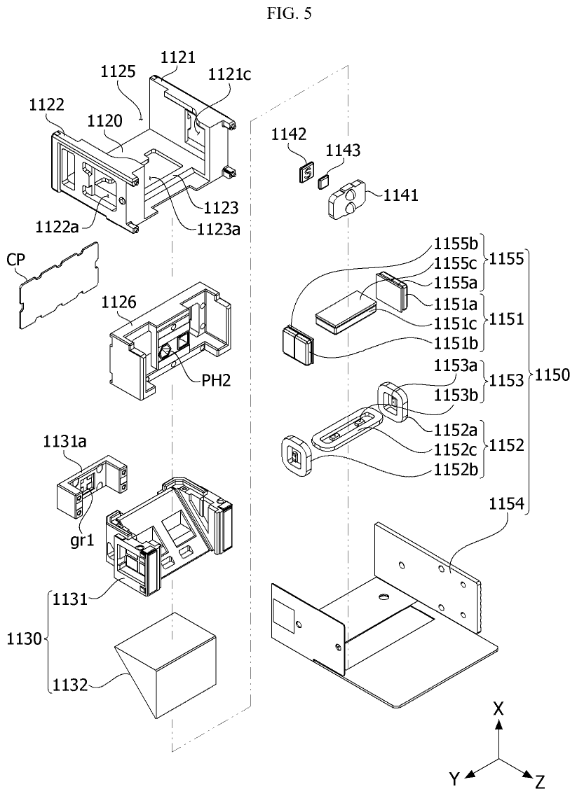

FIG. 4 is a perspective view showing a first camera actuator according to an embodiment, and FIG. 5 is an exploded perspective view showing a first camera actuator according to an embodiment.

Referring to FIGS. 4 and 5, the first camera actuator 1100 according to an embodiment may include a first housing 1120, a mover 1130, a rotating unit 1140, a first driving unit 1150, a first member 1126, and a second member 1131a. Furthermore, the first camera actuator 1100 may further include a plate CP.

The mover 1130 may include a holder 1131 and an optical member 1132 mounted on the holder 1131. In addition, the rotating unit 1140 may include a tilting guide unit 1141, and a second magnetic body 1142 and a first magnetic body 1143 having the same polarity or different polarities to press the tilting guide unit 1141. For example, polarities of surfaces facing each other of the first magnetic body 1143 and the second magnetic body 1142 may be the same. In addition, the first driving unit 1150 includes a driving magnet 1151, a driving coil 1152, a hall sensor unit 1153, a first substrate unit 1154, and a yoke unit 1155.

First, the first camera actuator 1100 may include a shield can (not shown). The shield can (not shown) may be located at the outermost side of the first camera actuator 1100 to surround the rotating unit 1140 and the first driving unit 1150 described below.

The shield can (not shown) may block or reduce electromagnetic waves generated from the outside. That is, the shield can (not shown) may reduce occurrence of malfunction in the rotating part 1140 and the first driving unit 1150.

The first housing 1120 may be located inside the shield can (not shown). When there is no shield can, the first housing 1120 may be located at the outermost side of the first camera actuator.

In addition, the first housing 1120 may be located inside the first substrate unit 1154 described below. The first housing 1120 may be coupled to the shield can (not shown) to be inserted into or engaged with each other.

The first housing 1120 may include a first housing side unit 1121, a second housing side unit 1122, a third housing side unit 1123, and a housing wall unit 1124. This will be described below in detail.

The first member 1126 may be disposed in the first housing 1120. The second member 1131a may penetrate a portion of the first member 1126. The first member 1126 may be disposed inside the housing. The first member 1126 may have a structure integrated with or separated from the first housing 1120.

Furthermore, the first camera actuator 1100 may further include a plate CP disposed outside the first member 1126. The plate CP may prevent foreign substances from flowing into the second member 1131a that penetrates the first member 1126. Furthermore, the plate CP may be made of a magnetic material. Accordingly, as the plate CP has magnetism, magnetic force on the first magnetic body 1143 and the second magnetic body 1142 that have a polarity for applying pressure may not be generated. That is, generation of magnetic force that hinders driving (applying pressure) of the first magnetic body 1143 and the second magnetic body 1142 can be reduced.

When the plate CP is a magnetic body, it may be referred to as a magnetic member, a magnetic body, a cover plate, a metal member, a metal plate, or the like.

The mover 1130 includes a holder 1131 and an optical member 1132 mounted on the holder 1131.

The holder 1131 may be mounted in an accommodation unit 1125 of the first housing 1120. The holder 1131 may include first to fourth holder outer side surfaces corresponding to a first housing side unit 1121, a second housing side unit 1122, a third housing side unit 1123, and a first member 1126, respectively. For example, the first to fourth holder outer side surfaces may correspond to or face the inner side surfaces of the first housing side unit 1121, the second housing side unit 1122, the third housing side unit 1123, and the first member 1126, respectively.

In addition, the holder 1131 may include a second member 1131a disposed in a fourth mounting groove. The second member 1131a may penetrate the first member 1126 and be coupled to the holder 1131. The second member 1131a and the holder 1131 may be coupled to each other by various bonding members or coupling members. This will be described below in detail.

The optical member 1132 may be mounted in the holder 1131. To this end, the holder 1131 may have a mounting surface, and the mounting surface may be formed by an accommodation groove. As an embodiment, the optical member 1132 may be configured of a mirror or a prism. Although it will be described below based on a prism, it may also be configured of a plurality of lenses as shown in the embodiment described above. Alternatively, the optical member 1132 may be configured as a plurality of lenses, a prism, or a mirror. In addition, the optical member 1132 may include a reflector disposed inside. However, it is not limited thereto.

In addition, the optical member 1132 may reflect light reflected from the outside (e.g., an object) toward the inside of the camera module. In other words, the optical member 1132 may improve the spatial limitation of the first camera actuator and the second camera actuator by changing the path of reflected light. Therefore, it should be understood that the camera module may provide a wide range of magnification by extending the path of light while minimizing the thickness.

In addition, the second member 1131a may be coupled to the holder 1131. The second member 1131a may be disposed outside the holder 1131 and inside the housing. In addition, the second member 1131a may be mounted in an additional groove located in an area other than the fourth mounting groove on the fourth holder outer side surface in the holder 1131. Therefore, the second member 1131a may be coupled to the holder 1131, and at least a portion of the first member 1126 may be located between the second member 1131a and the holder 1131. For example, at least a portion of the first member 1126 may be disposed in a space formed between the second member 1131a and the holder 1131. In addition, as described above, the second member 1131a may penetrate the hole (a first through hole and a second through hole described below) formed in the first member 1126.

In addition, the second member 1131a may be configured as a structure separated from the holder 1131. Through the configuration like this, assembly of the first camera actuator may be performed easily as described below. Alternatively, although the second member 1131a may be configured to be integrated with the holder 1131, it will be described below as a separate structure.

The rotating unit 1140 includes a tilting guide unit 1141, and a second magnetic body 1142 and a first magnetic body 1143 having the same polarity to press the tilting guide unit 1141.

The tilting guide unit 1141 may be coupled to the mover 1130 and the first housing 1120 described above. Specifically, the tilting guide unit 1141 may be disposed between the holder 1131 and the first member 1126. Accordingly, the tilting guide unit 1141 may be coupled to the mover 1130 of the holder 1131 and the first housing 1120. However, unlike those described above, in the present embodiment, the tilting guide unit 1141 may be disposed between the first member 1126 and the holder 1131. Specifically, the tilting guide unit 1141 may be located between the first member 1126 and the fourth mounting groove of the holder 1131. For example, at least a portion of the tilting guide unit 1141 may be located in the fourth mounting groove.

The second member 1131a, the first member 1126, the tilting guide unit 1141, and the holder 1131 may be disposed in order in the third direction (Z-axis direction). In addition, the second magnetic body 1142 and the first magnetic body 1143 may be mounted in a first groove gr1 formed in the second member 1131a and a second groove gr2 formed in the first member 1126, respectively. In the present embodiment, the positions of the first groove gr1 and the second groove gr2 may be different from those of the first and second grooves described in the other embodiment described above. However, the first groove gr1 is located inside the second member 1131a and moves together with the holder and the second member 1131a as one body, and the second groove gr2 is located on the first member 1126 in correspondence to the first groove gr1 to be coupled to the first housing 1120. Therefore, it will be described interchangeably using these terms. Furthermore, the first groove and the second groove may be the grooves as described above. Alternatively, the first groove and the second groove may be replaced in the form of a hole.

In addition, the tilting guide unit 1141 may be disposed to be adjacent to the optical axis. Therefore, the actuator according to an embodiment may easily change the path of light according to first and second axis tilts described below.

The tilting guide unit 1141 may include a first protrusion unit disposed to be spaced apart in the first direction (X-axis direction) and a second protrusion unit disposed to be spaced apart in the second direction (Y-axis direction). In addition, the first protrusion unit and the second protrusion unit may protrude in opposite directions. This will be described below in detail.

In addition, as described above, the second magnetic body 1142 may be located inside the second member 1131a. In addition, the first magnetic body 1143 may be located inside the first member 1126.

The second magnetic body 1142 and the first magnetic body 1143 may have the same polarity. For example, the second magnetic body 1142 may be a magnet having an N pole, and the first magnetic body 1143 may be a magnet having an N pole. Alternatively, on the contrary, the second magnetic body 1142 may be a magnet having an S pole, and the first magnetic body 1143 may be a magnet having an S pole. For example, as described above, a first polar surface of the first magnetic body 1143 and a second polar surface of the second magnetic body 1142 facing the first polar surface may have the same polarity.

The second magnetic body 1142 and the first magnetic body 1143 may generate a repulsive force between each other due to the polarity described above. Through the configuration like this, the repulsive force described above may be applied to the second member 1131a or the holder 1131 coupled to the second magnetic body 1142 and the first member 1126 or the first housing 1120 coupled to the first magnetic body 1143. At this point, the repulsive force applied to the second member 1131a may be transferred to the holder 1131 coupled to the second member 1131a. Therefore, the tilting guide unit 1141 located between the second member 1131a and the first member 1126 may be pressed by the repulsive force. Furthermore, the repulsive force may also be transferred to the housing and the mover. Accordingly, the housing and the mover may be pressed by each other by the repulsive force. In other words, the repulsive force may correspond to a holding force that maintains the position between the housing and the mover. That is, the repulsive force may maintain the tilting guide unit 1141 to be located between the holder 1131 and the first housing 1120 (or the first member 1126). Through the configuration like this, the position between the mover 1130 and the first housing 1120 can be maintained even when X-axis tilting or Y-axis tilting is performed. In addition, the tilting guide unit may be tightly attached to the first member 1126 and the holder 1131 by the repulsive force between the first magnetic body 1143 and the second magnetic body 1142. In other words, the repulsive force by the first magnetic body 1143 and the second magnetic body 1142 may be a holding force for maintaining the position between the holder 1131 and the first housing 1120.

The first driving unit 1150 includes a driving magnet 1151, a driving coil 1152, a hall sensor unit 1153, a first substrate unit 1154, and a yoke unit 1155. Details thereof will be provided below. In addition, the yoke unit 1155 may be referred to as a ‘first yoke unit’ in the first camera actuator. In addition, the yoke unit in the second camera actuator may be referred to as a ‘second yoke unit’.

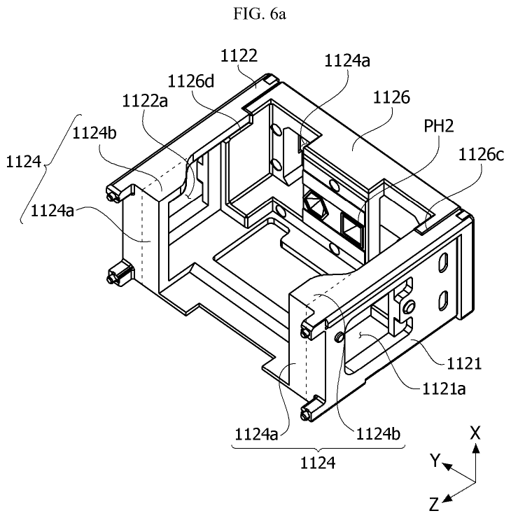

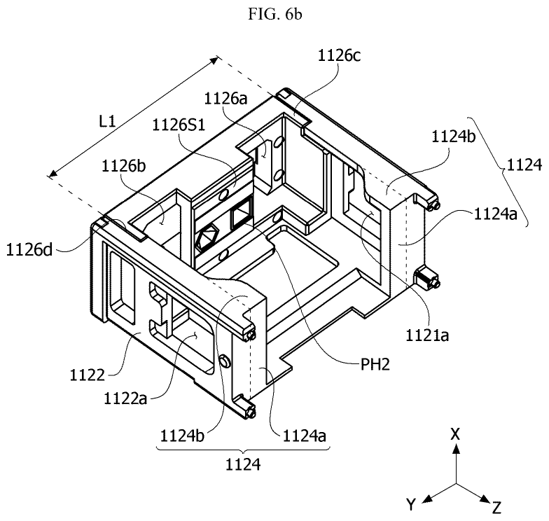

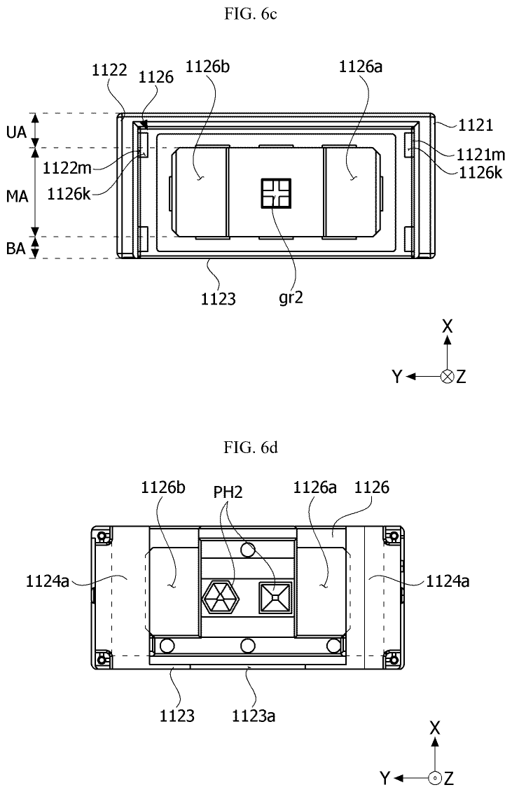

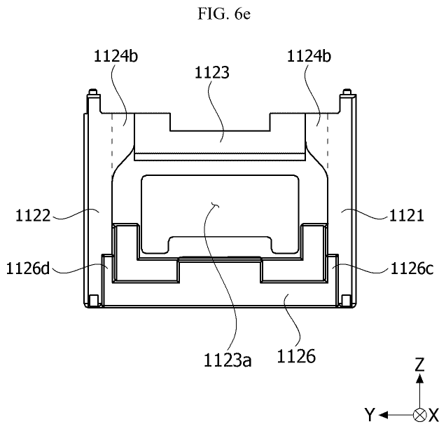

FIG. 6a is a perspective view showing a first housing of a first camera actuator according to an embodiment, FIG. 6b is a perspective view showing the first housing of FIG. 6a in a different direction, FIG. 6c is a front view showing a first housing of a first camera actuator according to an embodiment, FIG. 6d is a rear view showing a first housing of a first camera actuator according to an embodiment, and FIG. 6e is a top view showing a first housing of a first camera actuator according to an embodiment.

Referring to FIGS. 6a to 6e, the first housing 1120 according to an embodiment may include a first housing side unit 1121 to a third housing side unit 1123. In addition, the first member 1126 may be coupled to the first housing 1120 as one body. Accordingly, the first member 1126 may be a component included in the first housing 1120. Alternatively, the first housing 1120 may include the first member 1126.

The first housing side unit 1121 and the second housing side unit 1122 may be disposed to face each other. In addition, the first member 1216a and the housing wall unit 1124 may be disposed to face each other. Furthermore, the housing wall unit 1124 may be equally applied to the structure of a camera actuator in which the first member and the second member do not exist. That is, even in a structure in which the mover tilts inside the housing, the fixed housing may include the housing wall unit.

In addition, the third housing side unit 1123 may be disposed between the first housing side unit 1121 and the second housing side unit 1122.

The third housing side unit 1123 may be in contact with the first housing side unit 1121 and the second housing side unit 1122. In addition, the third housing side unit 1123 may be the bottom surface in the first housing 1120. In addition, those described above may be equally applied to the description of directions.

In addition, the first housing side unit 1121 may include a first housing hole 1121a. A first coil, which will be described below, may be located in the first housing hole 1121a.

In addition, the second housing side unit 1122 may include a second housing hole 1122a. In addition, a second coil 1152b, which will be described below, may be located in the second housing hole 1122a.

In addition, the first housing side unit 1121 and the second housing side unit 1122 may be side surfaces of the first housing 1120.

The first coil and the second coil may be coupled to the first substrate unit. As an embodiment, the first coil and the second coil are electrically connected to the first substrate unit so that current may flow. The current is a component of electromagnetic force that allows the second camera actuator to tilt with respect to the X-axis.

In addition, the third housing side unit 1123 may include a third housing hole 1123a.

A third coil, which will be described below, may be located in the third housing hole 1123a. In addition, the third coil 1152c may be electrically connected to the first substrate unit in contact with the first housing 1120, and coupled to each other. Accordingly, the third coil may be electrically connected to the first substrate unit and receive current from the first substrate unit. The current is a component of electromagnetic force that allows the second camera actuator to tilt with respect to the Y-axis.

The first member 1126 may be mounted between the first housing side unit 1121 and the third housing side unit 1123. Accordingly, the first member 1126 may be located on the third housing side unit 1123. For example, the first member 1126 may be located on one side. Based on the third direction, the first member 1126 and the holder may be located sequentially.

In addition, the first housing 1120 may include an accommodation unit 1125 formed by the first to third housing side units 1121 to 1123. The accommodation unit 1125 may include the first member 1126, the second member 1131a, and the mover 1130 as components. A mover, a tilting guide unit, and the like may be located in the accommodation unit 1125.

In addition, the first housing 1120 may further include the housing wall unit 1124 facing the first member 1126. In addition, the housing wall unit 1124 may be disposed between the first housing side unit 1121 and the second housing side unit 1122, and may be in contact with the first housing side unit 1121, the second housing side unit 1122, and the third housing side unit 1123.

In addition, the housing wall unit 1124 may be located at the end portions of the first housing side unit 1121 and the second housing side unit 1122. That is, the housing wall unit 1124 may be provided in plurality. In addition, a plurality of housing wall units 1124 may be located at the first housing side unit 1121 and the second housing side unit 1122, respectively. The plurality of housing wall units 1124 may be spaced apart from each other in the second direction (Y-axis direction). Accordingly, light reflected from the optical member 1132 may move to the second camera actuator at the rear end through the spaced area. In other words, the spaced area provides a path for the light to move.

In addition, the housing wall unit 1124 may include protrusions, grooves, or the like to provide easy coupling to another adjacent camera actuator (second camera actuator). As the coupling force between the housing wall unit 1124, in which an opening for providing a path of light is formed, and other components is improved while providing the path of light through the configuration like this, change of the path of light can be minimized by suppressing movement of the opening due to the space or the like.

More specifically, the housing wall units 1124 may be disposed on side units corresponding to the light-emitting surface of the optical member. In addition, the housing wall units 1124 may be located between the first housing side unit 1121 and the second housing side unit 1122, and may be located at the end portions of the first housing side unit 1121 and the second housing side unit 1122 in the direction of the optical axis. Accordingly, the housing wall units 1124 may be located at the rear end of the accommodation unit 1125 along the optical axis direction. Furthermore, the housing wall units 1124 may be located at the rear end of the optical member in the optical axis direction (Z-axis direction).

In addition, the housing wall units 1124 may be overlapped with the holder in the optical axis direction (Z-axis direction). In addition, the housing wall units 1124 may be at least partially overlapped with the holder in the optical axis direction. Here, the optical axis direction (Z-axis direction) may correspond to the moving direction of the reflected light. In addition, the optical axis direction may correspond to the vertical direction of the light-emitting surface of the optical member. Accordingly, although the mover, i.e., the holder, tilts, the movement may be limited by the housing wall unit 1124 for the sake of hand-shake prevention function. Furthermore, the impact that occurs as the housing wall unit 1124 and the holder collide with each other may not occur in the first member or the second member. Therefore, reliability of the first and second members can be improved.

In addition, the housing wall unit 1124 may be formed to be integrated with the housing 1120. In addition, a portion of the housing wall unit 1124 may be made of an elastic material. In addition, an elastic member may be additionally disposed on the housing wall unit 1124. Accordingly, the impact applied to the holder 1131 due to the collision between the housing wall unit 1124 and the holder 1131 may be reduced.

In addition, the housing wall unit 1124 according to an embodiment may include a wall unit 1124a facing (or corresponding to) the rear surface (or the light-emitting surface of the optical member) of the holder, and a housing extension unit 1124b extended from the wall unit 1124a to the top of the holder.

The wall unit 1124a may be overlapped with the holder in the optical axis direction (Z-axis direction). In addition, the housing extension unit 1124b may be overlapped with the holder in the first direction.

The wall unit 1124a may act as a stopper against tilting of the holder in the first direction or second direction. That is, when the holder tilts, the holder and the wall unit 1124a may collide or come into contact with each other.

In addition, when the holder moves in the first direction or tilts in the second axis (e.g., moves up and down), the housing extension unit 1124b may collide with or come into contact with the holder. That is, the housing extension unit 1124b may act as a stopper against the movement of the holder in the first direction. Furthermore, the third housing side unit 1130 may also act as a stopper.

In addition, as described above, the first member 1126 may be a component included in the first housing 1120 to be coupled to the first housing 1120. For example, the first member 1126 may be a structure integrated with or separated from the first housing 1120. It will be described below as a structure in which the first member 1126 is separated from the first housing 1120.

In addition, the first member 1126 may be disposed in the first housing 1120. Alternatively, the first member 1126 may be located inside the first housing 1120.

In addition, the first member 1126 may be coupled to the first housing 1120. As an embodiment, the first member 1126 may be located between the first housing side unit 1121 and the second housing side unit 1122. In addition, the first member 1126 is located on the third housing side unit 1123, and may be in contact with the first to third housing side units.

In addition, a first stop member 1121b may be located on the inner side surface of the first housing side unit 1121. In addition, a second stop member 1122b may be located on the inner side surface of the second housing side unit 1122.

The first stop member 1121b and the second stop member 1122b may be located symmetrically with respect to the first direction (X-axis direction). The first stop member 1121b and the second stop member 1122b may be extended in the first direction (X-axis direction). Through the configuration like this, the position can be maintained by the first stop member 1121b and the second stop member 1122b although the first member 1126 moves into the first housing 1120. In other words, the first stop member 1121b and the second stop member 1122b may maintain the first member 1126 to be located on one side of the first housing 1120.

Furthermore, the first stop member 1121b and the second stop member 1122b may fix the position of the tilting guide unit between the first member 1126 and the mover by fixing the position of the first member 1126 to eliminate factors that generate errors, such as vibration or the like. Therefore, the first camera actuator according to an embodiment may accurately perform X-axis tilting and Y-axis tilting.

In addition, the separation distance L2 in the second direction (Y-axis direction) between the first stop member 1121b and the second stop member 1122b may be smaller than the maximum length L1 in the second direction (Y-axis direction) of the first member 1126. Accordingly, the first member 1126 may be assembled or inserted into the side surface of the first housing 1120 to be coupled to the first housing 1120. Furthermore, the holder may be assembled along the first direction with respect to the first housing 1120. In addition, as described above, the first member 1126 may be coupled to the first housing 1120 along the side surface, i.e., along the optical axis direction. In addition, the second member may be assembled or inserted along the optical axis direction. Therefore, the second member may penetrate the first member 1126. Thereafter, a plate may be additionally disposed on the first member 1126.

In addition, the first member 1126 includes a second protrusion groove PH2 on which a second protrusion unit of the tilting guide unit is mounted. The second protrusion groove PH2 may be located on the inner side surface 1126s1 of the first member 1126. Descriptions of the first protrusion groove may be equally applied to the second protrusion groove PH2 as described below. For example, the second protrusion grooves PH2 may be provided in plurality and may have a structure having the same or different contact points as the second protrusion unit of the tilting guide unit. For example, there are two second protrusion grooves PH2, and they may have 4-point and 8-point contact structures. That is, the second protrusion groove PH2 may be configured of a plurality of inclined surfaces. In addition, the second protrusion groove PH2 may be a groove of hemispherical shape.

In addition, the first member 1126 is configured so that the protrusion unit, which is the reference axis of tilting, is disposed to be close to the center of gravity of the mover 1130 by disposing the protrusion unit (e.g., the second protrusion unit) of the tilting guide unit to be adjacent to the optical member (prism) inside the fourth mounting groove. Therefore, the moment that moves the mover 1130 for tilting can be minimized when the holder tilts. Accordingly, as the current consumption for driving the coil is also minimized, power consumption of the camera actuator can be reduced.

In addition, the first member 1126 may include through holes 1126a and 1126b. The through holes are provided in plurality, and may be configured of a first through hole 1126a and a second through hole 1126b.

The first and second extension units of the second member, which will be described below, may pass through the first through hole 1126a and the second through hole 1126b, respectively. Through this, a holding force may be generated between the second member and the first member by the repulsive force between the first and second magnetic bodies. In other words, even when the mover tilts, the first housing and the mover may maintain the positions relative therebetween.

The second protrusion groove PH2 may be located between the first through hole 1126a and the second through hole 1126b. Through the configuration like this, the coupling force between the tilting guide unit 1141 and the first member 1126 is improved, and degradation in tilting accuracy, which occurs as the tilting guide unit 1141 moves inside the first housing, can be prevented.

In addition, the second groove gr2 may be located on the outer side surface 1126s2 of the first member 1126. The first magnetic body may be mounted in the second groove gr2. In addition, the outer side surface 1126s2 of the first member 1126 may face or be opposite to the inner side surface of the second member or the member base unit. Furthermore, the second magnetic body mounted on the second member and the first magnetic body of the first member 1126 may face each other and generate the repulsive force described above. Accordingly, since the first member 1126 presses the tilting guide unit inward or the holder by the repulsive force, the mover may be spaced apart from the third housing side unit by a predetermined distance inside the first housing even without current injection into the coil. In other words, the holding force for maintaining the positions between the mover, the housing, and the tilting guide unit may be generated by the first magnetic body and the second magnetic body.

In addition, when the first member 1126 is formed to be integrated with the first housing 1120, reliability of the camera actuator can be improved as the coupling force between the first member 1126 and the first housing 1120 is improved. In addition, when the first member 1126 is formed separately, the ease of assembling and manufacturing the first member 1126 and the first housing 1120 can be improved.

In addition, as an embodiment, the first member 1126 may include the first through hole 1126a and the second through hole 1126b as described above. In addition, the first through hole 1126a and the second through hole 1126b may be disposed side by side in the second direction (Y-axis direction) to be overlapped with each other.

In addition, the first member 1126 may include an upper member UA located on the top of the first through hole 1126a and the second through hole 1126b, and a lower member BA located on the bottom of the first through hole 1126a and the second through hole 1126b. Accordingly, the first through hole 1126a and the second through hole 1126b may be located in the middle of the first member 1126. That is, the first member 1126 may include a connection member MA located on the side units of the first through hole 1126a and the second through hole 1126b. That is, the upper member UA and the lower member BA may be connected to each other through the connection member MA. In addition, the lower member BA may be provided in plurality to form the first and second through holes, and may be disposed to be spaced apart from each other in the second direction (Y-axis direction).

Therefore, as the first member 1126 has the upper member UA, rigidity can be improved. For example, rigidity of the first member 1126 may be increased compared to when the upper member UA is not provided. For example, in the present embodiment, the rigidity may have a unit of N/μm. Accordingly, reliability of the first camera actuator according to an embodiment can be improved.

In addition, first coupling grooves 1126k may be located on the outer side surface 1126s2 of the first member 1126. Each of the first coupling grooves 1126k may be located at an edge of the outer side surface 1126s2 of the first member 1126. In particular, the first coupling grooves 1126k may be located at the end units (e.g., left and right side units) of the outer side surface 1126s2 of the first member 1126 to be adjacent to the first housing side unit 1121.

The first coupling grooves 1126k may be located to correspond to the second coupling grooves 1121m and 1122m of the first housing side unit 1121 and the second housing side unit 1122. As an embodiment, the first coupling grooves 1126k may be located to correspond to (or face) the second coupling grooves 1121m and 1122m of the first housing side unit 1121 and the second housing side unit 1122. The second coupling grooves 1121m and 1122m may be located on a side surface, which is adjacent to the outer side surface 1126s2 of the first member 1126 described above and forms the same surface.

As an embodiment, the first coupling grooves 1126k and the second coupling grooves 1121m and 1122m may be provided in plurality, and the plurality of first coupling grooves 1126k and the plurality of second coupling grooves 1121m and 1122m may be located symmetrically in the first direction or the second direction.

In addition, a coupling member may be applied to the first coupling grooves 1126k and the second coupling grooves 1121m and 1122m. That is, the coupling force between the first housing 1120 and the first member 1126 can be improved as the coupling member is applied between the first housing side unit (or the second housing side unit) and the first member 1126. Although the coupling member may include epoxy or the like, it is not limited to such a material.

In addition, the first member 1126 may further include a first protrusion unit 1126c and a second protrusion unit 1126d. The first protrusion unit 1126c may be in contact with the first housing side unit 1121, and the second protrusion unit 1126d may be in contact with the second housing side unit 1122. The first protrusion unit 1126c may be extended from one end of the outer side surface 1126s2 of the first member in the third direction (Z-axis direction). The second protrusion unit 1126d may be extended from the other end of the outer side surface 1126s2 of the first member in the third direction (Z-axis direction). That is, the first protrusion unit and the second protrusion unit may be extended toward the holder.

The position of the first protrusion unit may be maintained by the first stop member 1121b, and the position of the second protrusion unit may be maintained by the second stop member 1122b. Accordingly, reliability of the camera actuator according to an embodiment can be improved.

In addition, as described above, the housing wall unit 1124 according to an embodiment may include the wall unit 1124a and the housing extension unit 1124b.

The housing wall unit 1124 or the wall unit 1124a may be overlapped with the first through hole 1126a and the second through hole 1126b of the first member 1126 in the optical axis direction (Z-axis direction). For example, the housing wall unit 1124 or the wall unit 1124a may be partially overlapped with the first through hole 1126a and the second through hole 1126b of the first member 1126 in the optical axis direction (Z-axis direction).

In addition, the second protrusion groove PH2 may be located between adjacent wall units 1124a. In addition, the housing wall unit 1124 or the wall unit 1124a may not be overlapped with the second protrusion groove PH2 along the optical axis direction (Z-axis direction).

Through the configuration like this, the effective area of the light reflected and emitted through the optical member located between adjacent wall units 1124a can be increased.

Furthermore, the distance between adjacent housing extension units 1124b (the separation distance in the second direction) can be reduced along the optical axis direction. Through the configuration like this, the amount of light entering the optical member can be increased. Furthermore, the housing extension unit 1124b may sufficiently perform the role of a stopper with respect to the tilt of the holder.

In addition, the third housing hole 1123a may be located between adjacent housing extension units 1124b. That is, the third housing hole 1123a may not be overlapped, but may be misaligned, with the housing extension unit 1124b in the first direction (X-axis direction).

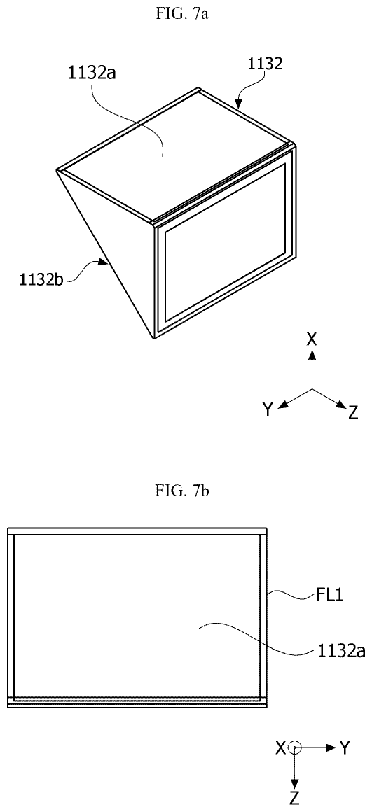

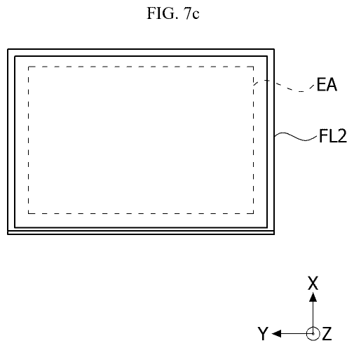

FIG. 7a is a perspective view showing an optical member of a first camera actuator according to an embodiment, FIG. 7b is a top view showing an optical member of a first camera actuator according to an embodiment, and FIG. 7c is a side view showing an optical member of a first camera actuator according to an embodiment.

Referring to FIG. 7a, the optical member 1132 may be mounted on the holder. The optical member 1132 may be a right-angle prism as a reflector, but it is not limited thereto.

As an embodiment, the optical member 1132 may have a protrusion unit (not shown) on a portion of the outer side surface. The optical member 1132 may be easily coupled to the holder through the protrusion unit (not shown). In addition, as the holder has a groove or a protrusion, it may be coupled to the optical member 1132.

In addition, the bottom surface 1132b of the optical member 1132 may be mounted on the mounting surface of the holder. Accordingly, the bottom surface 1132b of the optical member 1132 may correspond to the mounting surface of the holder. As an embodiment, the bottom surface 1132b may be configured as an inclined surface in the same manner as the holder is mounted. Accordingly, the optical member 1132 may be prevented from being separated from the holder when the prism moves as the holder moves.

In addition, as a groove is formed on the bottom surface 1132b of the optical member 1132 and a bonding member is applied, the optical member 1132 may be coupled to the holder. Alternatively, as the bonding member is applied to the groove or the protrusion of the holder, the holder may be coupled to the optical member 1132. However, the edge of the optical member 1132 may be in contact with the inclined surface or the mounting surface of the holder. That is, a portion of the bottom surface or the reflection surface 1132b of the optical member 1132 may be spaced apart from the inclined surface of the holder. For example, the effective area (corresponding to the effective diameter) of the reflection surface 1132b may be spaced apart from the inclined surface of the holder.

In addition, as described above, the optical member 1132 may be configured as a structure capable of reflecting light reflected from the outside (e.g., an object) toward the inside of the camera module. As an embodiment, the optical member 1132 may be configured as a single mirror. In addition, the optical member 1132 may improve the spatial limitation of the first camera actuator and the second camera actuator by changing the path of reflected light. Therefore, it should be understood that the camera module may provide a wide range of magnification by extending the path of light while minimizing the thickness. In addition, it should be understood that the camera module including the camera actuator according to an embodiment may provide a wide range of magnification by extending the path of light while minimizing the thickness.

Further referring to FIGS. 7b and 7c, furthermore, the optical member 1132 may include an incident surface 1132a, a reflection surface 1132b, and a light-emitting surface 1132c. The bottom surface 1132b described above may be the same surface as the reflection surface 1132b.

Furthermore, light may enter the incident surface 1132a. In addition, light passing through the incident surface 1132a may be reflected from the reflection surface 1132b inclined at a predetermined angle. The reflection surface 1132b may be inclined at a predetermined angle with respect to the incident surface 1132a. For example, the predetermined angle may be in a range of 40 to 50 degrees.

In addition, most of the light may be reflected from the reflection surface 1132b, passes through the light-emitting surface 1132c, and move to the second camera actuator. In this way, the optical member 1132 may change the path of light through the incident surface 1132a, the reflection surface 1132b, and the light-emitting surface 1132c.

In addition, the optical member 1132 may induce a flare phenomenon due to breakage or unintended reflection of light in the area other than the incident surface 1131a and the light-emitting surface 1132c. Furthermore, even when some of the light is not reflected from the reflection surface 1132b of the optical member 1132, a flare phenomenon may be induced due to unintended refraction, reflection, or the like of the light.

Accordingly, a film or the like may be attached to the edge of the incident surface 1132a or the light-emitting surface 1132c to prevent the flare phenomenon. For example, a light-shielding film may be attached to or a light-shielding paint may be formed on the edge of the incident surface 1132a or the light-emitting surface 1132c.

For example, a first film FL1 may be disposed on the edge of the incident surface 1132a. In addition, a second film FL2 may be disposed on the edge of the light-emitting surface 1132c. Furthermore, the second film FL2 may be located outside the effective area or effective diameter EA of the light-emitting surface 1132c. Alternatively, a structure having a predetermined roughness or higher may be formed on the edge of the incident surface 1132a or the light-emitting surface 1132c. Through the configuration like this, the image quality can be improved as the flare phenomenon described above is suppressed.

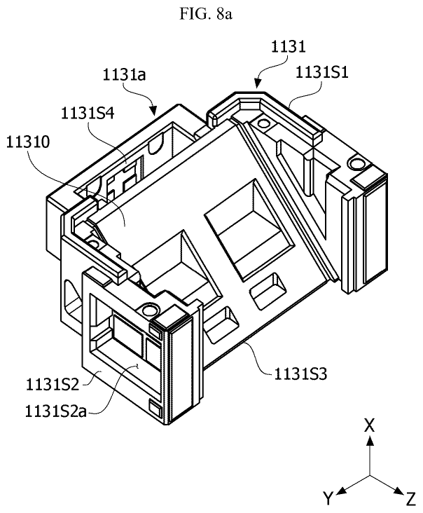

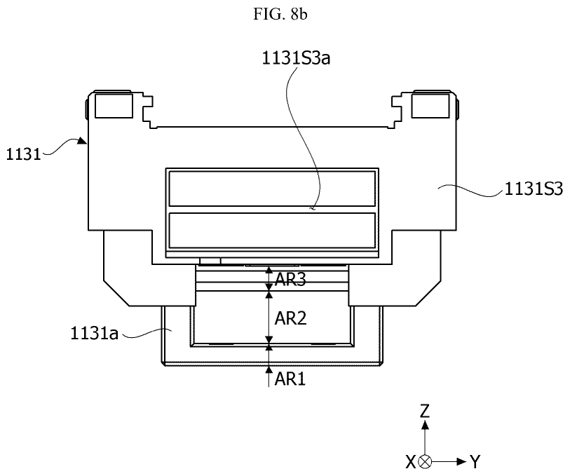

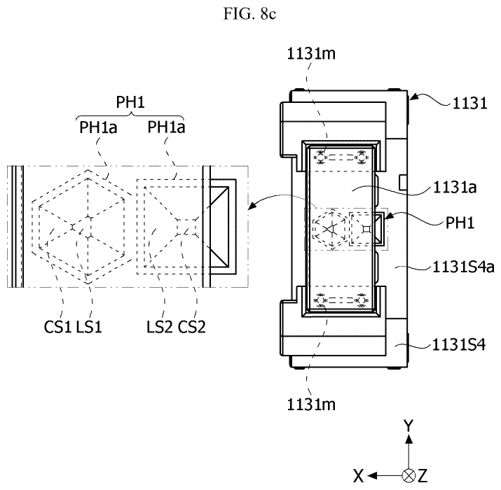

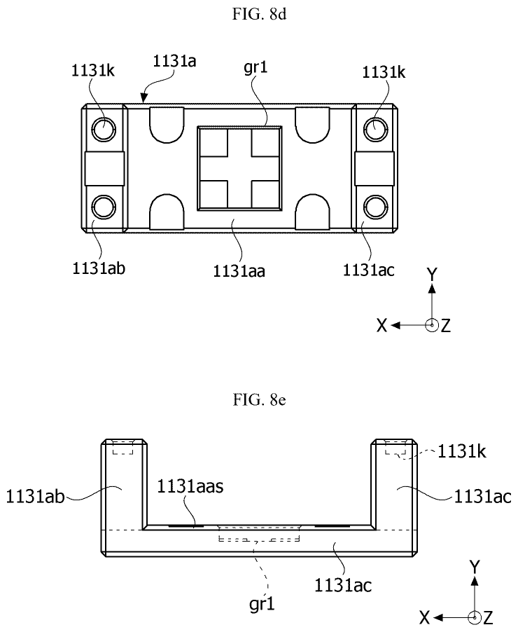

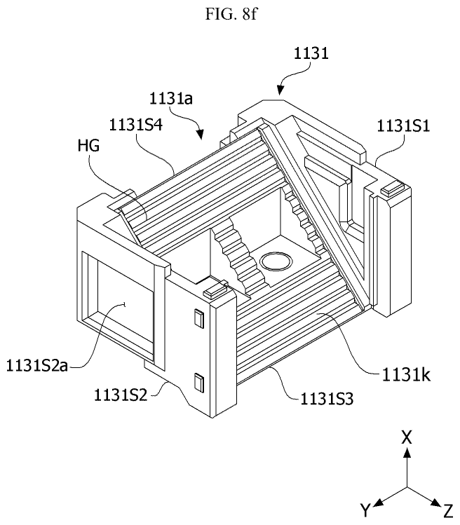

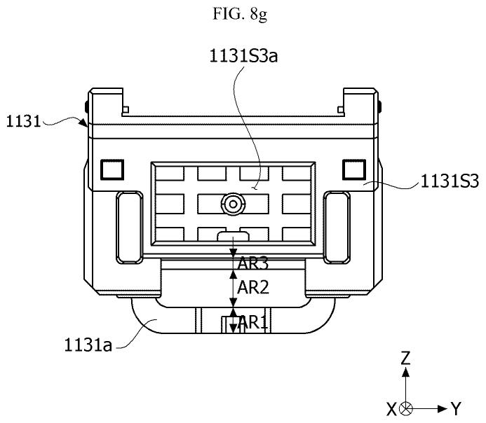

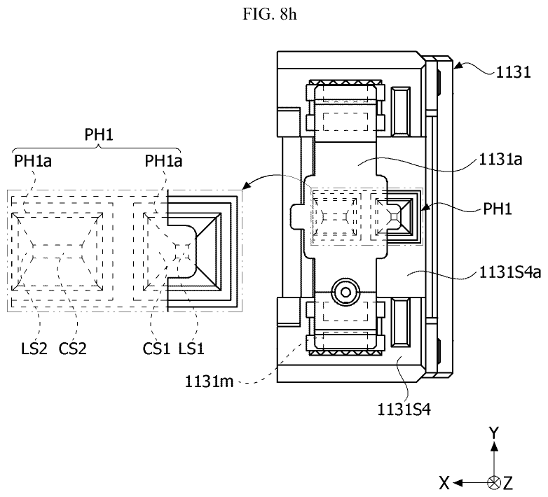

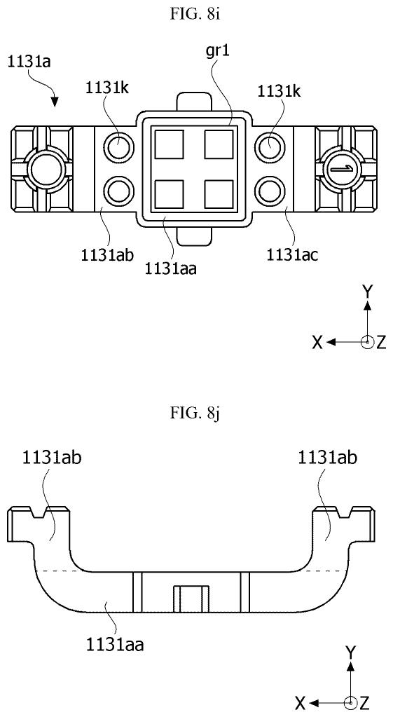

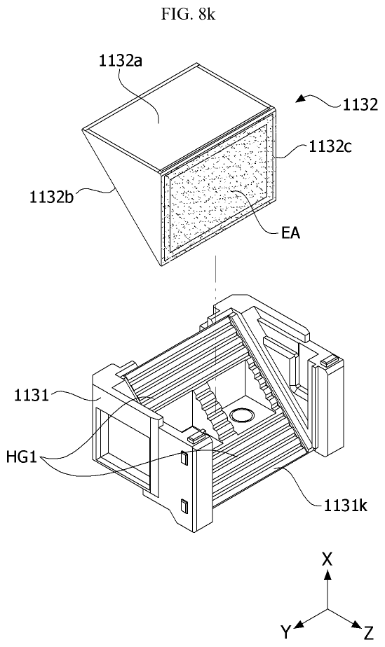

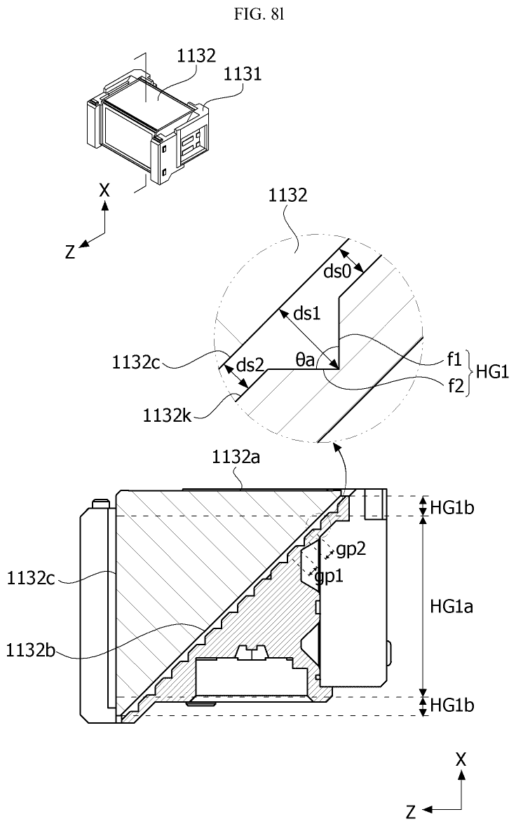

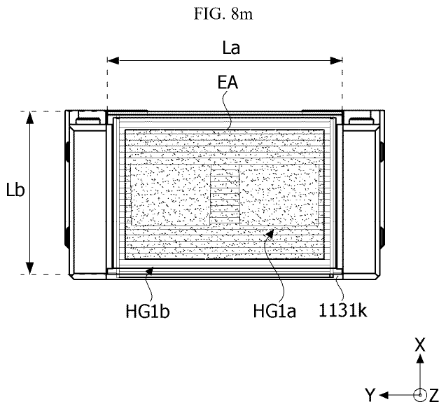

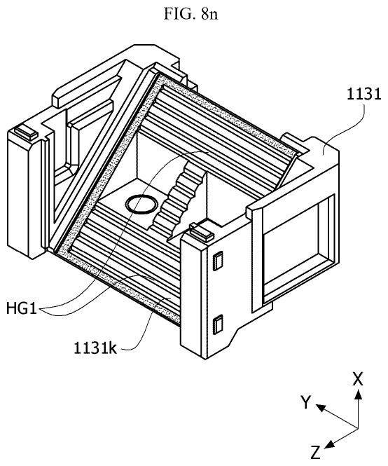

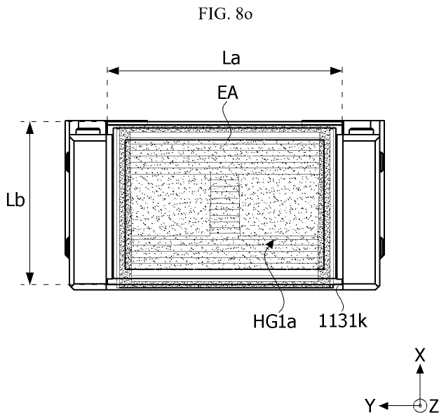

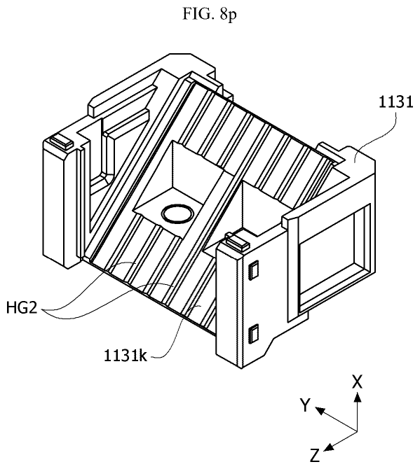

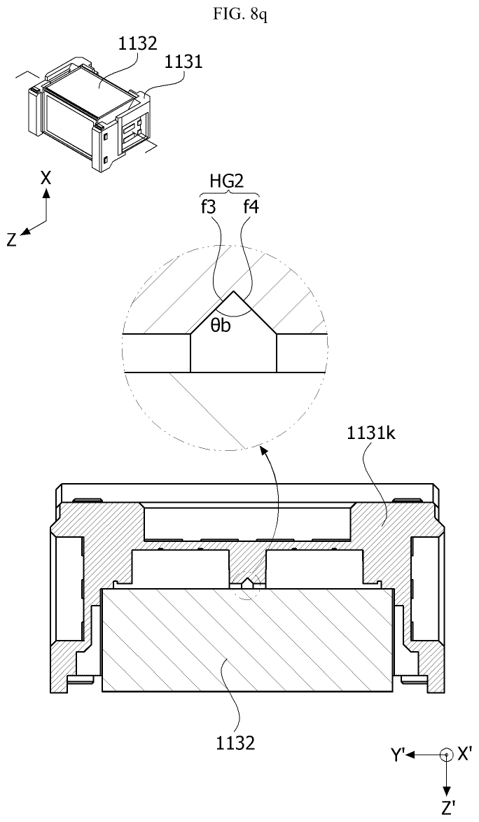

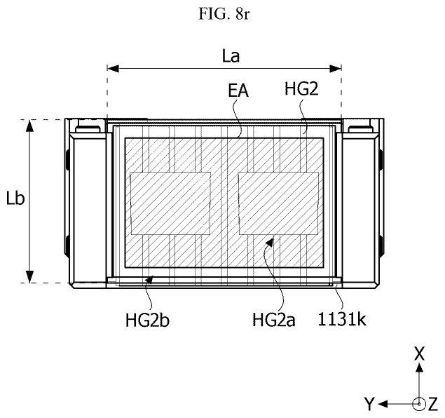

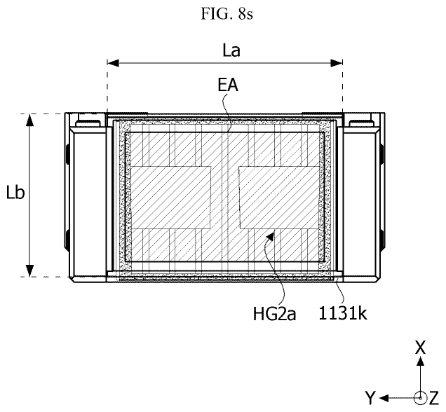

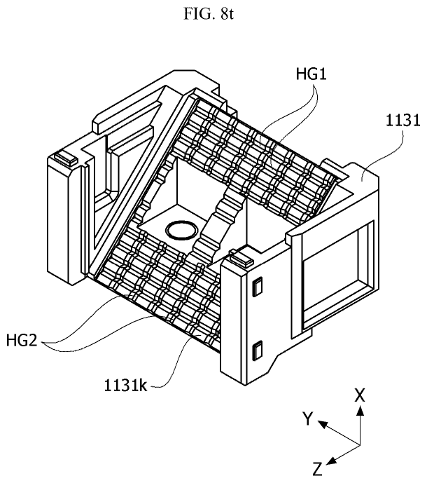

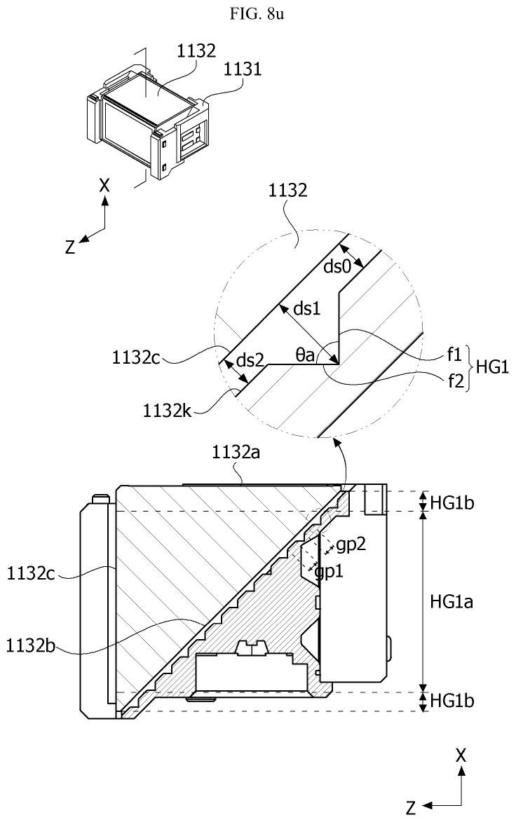

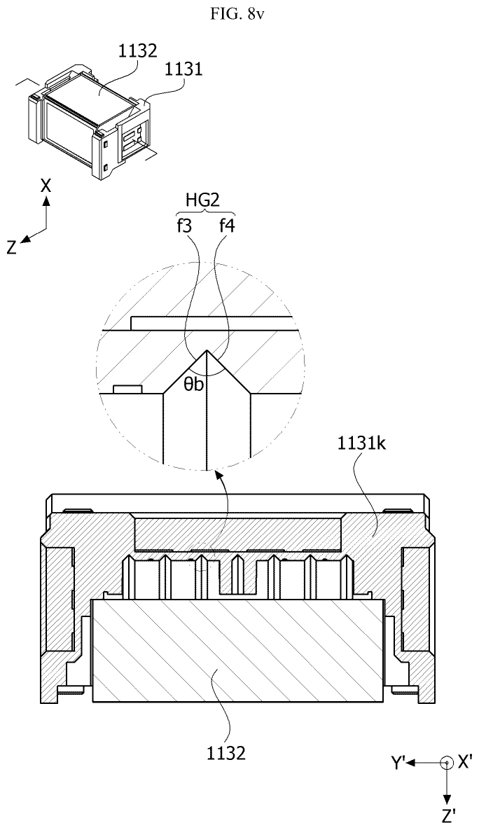

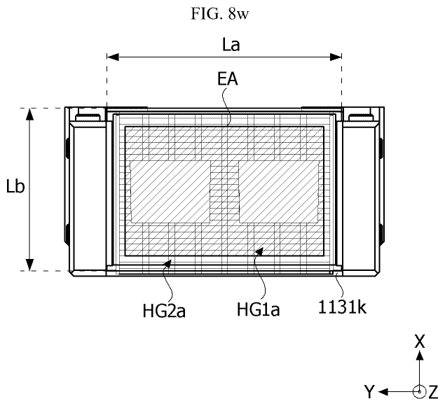

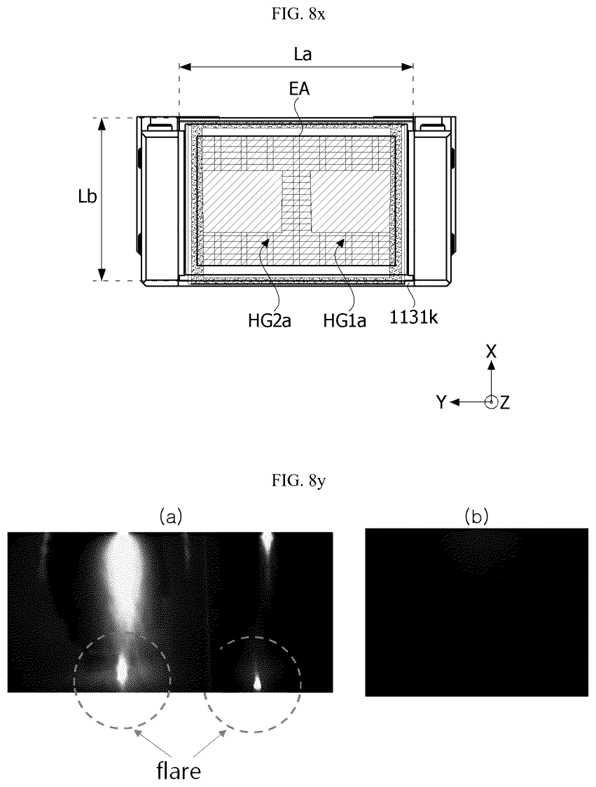

FIG. 8a is a perspective view showing a holder of a first camera actuator according to an embodiment, FIG. 8b is a bottom view showing a holder of a first camera actuator according to an embodiment, FIG. 8c is a front view showing a holder of a first camera actuator according to an embodiment, FIG. 8d is a rear view showing a second member of a first camera actuator according to an embodiment, and FIG. 8e is a bottom view showing a second member of a first camera actuator according to an embodiment.

Referring to FIGS. 8a to 8e, the holder 1131 may include a mounting surface 1131o on which the optical member 1132 is mounted. The mounting surface 1131o may be an inclined surface. In addition, the holder 1131 may include a step unit on the top of the mounting surface 113o. In addition, in the holder 1131, the step unit may be coupled to a protrusion unit (not shown) of the optical member 1132.

The holder 1131 may include a plurality of outer side surfaces. For example, the holder 1131 may include a first holder outer side surface 1131S1, a second holder outer side surface 1131S2, a third holder outer side surface 1131S3, and a fourth holder outer side surface 1131S4.

The first holder outer side surface 1131S1 may be located to face the second holder outer side surface 1131S2. That is, the first holder outer side surface 1131S1 and the second holder outer side surface 1131S2 may be disposed symmetrically with respect to the first direction (X-axis direction).

The first holder outer side surface 1131S1 may be located to correspond to the first housing side unit. That is, the first holder outer side surface 1131S1 may be located to face the first housing side unit. In addition, the second holder outer side surface 1131S2 may be located to correspond to the second housing side unit. That is, the second holder outer side surface 1131S2 may be located to face the second housing side unit.

In addition, the first holder outer side surface 1131S1 may include a first mounting groove 1131S1a. In addition, the second holder outer side surface 1131S2 may include a second mounting groove 1131S2a. The first mounting groove 1131S1a and the second mounting groove 1131S2amay be disposed symmetrically with respect to the first direction (X-axis direction).

In addition, the first mounting groove 1131S1a and the second mounting groove 1131S2a may be disposed to be overlapped in the second direction (Y-axis direction). In addition, a first magnet 1151a may be disposed in the first mounting groove 1131S1a, and a second magnet 1151b may be disposed in the second mounting groove 1131S2a. The first magnet 1151a and the second magnet 1151b may also be disposed symmetrically with respect to the first direction (X-axis direction). In this specification, it should be understood that first to third magnets may be coupled to the housing through a yoke or a bonding member. The polarity of the first magnet and the polarity of the second magnet may be located in the directions opposite to each other. For example, the N pole and S pole of the first magnet may be disposed sequentially in the third direction, and the S pole and N pole of the second magnet may be disposed sequentially in the third direction. As a modified embodiment, the polarity of the first magnet and the polarity of the second magnet may be located to be the same by controlling current injection or current directions of the first and second coils.

As described above, according to the positions of the first and second mounting grooves and the first and second magnets, the electromagnetic force induced by each magnet may be provided to the first holder outer side surface S1231S1 and the second holder outer side surface 1131S2 on the same axis. For example, an area on the first holder outer side surface S1231S1 where the electromagnetic force is applied (e.g., an area where the electromagnetic force is strongest) and an area on the second holder outer side surface S1231S1 where the electromagnetic force is applied (e.g., an area where the electromagnetic force is strongest) may be located on an axis parallel to the second direction (Y-axis direction). Therefore, X-axis tilting may be accurately performed.

The first magnet may be disposed in the first mounting groove 1131S1a, and the second magnet may be disposed in the second mounting groove 1131S2a.

The third holder outer side surface 1131S3 may be an outer side surface in contact with the first holder outer side surface 1131S1 and the second holder outer side surface 1131S2, and extended from one side of the first holder outer side surface 1131S1 and the second holder outer side surface 1131S2 in the second direction (Y-axis direction). In addition, the third holder outer side surface 1131S3 may be located between the first holder outer side surface 1131S1 and the second holder outer side surface 1131S2. The third holder outer side surface 1131S3 may be the bottom surface in the holder 1131. That is, the third holder outer side surface 1131S3 may be located to face the third housing side unit.

In addition, the third holder outer side surface 1131S3 may include a third mounting groove 1131S3a. The third magnet may be disposed in the third mounting groove 1131S3a. The third holder outer side surface 1131S3 may be located to face the third housing side unit 1123.

In addition, the third housing hole 1123a may be at least partially overlapped with the third mounting groove 1131S3a in the first direction (X-axis direction). Accordingly, the third magnet in the third mounting groove 1131S3a and the third coil in the third housing hole 1123a may be located to face each other. In addition, as the third magnet and the third coil generate electromagnetic force, the second camera actuator may perform Y-axis tilting.

In addition, X-axis tilting is accomplished by a plurality of magnets (the first and second magnets), whereas Y-axis tilting may be accomplished only by the third magnet.

As an embodiment, the area of the third mounting groove 1131S3a may larger than that of the first mounting groove 1131S1a or the second mounting groove 1131S2a. Through the configuration like this, Y-axis tilting may be performed with current control similar to that of X-axis tilting.

The fourth holder outer side surface 1131S4 may be an outer side surface in contact with the first holder outer side surface 1131S1 and the second holder outer side surface 1131S2, and extended from the first holder outer side surface 1131S1 and the second holder outer side surface 1131S2 in the first direction (X-axis direction). In addition, the fourth holder outer side surface 1131S4 may be located between the first holder outer side surface 1131S1 and the second holder outer side surface 1131S2. That is, the fourth holder outer side surface 1131S4 may be located to face the first member.

The fourth holder outer side surface 1131S4 may include a fourth mounting groove 1131S4a. The tilting guide unit 1141 may be located in the fourth mounting groove 1131S4a. In addition, the second member 1131a and the first member 1126 may be located in the fourth mounting groove 1131S4a. In addition, the fourth mounting groove 1131S4a may include a plurality of regions. It may include a first region AR1, a second region AR2, and a third region AR3.

The second member 1131a may be located in the first region AR1. That is, the first region AR1 may be overlapped with the second member 1131a in the first direction (X-axis direction). In particular, the first region AR1 may be an area where the member base unit of the second member 1131a is located. At this point, the first region AR1 may be located on the fourth holder outer side surface 1131S4. That is, the first region AR1 may correspond to an area located on the top side of the fourth mounting groove 1131S4a. In this case, the first region AR1 may not be an area inside the fourth mounting groove 1131S4a.

The first member 1126 may be located in the second region AR2. That is, the second region AR2 may be overlapped with the first member 1126 in the first direction (X-axis direction).

In addition, the second region AR2 may be located on the fourth holder outer side surface 1131S4, like the first region. That is, the second region AR2 may correspond to an area located on the top of the fourth mounting groove 1131S4a.

The tilting guide unit may be located in the third region AR3. In particular, the base of the tilting guide unit may be located in the third region AR3. That is, the third region AR3 may be overlapped with the tilting guide unit (e.g., the base) in the first direction (X-axis direction).

In addition, the second region AR2 may be located between the first region AR1 and the third region AR3.

In addition, the second member is disposed in the first region AR1, and the second member 1131a may include a first groove gr1. As an embodiment, the second member 1131a may include the first groove gr1 formed on the inner side surface 1131aas. In addition, as described above, the second magnetic body may be disposed in the first groove gr1.

In addition, as described above, the first member may be disposed in the second region AR2. The first groove gr1 may be located to face the second groove gr2. For example, the first groove gr1 may be at least partially overlapped with the second groove gr2 in the third direction (Z-axis direction).

In addition, the repulsive force generated by the second magnetic body may be transferred to the fourth mounting groove 1131S4a of the holder 1131 through the second member. Accordingly, the holder may apply force to the tilting guide unit in the same direction as the repulsive force generated by the second magnetic body.

The first member may include the second groove gr2 facing the first groove gr1 formed on the outer side surface. In addition, the first member may include the second protrusion groove formed on the inner side surface as described above. In addition, the second protrusion unit may be mounted in the second protrusion groove.

In addition, like the second magnetic body, the repulsive force generated by the first magnetic body and the second magnetic body may be applied to the first member. Accordingly, the first member and the second member may press the tilting guide unit disposed between the first member and the holder 1131 through the repulsive force.

The tilting guide unit 1141 may be disposed in the third region AR3.

In addition, the first protrusion groove PH1 may be located in the fourth mounting groove 1131S4a. In addition, the first protrusion unit of the tilting guide unit 1141 may be accommodated in the first protrusion groove PH1. Accordingly, the first protrusion unit PR1 may be in contact with the first protrusion groove. The maximum diameter of the first protrusion groove PH1 may correspond to the maximum diameter of the first protrusion unit PR1. This may be equally applied to the second protrusion groove and the second protrusion unit PR2. That is, the maximum diameter of the second protrusion groove may correspond to the maximum diameter of the second protrusion unit PR2. Accordingly, the second protrusion unit may be in contact with the second protrusion groove. Through the configuration like this, the first axis tilting may occur easily with respect to the first protrusion unit and the second axis tilting may occur easily with respect to the second protrusion unit, and the radius of tilting can be improved.

In addition, as an embodiment, the first protrusion groove PH1 may be provided in plurality. For example, any one among the first protrusion groove PH1 and the second protrusion groove PH2 may include a 1-1st protrusion groove PH1a and a 1-2nd protrusion groove PH1b. Hereinafter, it will be described assuming that the first protrusion groove PH1 includes the 1-1st protrusion groove PH1a and the 1-2nd protrusion groove PH1b. In addition, the following description may be equally applied to the second protrusion groove PH2. For example, the second protrusion groove PH2 includes a 2-1st protrusion groove and a 2-2nd protrusion groove, and description of the 1-1st protrusion groove may be applied to the 2-1st protrusion groove, and description of the 1-2nd protrusion groove may be applied to the 2-2nd protrusion groove.

The 1-1st protrusion groove PH1a and the 1-2nd protrusion groove PH1b may be disposed side by side in the first direction (X-axis direction). The maximum area of the 1-1st protrusion groove PH1a may be different from or the same as that of the 1-2nd protrusion groove PH1b.

Each of the plurality of first protrusion grooves PH1 may have a different number of inclined surfaces. For example, the first protrusion groove PH1 may include a groove bottom surface and an inclined surface. At this point, each of the plurality of protrusion grooves may have a different number of inclined surfaces. In addition, the area of the bottom surface of each protrusion groove may also be different.

For example, the 1-1st protrusion groove PH1a may include a first groove bottom surface LS1 and a first inclined surface CS1. The 1-2nd protrusion groove PH1b may include a second groove bottom surface LS2 and a second inclined surface CS2.

At this point, the areas of the first groove bottom surface LS1 and the second groove bottom surface LS2 may be different from each other. The area of the first groove bottom surface LS1 may be smaller than the area of the second groove bottom surface LS2.

In addition, the number of first inclined surfaces CS1 in contact with the first groove bottom surface LS1 may be different from the number of second inclined surfaces CS2. For example, the number of first inclined surfaces CS1 may be larger than the number of second inclined surfaces CS2.

Through the configuration like this, the assembly tolerance of the first protrusion unit mounted on the first protrusion groove PH1 may be easily compensated for. For example, since the number of the first inclined surfaces CS1 is larger than the number of the second inclined surfaces CS2, the first protrusion unit is in contact with more inclined surfaces, so that the position of the first protrusion unit can be maintained more accurately in the 1-1st protrusion groove PH1a.

Unlike this, in the 1-2nd protrusion groove PH1b, the number of inclined surfaces in contact with the first protrusion unit is smaller than that of the 1-1st protrusion groove PH1b, so that the position of the first protrusion unit can be adjusted easily.

As an embodiment, the second inclined surfaces CS2 may be disposed to be spaced apart from each other in the second direction (Y-axis direction). In addition, the second groove bottom surface LS2 may be extended in the first direction (X-axis direction) so that the first protrusion unit may easily move in the first direction (X-axis direction) while being in contact with the second inclined surface CS2. That is, in the 1-2nd protrusion groove PHIb, the position of the first protrusion unit may be adjusted easily. In addition, a lubricating member may be applied to the first protrusion groove PH1.

In addition, in the present embodiment, each of the first region AR1, the second region AR2, and the third region AR3 may have a different height in the first direction (X-axis direction). As an embodiment, the height of the first region AR1 in the first direction (X-axis direction) may be higher than those of the second region AR2 and the third region AR3. Accordingly, there may be a step between the first region AR1 and the second region AR2.

In addition, the second member 1131a may include the first groove gr1. In other words, the first groove gr1 may be located on the inner side surface of the member base unit 1131aa. In addition, the second magnetic body described above may be mounted in the first groove gr1. In addition, the first groove gr1 may be provided in plurality according to the number of second magnetic bodies. That is, as many first groove gr1 may be configured as the number of second magnetic bodies.

In addition, the second member 1131a may include a member base unit 1131aa, a first extension unit 1131ab, and a second extension unit 1131ac.

The member base unit 1131aa may be located at the outermost side of the first camera actuator. The member base unit 1131aa may be located outside the first member. That is, the first member may be located between the member base unit 1131aa and the tilting guide unit.

The first extension unit 1131ab may be extended from the edge of the member base unit 1131aa in the third direction (Z-axis direction). That is, the first extension unit 1131ab may be extended from the member base unit 1131aa toward the holder 1131. This may be equally applied to the second extension unit 1131ac. In addition, the second extension unit 1131ac may be extended from the edge of the member base unit 1131aa in the third direction (Z-axis direction). As an embodiment, the first extension unit 1131ab and the second extension unit 1131ac may be located at the edges of the member base unit 1131aa in the second direction (Y-axis direction). In addition, the first extension unit 1131ab and the second extension unit 1131ac may be disposed between the upper member and the lower member.

Accordingly, the second member 1131a may have a groove formed by the first extension unit 1131ab and the second extension unit 1131ac. That is, the groove may be located between the first extension unit 1131ab and the second extension unit 1131ac. Accordingly, the first extension unit 1131ab and the second extension unit 1131ac may be connected to each other only through the member base unit 1131aa. Through the configuration like this, the second member 1131a may continuously receive the repulsive force of the second magnetic body mounted at the center, particularly, in the first groove gr1, of the member base unit 1131aa.

In addition, the first extension unit 1131ab may be spaced apart from the second extension unit 1131ac in the second direction (Y-axis direction) to form a separation space. The first member and the tilting guide unit may be mounted in the separation space. In addition, the second magnetic body and the first magnetic body may be located in the separation space.

In addition, the length of the first extension unit 1131ab may be the same as that of the second extension unit 1131ac in the third direction (Z-axis direction). Accordingly, as the coupling force, weight, and the like are formed to be balanced, tilting of the holder may be performed accurately without being inclined to one side.

In addition, the first extension unit 1131ab and the second extension unit 1131ac may be coupled to the holder. It should be understood that in this specification, they may be coupled to each other through a bonding member, in addition to the protrusion and groove structure described above. As an embodiment, the first extension unit 1131ab and the second extension unit 1131ac may include a third coupling groove 1131k formed in the third direction (Z-axis direction). In addition, in the fourth mounting groove 1131S4a, a coupling protrusion 1131m may be located in an area overlapped with the first extension unit 1131ab and the second extension unit 1131ac in the third direction (Z-axis direction). The coupling protrusion 1131m may be located in correspondence to the third coupling groove 1131k.

For example, a bonding material such as epoxy or the like may be applied to the third coupling groove 1131k. In addition, the coupling protrusion 1131m may be inserted into the third coupling grooves 1131k of the first extension unit 1131ab and the second extension unit 1131ac. Through the configuration like this, the second member 1131a and the holder 1131 may be coupled to each other. In addition, through the coupling like this, the repulsive force applied to the second member 1131a may be transferred to the holder 1131.

However, it should be understood that the positions in the protrusion and groove structure may be changed with each other as described above.

FIG. 8f is a perspective view showing a holder of a first camera actuator according to another embodiment, FIG. 8g is a bottom view showing a holder of a first camera actuator according to another embodiment, FIG. 8h is a front view showing a holder of a first camera actuator according to another embodiment, FIG. 8i is a rear view showing a second member of a first camera actuator according to another embodiment, and FIG. 8j is a bottom view showing a second member of a first camera actuator according to another embodiment.

Referring to FIGS. 8F to 8J, the holder 1131 may include a mounting surface 1131k on which the optical member 1132 is mounted. The mounting surface 1131k may be an inclined surface. It will be described below as the inclined surface 1131k of the holder 1131. Furthermore, the inclined surface 1131k of the holder 1131 may face the optical member. The inclined surface 1131k may be spaced apart from the effective area of the reflection surface of the optical member by a predetermined distance. Furthermore, the holder 1131 may include a plurality of holder grooves HG extended along at least one among one side or the other side of the inclined surface 1131k. Detailed description of the holder grooves HG will be provided below.

In addition, the holder 1131 may include a step unit on the top of the mounting surface 1131k. In addition, in the holder 1131, the step unit may be coupled to a protrusion unit (not shown) of the optical member 1132.

The holder 1131 may include a plurality of outer side surfaces. For example, the holder 1131 may include a first holder outer side surface 1131S1, a second holder outer side surface 1131S2, a third holder outer side surface 1131S3, and a fourth holder outer side surface 1131S4.

The first holder outer side surface 1131S1 may be located to face the second holder outer side surface 1131S2. That is, the first holder outer side surface 1131S1 and the second holder outer side surface 1131S2 may be disposed symmetrically with respect to the first direction (X-axis direction).

The first holder outer side surface 1131S1 may be located to correspond to the first housing side unit. That is, the first holder outer side surface 1131S1 may be located to face the first housing side unit. In addition, the second holder outer side surface 1131S2 may be located to correspond to the second housing side unit. That is, the second holder outer side surface 1131S2 may be located to face the second housing side unit.

In addition, the first holder outer side surface 1131S1 may include a first mounting groove 1131S1a. In addition, the second holder outer side surface 1131S2 may include a second mounting groove 1131S2a. The first mounting groove 1131S1a and the second mounting groove 1131S2a may be disposed symmetrically with respect to the first direction (X-axis direction).

In addition, the first mounting groove 1131S1a and the second mounting groove 1131S2a may be disposed to be overlapped in the second direction (Y-axis direction). In addition, a first magnet 1151a may be disposed in the first mounting groove 1131S1a, and a second magnet 1151b may be disposed in the second mounting groove 1131S2a. The first magnet 1151a and the second magnet 1151b may also be disposed symmetrically with respect to the first direction (X-axis direction). In this specification, it should be understood that first to third magnets may be coupled to the housing through a yoke or a bonding member. The polarity of the first magnet and the polarity of the second magnet may be located in the directions opposite to each other. For example, the N pole and S pole of the first magnet may be disposed sequentially in the third direction, and the S pole and N pole of the second magnet may be disposed sequentially in the third direction. As a modified embodiment, the polarity of the first magnet and the polarity of the second magnet may be located to be the same by controlling current injection or current directions of the first and second coils.

As described above, according to the positions of the first and second mounting grooves and the first and second magnets, the electromagnetic force induced by each magnet may be provided to the first holder outer side surface S1231S1 and the second holder outer side surface 1131S2 on the same axis. For example, an area on the first holder outer side surface S1231S1 where the electromagnetic force is applied (e.g., an area where the electromagnetic force is strongest) and an area on the second holder outer side surface S1231S1 where the electromagnetic force is applied (e.g., an area where the electromagnetic force is strongest) may be located on an axis parallel to the second direction (Y-axis direction). Therefore, X-axis tilting may be accurately performed.

The first magnet 1151a may be disposed in the first mounting groove 1131S1a, and the second magnet 1151b may be disposed in the second mounting groove 1131S2a.

The third holder outer side surface 1131S3 may be an outer side surface in contact with the first holder outer side surface 1131S1 and the second holder outer side surface 1131S2, and extended from one side of the first holder outer side surface 1131S1 and the second holder outer side surface 1131S2 in the second direction (Y-axis direction). In addition, the third holder outer side surface 1131S3 may be located between the first holder outer side surface 1131S1 and the second holder outer side surface 1131S2. The third holder outer side surface 1131S3 may be the bottom surface in the holder 1131. That is, the third holder outer side surface 1131S3 may be located to face the third housing side unit.

In addition, the third holder outer side surface 1131S3 may include a third mounting groove 1131S3a. The third magnet 1151c may be disposed in the third mounting groove 1131S3a. The third holder outer side surface 1131S3 may be located to face the third housing side unit 1123.

In addition, the third housing hole 1123a may be at least partially overlapped with the third mounting groove 1131S3a in the first direction (X-axis direction). Accordingly, the third magnet 1151c in the third mounting groove 1131S3a and the third coil 1152c in the third housing hole 1123a may be located to face each other. In addition, as the third magnet 1151c and the third coil 1152c generate electromagnetic force, the second camera actuator may perform Y-axis tilting.

In addition, X-axis tilting is accomplished by a plurality of magnets (the first and second magnets 1151a and 1151b), whereas Y-axis tilting may be accomplished only by the third magnet 1151c.

As an embodiment, the area of the third mounting groove 1131S3a may larger than that of the first mounting groove 1131S1a or the second mounting groove 1131S2a. Through the configuration like this, Y-axis tilting may be performed with current control similar to that of X-axis tilting.

The fourth holder outer side surface 1131S4 may be an outer side surface in contact with the first holder outer side surface 1131S1 and the second holder outer side surface 1131S2, and extended from the first holder outer side surface 1131S1 and the second holder outer side surface 1131S2 in the first direction (X-axis direction). In addition, the fourth holder outer side surface 1131S4 may be located between the first holder outer side surface 1131S1 and the second holder outer side surface 1131S2. That is, the fourth holder outer side surface 1131S4 may be located to face the first member.

The fourth holder outer side surface 1131S4 may include a fourth mounting groove 1131S4a. The tilting guide unit 1141 may be located in the fourth mounting groove 1131S4a. In addition, the second member 1131a and the first member 1126 may be located in the fourth mounting groove 1131S4a. In addition, the fourth mounting groove 1131S4a may include a plurality of regions. It may include a first region AR1, a second region AR2, and a third region AR3.

The second member 1131a may be located in the first region AR1. That is, the first region AR1 may be overlapped with the second member 1131a in the first direction (X-axis direction). In particular, the first region AR1 may be an area where the member base unit of the second member 1131a is located. At this point, the first region AR1 may be located on the fourth holder outer side surface 1131S4. That is, the first region AR1 may correspond to an area located on the top side of the fourth mounting groove 1131S4a. In this case, the first region AR1 may not be an area inside the fourth mounting groove 1131S4a.

The first member 1126 may be located in the second region AR2. That is, the second region AR2 may be overlapped with the first member 1126 in the first direction (X-axis direction).

In addition, the second region AR2 may be located on the fourth holder outer side surface 1131S4, like the first region. That is, the second region AR2 may correspond to an area located on the top of the fourth mounting groove 1131S4a.

The tilting guide unit may be located in the third region AR3. In particular, the base of the tilting guide unit may be located in the third region AR3. That is, the third region AR3 may be overlapped with the tilting guide unit (e.g., the base) in the first direction (X-axis direction).

In addition, the second region AR2 may be located between the first region AR1 and the third region AR3.

In addition, the second member is disposed in the first region AR1, and the second member 1131a may include a first groove gr1. As an embodiment, the second member 1131a may include the first groove gr1 formed on the inner side surface 1131aas. In addition, as described above, the second magnetic body may be disposed in the first groove gr1.

In addition, as described above, the first member may be disposed in the second region AR2. The first groove gr1 may be located to face the second groove gr2. For example, the first groove gr1 may be at least partially overlapped with the second groove gr2 in the third direction (Z-axis direction).

In addition, the repulsive force generated by the second magnetic body may be transferred to the fourth mounting groove 1131S4a of the holder 1131 through the second member. Accordingly, the holder may apply force to the tilting guide unit in the same direction as the repulsive force generated by the second magnetic body.

The first member may include the second groove gr2 facing the first groove gr1 formed on the outer side surface. In addition, the first member may include the second protrusion groove formed on the inner side surface as described above. In addition, the second protrusion unit may be mounted in the second protrusion groove.

In addition, like the second magnetic body, the repulsive force generated by the first magnetic body and the second magnetic body may be applied to the first member. Accordingly, the first member and the second member may press the tilting guide unit disposed between the first member and the holder 1131 through the repulsive force.

The tilting guide unit 1141 may be disposed in the third region AR3.

In addition, the first protrusion groove PH1 may be located in the fourth mounting groove 1131S4a. In addition, the first protrusion unit of the tilting guide unit 1141 may be accommodated in the first protrusion groove PH1. Accordingly, the first protrusion unit PR1 may be in contact with the first protrusion groove. The maximum diameter of the first protrusion groove PH1 may correspond to the maximum diameter of the first protrusion unit PR1. This may be equally applied to the second protrusion groove and the second protrusion unit PR2. That is, the maximum diameter of the second protrusion groove may correspond to the maximum diameter of the second protrusion unit PR2. Accordingly, the second protrusion unit may be in contact with the second protrusion groove. Through the configuration like this, the first axis tilting may occur easily with respect to the first protrusion unit, and the second axis tilting may occur easily with respect to the second protrusion unit, and the radius of tilting can be improved.

In addition, as an embodiment, the first protrusion groove PH1 may be provided in plurality. For example, any one among the first protrusion groove PH1 and the second protrusion groove PH2 may include a 1-1st protrusion groove PH1a and a 1-2nd protrusion groove PH1b. Hereinafter, it will be described assuming that the first protrusion groove PH1 includes the 1-1st protrusion groove PH1a and the 1-2nd protrusion groove PH1b. In addition, the following description may be equally applied to the second protrusion groove PH2. For example, the second protrusion groove PH2 includes a 2-1st protrusion groove and a 2-2nd protrusion groove, and description of the 1-1st protrusion groove may be applied to the 2-1st protrusion groove, and description of the 1-2nd protrusion groove may be applied to the 2-2nd protrusion groove.

The 1-1st protrusion groove PH1a and the 1-2nd protrusion groove PHIb may be disposed side by side in the first direction (X-axis direction). The maximum area of the 1-1st protrusion groove PH1a may be the same as that of the 1-2nd protrusion groove PH1b.

Each of the plurality of first protrusion grooves PH1 may have a different number of inclined surfaces. For example, the first protrusion groove PH1 may include a groove bottom surface and an inclined surface. At this point, each of the plurality of protrusion grooves may have a different number of inclined surfaces. In addition, the area of the bottom surface of each protrusion groove may also be different.

For example, the 1-1st protrusion groove PH1a may include a first groove bottom surface LS1 and a first inclined surface CS1. The 1-2nd protrusion groove PHIb may include a second groove bottom surface LS2 and a second inclined surface CS2.

At this point, the areas of the first groove bottom surface LS1 and the second groove bottom surface LS2 may be different from each other. The area of the first groove bottom surface LS1 may be smaller than the area of the second groove bottom surface LS2.

In addition, the number of first inclined surfaces CS1 in contact with the first groove bottom surface LS1 may be different from the number of second inclined surfaces CS2. For example, the number of first inclined surfaces CS1 may be larger than the number of second inclined surfaces CS2.

Through the configuration like this, the assembly tolerance of the first protrusion unit mounted on the first protrusion groove PH1 may be easily compensated for. For example, since the number of the first inclined surfaces CS1 is larger than the number of the second inclined surfaces CS2, the first protrusion unit is in contact with more inclined surfaces, so that the position of the first protrusion unit can be maintained more accurately in the 1-1st protrusion groove PH1a.

Unlike this, in the 1-2nd protrusion groove PHIb, the number of inclined surfaces in contact with the first protrusion unit is smaller than that of the 1-1st protrusion groove PHIb, so that the position of the first protrusion unit can be adjusted easily.

As an embodiment, the second inclined surfaces CS2 may be disposed to be spaced apart from each other in the second direction (Y-axis direction). In addition, the second groove bottom surface LS2 may be extended in the first direction (X-axis direction) so that the first protrusion unit may easily move in the first direction (X-axis direction) while being in contact with the second inclined surface CS2. That is, in the 1-2nd protrusion groove PH1b, the position of the first protrusion unit may be adjusted easily.

In addition, in the present embodiment, each of the first region AR1, the second region AR2, and the third region AR3 may have a different height in the first direction (X-axis direction). As an embodiment, the height of the first region AR1 in the first direction (X-axis direction) may be higher than those of the second region AR2 and the third region AR3. Accordingly, there may be a step between the first region AR1 and the second region AR2.

In addition, the second member 1131a may include the first groove gr1. In other words, the first groove gr1 may be located on the inner side surface of the member base unit 1131aa. In addition, the second magnetic body described above may be mounted in the first groove gr1. In addition, the first groove gr1 may be provided in plurality according to the number of second magnetic bodies. That is, as many first groove gr1 may be configured as the number of second magnetic bodies.

In addition, the second member 1131a may include a member base unit 1131aa, a first extension unit 1131ab, and a second extension unit 1131ac.

The member base unit 1131aa may be located at the outermost side of the first camera actuator. The member base unit 1131aa may be located outside the first member. That is, the first member may be located between the member base unit 1131aa and the tilting guide unit.

The first extension unit 1131ab may be extended from the edge of the member base unit 1131aa in the third direction (Z-axis direction). That is, the first extension unit 1131ab may be extended from the member base unit 1131aa toward the holder 1131. This may be equally applied to the second extension unit 1131ac. In addition, the second extension unit 1131ac may be extended from the edge of the member base unit 1131aa in the third direction (Z-axis direction). As an embodiment, the first extension unit 1131ab and the second extension unit 1131ac may be located at the edges of the member base unit 1131aa in the second direction (Y-axis direction). In addition, the first extension unit 1131ab and the second extension unit 1131ac may be disposed between the upper member and the lower member.

Accordingly, the second member 1131a may have a groove formed by the first extension unit 1131ab and the second extension unit 1131ac. That is, the groove may be located between the first extension unit 1131ab and the second extension unit 1131ac. Accordingly, the first extension unit 1131ab and the second extension unit 1131ac may be connected to each other only through the member base unit 1131aa. Through the configuration like this, the second member 1131a may continuously receive the repulsive force of the second magnetic body mounted at the center, particularly, in the first groove gr1, of the member base unit 1131aa.

In addition, as the second member 1131a is coupled to the holder and moves when X-axis tilting and Y-axis tilting are performed, rigidity of the second member 1131a may be higher than the rigidity of the first member.

Furthermore, as described above, as the first member according to an embodiment has an upper member and a lower member, rigidity thereof can be increased. Through the configuration like this, the difference in rigidity between the second member and the first member can be reduced. Therefore, when the second member 1131a and the holder 1131 coupled to the second member 1131a tilt together with respect to the X axis or Y axis, the adjacent distance between the second member 1131a and the first member is reduced, and the second member 1131a may be in contact with the first member. Accordingly, since rigidity of the first member is improved as described above, it may easily perform an operation as a stopper. That is, reliability of the camera actuator can be improved.

Furthermore, as the difference in rigidity between the first member and the second member is reduced, damage due to the contact at the moment of tilting can be minimized. That is, reliability of the camera actuator can be improved.

In addition, the first extension unit 1131ab may be spaced apart from the second extension unit 1131ac in the second direction (Y-axis direction) to form a separation space. The first member and the tilting guide unit may be mounted in the separation space. In addition, the second magnetic body and the first magnetic body may be located in the separation space.

In addition, the length of the first extension unit 1131ab may be the same as that of the second extension unit 1131ac in the third direction (Z-axis direction). Accordingly, as the coupling force, weight, and the like are formed to be balanced, tilting of the holder may be performed accurately without being inclined to one side.

In addition, the first extension unit 1131ab and the second extension unit 1131ac may be coupled to the holder. It should be understood that in this specification, they may be coupled to each other through a bonding member, in addition to the protrusion and groove structure described above. As an embodiment, the first extension unit 1131ab and the second extension unit 1131ac may include a third coupling groove 1131k formed in the third direction (Z-axis direction). In addition, in the fourth mounting groove 1131S4a, a coupling protrusion 1131m may be located in an area overlapped with the first extension unit 1131ab and the second extension unit 1131ac in the third direction (Z-axis direction). The coupling protrusion 1131m may be located in correspondence to the third coupling groove 1131k.

For example, a bonding material such as epoxy or the like may be applied to the third coupling groove 1131k. In addition, the coupling protrusion 1131m may be inserted into the third coupling grooves 1131k of the first extension unit 1131ab and the second extension unit 1131ac. Through the configuration like this, the second member 1131a and the holder 1131 may be coupled to each other. In addition, through the coupling like this, the repulsive force applied to the second member 1131a may be transferred to the holder 1131.

However, it should be understood that the positions in the protrusion and groove structure may be changed with each other as described above.

FIG. 8k is a perspective view showing a holder and an optical member according to a first embodiment, FIG. 8l is a perspective view and a cross-sectional view showing a holder and an optical member according to a first embodiment, FIG. 8m is a side view showing a holder and an optical member according to a first embodiment, FIG. 8n is a perspective view showing a holder according to a first modified embodiment, and FIG. 8o is a side view showing a holder and an optical member according to a first modified embodiment.

Referring to FIGS. 8k and 8m, the optical member 1132 may be located on the inclined surface 1131k of the holder 1131 according to a first embodiment. The optical member 1132 may be coupled to the holder 1131 by a bonding member (e.g., epoxy) through the side surfaces, excluding the incident surface 1132a, the reflection surface 1132b, and the light-emitting surface 1132c.

In addition, the holder 1131 according to an embodiment may include an inclined surface 1131k facing the optical member 1132, and a plurality of holder grooves extended along at least one among one side or the other side of the inclined surface 1131k. In the present embodiment, one side or the other side of the inclined surface may correspond to one edge or the other edge. For example, the inclined surface may have a long side or a short side, and the long side may correspond to one side, and the short side may correspond to the other side, or vice versa. In addition, when the edges of the inclined surface are of equal length, one edge among the edges may correspond to one side, and another edge in contact with the one edge may correspond to the other edge. Furthermore, when the shape of the inclined surface 1131k is not a square, an edge in one direction on the reflection surface may correspond to the one side, and an edge in a direction perpendicular to the one direction may correspond to the other side.

Furthermore, in the present embodiment, the plurality of holder grooves may include first holder grooves HG1 extended along one side of the inclined surface. The plurality of first holder grooves HG1 may be extended in the second direction (Y-axis direction). Accordingly, the length of the first holder grooves HG1 in the second direction may be longer than the length along the other side. Furthermore, a groove for an ejector pin or a shell may be further disposed on the inclined surface 1131k. At this point, the holder groove (e.g., the first holder groove) may or may not be overlapped with the groove for the push pin or the slit. In the drawing, it will be described assuming that the holder groove is not overlapped with the groove for the push pin or the slit.

In addition, in the present embodiment, the holder groove is described as a structure configured of two inclined surfaces or two surfaces like a prism. However, it is not limited thereto, and the shape of the holder groove may include a surface of different angles and a round surface. In addition, the horizontal length of the surface of the groove may be different or the same. In the same way, the vertical length of the surface of the groove may also be the same or different.

In the embodiment, the first holder groove HG1 may include a first groove region HG1a overlapped with the effective area EA of the light-emitting surface 1132c, and a second groove region HG1b not overlapped with the effective area EA of the light-emitting surface 1132c. At this point, the first groove region HG1a may be overlapped with the effective area EA of the light-emitting surface 1132c in the third direction (Z-axis direction). In addition, the second groove region HG1b may not be overlapped with the effective area EA of the light-emitting surface 1132c in the third direction (Z-axis direction).

At this point, the second groove region HG1b may be disposed to surround the first groove region HG1a. In addition, the second groove region HG1b may be located outside the first groove region HG1a as a closed loop or an open loop. In addition, the second groove region HG1b may be disposed to surround the first groove region HG1a. In addition, the second groove region HG1b may be located outside the first groove region HG1a. In other words, the first groove region HG1a may be located inside the second groove region HG1b.

Furthermore, the first holder groove HG1 may be formed in any area other than the groove region for the slit.

In addition, the area of the first groove region HG1a may be larger than the area of the second groove region HG1b. In addition, although most of the light is reflected in the effective area of the reflection surface 1132b, some light may not be reflected from the reflection surface 1132b unintendedly. In this way, some light may unintendedly move to the first groove region HG1a, rather than the second groove region HG1b. In addition, in the embodiment, as the area of the first groove region HG1a is prepared to be larger than the area of the second groove region HG1b, the flare phenomenon generated by some unintendedly reflected and diffracted light can be suppressed.

Furthermore, in the plurality of first holder grooves HG1, the separation distances gp1 and gp2 between adjacent first holder grooves HG1 may be the same or different. In the embodiment, in the plurality of first holder grooves HG1, the separation distances between adjacent first holder grooves HG1 may be the same.

Alternatively, the distance between adjacent first holder grooves HG1 may vary toward the outside with respect to the center of the inclined surface 1131k. Alternatively, the distance between adjacent first holder grooves HG1 may increase toward the center of the inclined surface 1131k. For example, the distance gp2 between the first holder grooves HG1 adjacent to the outer side of the inclined surface 1131k may be different from the distance gp1 between the first holder grooves HG1 adjacent to the center of the inclined surface 1131k. For example, the distance gp2 between the first holder grooves HG1 adjacent to the outer side of the inclined surface 1131k may be larger than the distance gp1 between the first holder grooves HG1 adjacent to the center of the inclined surface 1131k.

In addition, the first holder groove HG1 may include a first groove surface f1 and a second groove surface f2. The first groove surface f1 may be in contact with the second groove surface f2. Furthermore, the first groove surface f1 may be side by side with the light-emitting surface 1132c. That is, the first groove surface f1 may be parallel to the light-emitting surface 1132c. In addition, the second groove surface f2 may be side by side with the incident surface 1132a. That is, the second groove surface f2 may be parallel to the incident surface 1132a.

As another example, the first groove surface f1 may be partially parallel to the light-emitting surface 1132c. That is, the first groove surface f1 may form a predetermined angle with the light-emitting surface 1132c. In this case, the predetermined angle includes an angle formed with a virtual plane extended from the surface.

In addition, the second groove surface f2 may be side by side with the incident surface 1132a. Furthermore, the second groove surface f2 may form a predetermined angle with the incident surface 1132a.

For example, the angle θₐ formed by the first groove surface f1 and the second groove surface f2 may be 80 to 110 degrees. Preferably, the angle θₐ may be 85 to 105 degrees. In addition, the angle θₐ may be 90 degrees.

In addition, as an embodiment, the first distance ds1 may be larger than the second distance ds2. Here, the first distance ds1 is the distance between the edge where the first groove surface f1 and the second groove surface f2 meet and the reflection surface 1131k. In addition, the second distance ds2 may be the minimum distance between the first groove surface f1 or the second groove surface f2 and the reflection surface 1132b. That is, the first holder groove HG1 may be disposed to be further spaced apart from the reflection surface 1132b than from the inclined surface 1131k in some areas.

In addition, as described above, the inclined surface 1131k of the holder 1131 may face the reflection surface 1132b of the optical member 1132. In addition, the effective area of the reflection surface 1132b may be spaced apart from the inclined surface 1131k by a predetermined distance ds0. That is, a predetermined space may exist between the inclined surface 1131k and the reflection surface 1132b. In addition, the length La of one side may be different from or equal to the length Lb of the other side. In the present specification, the length La of one side may be longer than the length Lb of the other side.

Referring to FIGS. 8n and 8o, descriptions of the holder and the optical member according to a first embodiment may be equally applied, except those described below.

In a first modified embodiment, the first holder groove HG1 may be disposed to be overlapped with the effective area EA of the light-emitting surface 1132c. That is, the second groove region described above may not exist. Through the configuration like this, the first holder groove HG1 may be located to be spaced apart from the edge of the inclined surface 1131k by a predetermined distance. Therefore, the first holder groove HG1 may be formed in correspondence to the effective area considering unintended concentration of light. Accordingly, the flare phenomenon can be suppressed more efficiently.

Furthermore, the first holder groove HG1 may be disposed only on some of the edges of the inclined surface 1131k. Accordingly, some of the first holder grooves HG1 may also be disposed on the edges of the inclined surface 1131k.

FIG. 8p is a perspective view showing a holder and an optical member according to a second modified embodiment, FIG. 8q is a perspective view and a cross-sectional view showing a holder and an optical member according to a second embodiment, FIG. 8r is a side view showing a holder and an optical member according to a second embodiment, and FIG. 8s is a side view showing a holder and an optical member according to a second modified embodiment.

Referring to FIGS. 8p to 8r, the optical member 1132 may be located on the inclined surface 1131k of the holder 1131 according to a second embodiment. The optical member 1132 may be coupled to the holder 1131 by a bonding member (e.g., epoxy) through the side surfaces, excluding the incident surface 1132a, the reflection surface 1132b, and the light-emitting surface 1132c. In addition, descriptions of the holder and the optical member may be equally applied, except those described below. In addition, the holder 1131 according to a second embodiment may include a holder groove, i.e., a second holder groove HG2, located on the inclined surface 1131k and extended toward the other side. The second holder groove HG2 may be a groove extended along the other side or the short side of the inclined surface. The extended direction of the second holder groove HG2 may be perpendicular to that of the first holder groove described above.

In the embodiment, the second holder groove HG2 may include a third groove region HG2a overlapped with the effective area EA of the light-emitting surface 1132c, and a fourth groove region HG2b not overlapped with the effective area EA of the light-emitting surface 1132c. At this point, the third groove region HG2a may be overlapped with the effective area EA of the light-emitting surface 1132c in the third direction (Z-axis direction). In addition, the fourth groove region HG2b may not be overlapped with the effective area EA of the light-emitting surface 1132c in the third direction (Z-axis direction).

At this point, the fourth groove region HG2b may be disposed to surround the third groove region HG2a. In addition, the fourth groove region HG2b may be located outside the third groove region HG2a. In other words, the third groove region HG2a may be located inside the fourth groove region HG2b.

In addition, the area of the third groove region HG2a may be larger than the area of the fourth groove region HG2b. In addition, although most of the light is reflected in the effective area of the reflection surface 1132b, some light may not be reflected from the reflection surface 1132b unintendedly. In this way, some light may unintendedly move to the third groove region HG2a, rather than the fourth groove region HG2b. In addition, in the embodiment, as the area of the third groove region HG2a is prepared to be larger than the area of the fourth groove region HG2b, the flare phenomenon generated by some unintendedly reflected and diffracted light can be suppressed.

Furthermore, in the plurality of second holder grooves HG2, the separation distances gp3 and gp4 between adjacent second holder grooves HG2 may be the same. Alternatively, the distance between adjacent second holder grooves HG2 may increase toward the center of the inclined surface 1131k. For example, the distance gp4 between the second holder grooves HG2 adjacent to the outer side of the inclined surface 1131k may be different from the distance gp3 between the second holder grooves HG2 adjacent to the center of the inclined surface 1131k. For example, the distance gp4 between the second holder grooves HG2 adjacent to the outer side of the inclined surface 1131k may be larger than the distance gp3 between the second holder grooves HG2 adjacent to the center of the inclined surface 1131k.

In addition, the second holder groove HG2 may include a third groove surface f3 and a fourth groove surface f4. The third groove surface f3 may be in contact with the fourth groove surface f4. Furthermore, the third groove surface f3 may be misaligned with (e.g., perpendicular to) the light-emitting surface 1132c. In addition, the fourth groove surface f4 may be misaligned with (e.g., perpendicular to) the incident surface 1132a.

Furthermore, the angle θₐ formed by the third groove surface f3 and the fourth groove surface f4 may be 80 to 110 degrees. Preferably, the angle θ_{b} may be 85 to 105 degrees. In addition, the angle θₐ may be 90 degrees.

In addition, as an embodiment, the third distance may be larger than the fourth distance. Here, the third distance is the distance between the edge where the third groove surface f3 and the fourth groove surface f4 meet and the reflection surface 1131k. In addition, the fourth distance may be the minimum distance between the third groove surface f3 or the fourth groove surface f4 and the reflection surface 1132b. That is, the second holder groove HG2 may be disposed to be further spaced apart from the reflection surface 1132b than from the inclined surface 1131k in some areas.

In addition, as described above, the inclined surface 1131k of the holder 1131 may face the reflection surface 1132b of the optical member 1132. In addition, the effective area of the reflection surface 1132b may be spaced apart from the inclined surface 1131k by a predetermined distance. That is, a predetermined space may exist between the inclined surface 1131k and the reflection surface 1132b. In addition, the length La of one side may be different from or equal to the length Lb of the other side. In the present specification, the length La of one side may be longer than the length Lb of the other side.

Referring to FIG. 8s, descriptions of the holder and the optical member according to a second embodiment may be equally applied, except those described below.

In a second modified embodiment, the second holder groove HG2 may be disposed to be overlapped with the effective area EA of the light-emitting surface 1132c. That is, the fourth groove region described above may not exist. Through the configuration like this, the second holder groove HG2 may be located to be spaced apart from the edge of the inclined surface 1131k by a predetermined distance. Therefore, the second holder groove HG2 may be formed in correspondence to the effective area considering unintended concentration of light. Accordingly, the flare phenomenon can be suppressed more efficiently.

FIG. 8t is a perspective view showing a holder and an optical member according to a third embodiment, FIG. 8u is a perspective view and a cross-sectional view showing a holder and an optical member according to a third embodiment, FIG. 8v is a perspective view and another cross-sectional view showing a holder and an optical member according to a third embodiment, FIG. 8w is a side view showing a holder and an optical member according to a third embodiment, and FIG. 8x is a side view showing a holder and an optical member according to a third modified embodiment.

Referring to FIGS. 8t to 8w, descriptions of the holder and the optical member may be equally applied, except those described below.

The holder 1131 according to an embodiment may include an inclined surface 1131k facing the optical member 1132, and a plurality of holder grooves extended along at least one among one side and the other side of the inclined surface 1131k. In a third embodiment, the holder 1131 may include a first holder groove HG1 extended along one side and a second holder groove HG2 extended along the other side.

The plurality of first holder grooves HG1 may be extended in the second direction (Y-axis direction). Accordingly, the length of the first holder grooves HG1 in the second direction may be longer than the length along the other side.

In addition, the second holder groove HG2 may be a groove extended along the other side or the short side of the inclined surface. The extended direction of the second holder groove HG2 may be perpendicular to that of the first holder groove HG1 described above.

The first holder groove HG1 and the second holder groove HG2 may intersect with each other. For example, one first holder groove HG1 may partially intersect with a plurality of second holder grooves HG2. In addition, one second holder groove HG2 may partially intersect with a plurality of first holder grooves HG1. That is, the first holder groove HG1 and the second holder groove HG2 may be overlapped with each other.

In addition, the first holder groove HG1 may include a first groove region HG1a overlapped with the effective area EA of the light-emitting surface 1132c, and a fourth groove region HG2b not overlapped with the effective area EA of the light-emitting surface 1132c. At this point, the first groove region HG1a may be overlapped with the effective area EA of the light-emitting surface 1132c in the third direction (Z-axis direction). In addition, the second groove region HG1b may not be overlapped with the effective area EA of the light-emitting surface 1132c in the third direction (Z-axis direction).

In addition, the second holder groove HG2 may include a third groove region HG2a overlapped with the effective area EA of the light-emitting surface 1132c, and a fourth groove region HG2b not overlapped with the effective area EA of the light-emitting surface 1132c. At this point, the third groove region HG2a may be overlapped with the effective area EA of the light-emitting surface 1132c in the third direction (Z-axis direction). In addition, the fourth groove region HG2b may not be overlapped with the effective area EA of the light-emitting surface 1132c in the third direction (Z-axis direction).

The first groove region HG1a may intersect or be overlapped with the third groove region HG2a, and the second groove region HG1b may intersect or be overlapped with the fourth groove region HG2b.

Furthermore, the second groove region HG1b may be disposed to surround the first groove region HG1a. In addition, the second groove region HG1b may be located outside the first groove region HG1a. In other words, the first groove region HG1a may be located inside the second groove region HG1b. In addition, the fourth groove region HG2b may be disposed to surround the third groove region HG2a. In addition, the fourth groove region HG2b may be located outside the third groove region HG2a. In other words, the third groove region HG2a may be located inside the fourth groove region HG2b.

In addition, the first groove region HG1a or the third groove region HG2a may be located inside the second groove region H1b or the fourth groove region HG2b. In other words, the second groove region H1b or the fourth groove region HG2b may be located outside the first groove region HG1a or the third groove region HG2a.

In addition, the area of the first groove region HG1a may be larger than the area of the second groove region HG1b. In addition, the area of the third groove region HG2a may be larger than the area of the fourth groove region HG2b.

At this point, although most of the light is reflected in the effective area of the reflection surface 1132b as described above, some light may not be reflected from the reflection surface 1132b unintendedly. In this way, some light may unintendedly move to the first groove region HG1a (or the third groove region HG2a), rather than the second groove region HG1b (or the fourth groove region HG2b). In addition, in the embodiment, as the area of the first groove region HG1a (or the third groove region HG2a) is prepared to be larger than the area of the second groove region HG1b (or the fourth groove region HG2b), the flare phenomenon generated by some unintendedly reflected and diffracted light can be suppressed.

Furthermore, in the plurality of first holder grooves HG1, the separation distances gp1 and gp2 between adjacent first holder grooves HG1 may be the same. Alternatively, the distance between adjacent first holder grooves HG1 may increase toward the center of the inclined surface 1131k. For example, the distance gp2 between the first holder grooves HG1 adjacent to the outer side of the inclined surface 1131k may be different from the distance gp1 between the first holder grooves HG1 adjacent to the center of the inclined surface 1131k. For example, the distance gp2 between the first holder grooves HG1 adjacent to the outer side of the inclined surface 1131k may be larger than the distance gp1 between the first holder grooves HG1 adjacent to the center of the inclined surface 1131k.

In the plurality of second holder grooves HG2, the separation distances gp3 and gp4 between adjacent second holder grooves HG2 may be the same. Alternatively, the distance between adjacent second holder grooves HG2 may increase toward the center of the inclined surface 1131k. For example, the distance gp4 between the second holder grooves HG2 adjacent to the outer side of the inclined surface 1131k may be different from the distance gp3 between the second holder grooves HG2 adjacent to the center of the inclined surface 1131k. For example, the distance gp4 between the second holder grooves HG2 adjacent to the outer side of the inclined surface 1131k may be larger than the distance gp3 between the second holder grooves HG2 adjacent to the center of the inclined surface 1131k.

In addition, the first holder groove HG1 may include a first groove surface f1 and a second groove surface f2. The first groove surface f1 may be in contact with the second groove surface f2. Furthermore, the first groove surface f1 may be side by side with the light-emitting surface 1132c. That is, the first groove surface f1 may be parallel to the light-emitting surface 1132c. In addition, the second groove surface f2 may be side by side with the incident surface 1132a. That is, the second groove surface f2 may be parallel to the incident surface 1132a. Furthermore, the second holder groove HG2 may include a third groove surface f3 and a fourth groove surface f4. The third groove surface f3 may be in contact with the fourth groove surface f4. Furthermore, the third groove surface f3 may be perpendicular to the light-emitting surface 1132c. In addition, the fourth groove surface f4 may be perpendicular to the incident surface 1132a.

In addition, as an embodiment, the third distance may be larger than the fourth distance. Here, the third distance is the distance between the edge where the third groove surface f3 and the fourth groove surface f4 meet and the reflection surface 1131k. In addition, the fourth distance may be the minimum distance between the third groove surface f3 or the fourth groove surface f4 and the reflection surface 1132b. That is, the second holder groove HG2 may be disposed to be further spaced apart from the reflection surface 1132b than from the inclined surface 1131k in some areas.

Referring to FIG. 8x, descriptions of the first modified embodiment and the second modified embodiment may be equally applied, except those described below.

In this modified embodiment, the first holder groove HG1 may be disposed to be overlapped with the effective area EA of the light-emitting surface 1132c. That is, the second groove region described above may not exist. The second holder groove HG2 may be disposed to be overlapped with the effective area EA of the light-emitting surface 1132c. That is, the fourth groove region described above may not exist. Therefore, the first groove region and the second groove region may intersect or be overlapped with each other.

Through the configuration like this, the first holder groove HG1 or the second holder groove HG2 may be located to be spaced apart from the edge of the inclined surface 1131k by a predetermined distance. Therefore, the first holder groove HG1 may be formed in correspondence to the effective area considering unintended concentration of light. Accordingly, the flare phenomenon can be suppressed more efficiently.

FIG. 8y is a view explaining the effect of a holder and an optical member according to an embodiment.

FIG. 8y(a) shows an image formed on an image sensor in a dark room when the first holder groove or the second holder groove is not formed on the inclined surface of the holder. That is, it can be seen that a flare phenomenon occurs as shown in FIG. 8y(a). Unlike this, FIG. 8y(b) shows an image formed on an image sensor in a dark room when the first holder groove or the second holder groove is formed on the inclined surface of the holder. As described above, it can be seen that the flare phenomenon induced by unintended refraction or reflection of light by the first holder groove or the second holder groove is suppressed.

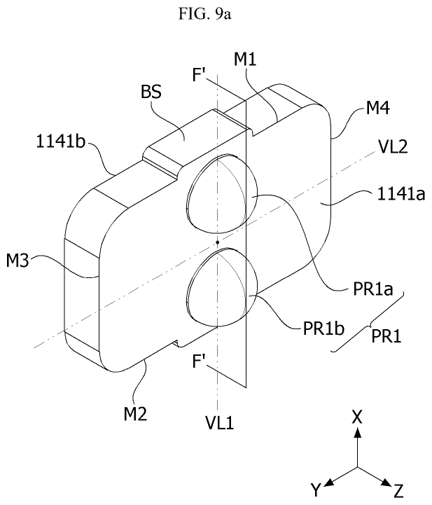

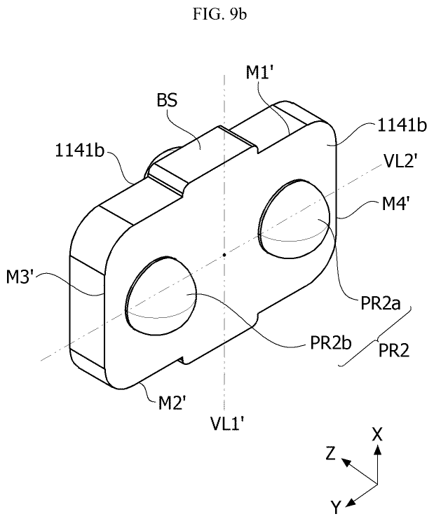

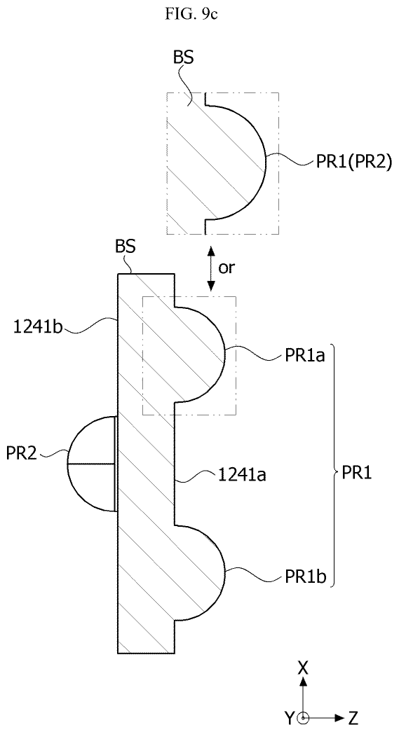

FIG. 9a is a perspective view showing a tilting guide unit of a first camera actuator according to an embodiment, FIG. 9b is a perspective view in a direction different from that of FIG. 9a, and FIG. 9c is a view taken along the line FF′ in FIG. 9a.

The tilting guide unit 1141 according to an embodiment may include a base BS, a first protrusion unit PR1 protruding from a first surface 1141a of the base BS, and a second protrusion unit PR2 protruding from a second surface 1141b of the base BS. In addition, the surfaces where the first protrusion unit and the second protrusion unit are formed may be opposite to each other according to the structure, and this will be described below with reference to the drawings. In addition, it should be understood that the first protrusion unit PR1 and the second protrusion unit PR2 may be formed to be integrated with the base BS, and that the first protrusion unit PR1 and the second protrusion unit RP2 may have a spherical shape like a ball as shown in the drawing. In addition, the first protrusion unit PR1 and the second protrusion unit RP2 may not be a projection or protrusion shape, but a ball.

First, the base BS may include a first surface 1141a and a second surface 1141b facing the first surface 1141a. That is, the first surface 1141a may be spaced apart from the second surface 1141b in the third direction (Z-axis direction), and the first and second surfaces may be outer side surfaces facing or opposing each other inside the tilting guide unit 1141.

The tilting guide unit 1141 may include a first protrusion unit PR1 extended from the first surface 1141a toward one side. According to an embodiment, the first protrusion unit PR1 may protrude from the first surface 1141a toward the holder. The first protrusion unit PR1 is provided in plurality, and may include a 1-1st protrusion unit PR1a and a 1-2nd protrusion unit PR1b.

The 1-1st protrusion unit PR1a and the 1-2nd protrusion unit PR1b may be located side by side in the first direction (X-axis direction). In other words, the 1-1st protrusion unit PR1a and the 1-2nd protrusion unit PR1b may be overlapped in the first direction (X-axis direction). In addition, in the embodiment, the 1-1st protrusion unit PR1a and the 1-2nd protrusion unit PR1b may be bisected by an imaginary line extended in the first direction (X-axis direction).

In addition, the 1-1st protrusion unit PR1a and the 1-2nd protrusion unit PR1b have a curvature, and may be, for example, a hemispherical shape. In addition, the 1-1st protrusion unit PR1a and the 1-2nd protrusion unit PR1b may be in contact with the first groove of the housing at a point farthest spaced apart from the first surface 1141a of the base BS.

In addition, the tilting guide unit 1141 may include a second protrusion unit PR2 extended from the second surface 1141a toward one side. According to an embodiment, the second protrusion unit PR2 may protrude from the second surface 1141b toward the housing. In addition, the second protrusion unit PR2 is provided in plurality, and may include a 2-1st protrusion unit PR2a and a 2-2nd protrusion unit PR2b in an embodiment.

The 2-1st protrusion unit PR2a and the 2-2nd protrusion unit PR2b may be located side by side in the second direction (Y-axis direction). That is, the 2-1st protrusion unit PR2a and the 2-2nd protrusion unit PR2b may be overlapped in the second direction (Y-axis direction). In addition, in the embodiment, the 2-1st protrusion unit PR2a and the 2-2nd protrusion unit PR2b may be bisected by an imaginary line extended in the second direction (Y-axis direction).

The 2-1st protrusion unit PR2a and the 2-2nd protrusion unit PR2b may have a curvature, and may be, for example, a hemispherical shape. In addition, the 2-1st protrusion unit PR2a and the 2-2nd protrusion unit PR2b may be in contact with the second member 1131a at a point spaced apart from the second surface 1141b of the base BS.

The 1-1st protrusion unit PR1a and the 1-2nd protrusion unit PR1b may be located in an area between the 2-1st protrusion unit PR2a and the 2-2nd protrusion unit PR2b in the second direction. According to an embodiment, the 1-1st protrusion unit PR1a and the 1-2nd protrusion unit PR1b may be located at the center of a separation space between the 2-1st protrusion unit PR2a and the 2-2nd protrusion unit PR2b in the second direction. Through the configuration like this, the actuator according to an embodiment may allow X-axis tilting to have the same range of angle with respect to the X-axis. In other words, the tilting guide unit 1141 may provide a range (e.g., positive/negative range) of the holder for performing X-axis tilting to be the same with respect to the 1-1st protrusion unit PR1a and the 1-2nd protrusion unit PR1b.

In addition, the 2-1st protrusion unit PR2a and the 2-2nd protrusion unit PR2b may be located in an area between the 1-1st protrusion unit PR1a and the 1-2nd protrusion unit PR1b in the first direction. According to an embodiment, the 2-1st protrusion unit PR2a and the 2-2nd protrusion unit PR2b may be located at the center of a separation space between the 1-1st protrusion unit PR1a and the 1-2nd protrusion unit PR1b in the first direction. Through the configuration like this, the actuator according to an embodiment may allow Y-axis tilting to have the same range of angle with respect to the Y-axis. In other words, the tilting guide unit 1141 and the holder may provide a range (e.g., positive/negative range) capable of Y-axis tilting to be the same with respect to the Y-axis with respect to the 2-1st protrusion unit PR2a and the 2-2nd protrusion unit PR2b.

Specifically, the first surface 1141a may include a first outer line M1, a second outer line M2, a third outer line M3, and a fourth outer line M4. The first outer line M1 and the second outer line M2 may face each other, and the third outer line M3 and the fourth outer line M4 may face each other. In addition, the third outer line M3 and the fourth outer line M4 may be located between the first outer line M1 and the second outer line M2. In addition, the first outer line M1 and the second outer line M2 may be perpendicular to the first direction (X-axis direction), but the third outer line M3 and the fourth outer line M4 may be parallel to the first direction (X-axis direction).

At this point, the first protrusion unit PR1 may be located on the first imaginary line VL1. Here, the first imaginary line VL1 is a line that bisects the first outer line M1 and the second outer line M2. Alternatively, the first and third imaginary lines VL1 and VL1′ are lines that bisect the base BS in the second direction (Y-axis direction). Accordingly, the tilting guide unit 1141 may easily perform X-axis tilting through the first protrusion unit PR1. In addition, since the tilting guide unit 1141 performs X-axis tilting on the basis of the first imaginary line VL1, rotational force may be uniformly applied to the tilting guide unit 1141. Accordingly, X-axis tilting can be precisely performed, and reliability of the device can be improved.

In addition, the 1-1st protrusion unit PR1a and the 1-2nd protrusion unit PR1b may be disposed symmetrically with respect to the first imaginary line VL1 and the second imaginary line VL 2. Alternatively, the 1-1st protrusion unit PR1a and the 1-2nd protrusion unit PR1b may be located symmetrically with respect to a first center point. Through the configuration like this, when X-axis tilting is performed, the supporting force supported by the first protrusion unit PR1 may be equally applied to the upper and lower sides with respect to the second imaginary line VL2. Accordingly, reliability of the tilting guide unit can be improved. Here, the second imaginary line VL2 is a line that bisects the third outer line M3 and the fourth outer line M4. Alternatively, the second and fourth imaginary lines VL2 and VL2′ are lines that bisect the base BS in the first direction (X-axis direction).

In addition, the first center point may be the intersection of the first imaginary line VL1 and the second imaginary line VL2. Alternatively, it may be a point corresponding to the center of gravity according to the shape of the tilting guide unit 1141.

In addition, the second surface 1141b may include a fifth outer line M1′, a sixth outer line M2′, a seventh outer line M3′, and an eighth outer line M4′. The fifth outer line M1′ and the sixth outer line M2′ may face each other, and the seventh outer line M3′ and the eighth outer line M4′ may face each other. In addition, the seventh outer line M3′ and the eighth outer line M4′ may be located between the fifth outer line M1′ and the sixth outer line M2′. In addition, the fifth outer line M1′ and the sixth outer line M2′ are perpendicular to the first direction (X-axis direction), but the seventh outer line M3′ and the eighth outer line M4′ may be parallel to the first direction (X-axis direction).

In addition, since the tilting guide unit 1141 performs Y-axis tilting on the basis of the fourth imaginary line VL2′, rotational force may be uniformly applied to the tilting guide unit 1141. Accordingly, Y-axis tilting can be precisely performed, and reliability of the device can be improved.

In addition, the 2-1st protrusion unit PR2a and the 2-2nd protrusion unit PR2b may be disposed symmetrically with respect to the third imaginary line VL1′ on the fourth imaginary line VL2′. Alternatively, the 2-1st protrusion unit PR2a and the 2-2nd protrusion unit PR2b may be located symmetrically with respect to a second center point. Through the configuration like this, when Y-axis tilting is performed, the supporting force supported by the second protrusion unit PR2 may be equally applied to the upper and lower sides of the tilting guide unit with respect to the fourth imaginary line VL2′. Accordingly, reliability of the tilting guide unit can be improved. Here, the third imaginary line VL1′ is a line that bisects the fifth outer line M1′ and the sixth outer line M2′. In addition, the second center point may be the intersection of the third imaginary line VL1′ and the fourth imaginary line VL2′. Alternatively, it may be a point corresponding to the center of gravity according to the shape of the tilting guide unit 1141.

In addition, the distance DR2 between the 1-1st protrusion unit PR1a and the 1-2nd protrusion unit PR1b in the first direction (X-axis direction) may be larger than the length of the second protrusion unit PR2 in the first direction (X-axis direction). Accordingly, when X-axis tilting is performed with respect to the 1-1st protrusion unit PR1a and the 1-2nd protrusion unit PR1b, resistance generated by the second protrusion unit PR2 can be minimized.

Corresponding thereto, the distance ML2 between the 2-1st protrusion unit PR2a and the 2-2nd protrusion unit PR2b in the second direction (Y-axis direction) may be larger than the length of the first protrusion unit PR1 in the second direction (Y-axis direction). Accordingly, when Y-axis tilting is performed with respect to the 2-1st protrusion unit PR2a and the 2-2nd protrusion unit PR2b, resistance generated by the first protrusion unit PR1 can be minimized.

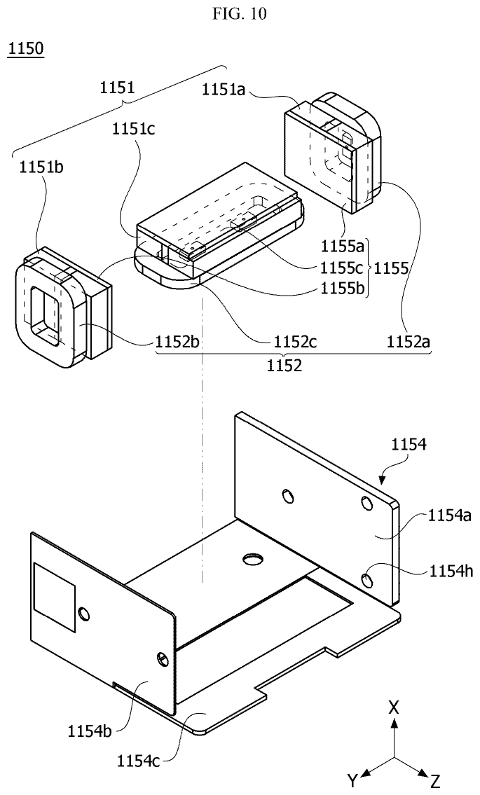

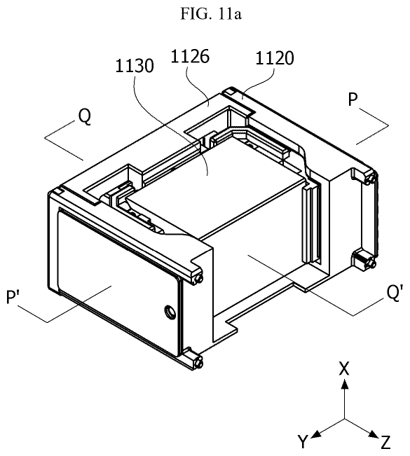

FIG. 10 is a view showing a first driving unit of a first camera actuator according to an embodiment.

Referring to FIG. 10, the first driving unit 1150 includes a driving magnet 1151, a driving coil 1152, a hall sensor unit 1153, a first substrate unit 1154, and a yoke unit 1155.

In addition, as described above, the driving magnet 1151 may include a first magnet 1151a, a second magnet 1151b, and a third magnet 1151c that provide a driving force by electromagnetic force. The first magnet 1151a, the second magnet 1151b, and the third magnet 1151c may be located on the outer side surface of the holder 1131, respectively.

In addition, the driving coil 1152 may include a plurality of coils. As an embodiment, the driving coil 1152 may include a first coil 1152a, a second coil 1152b, and a third coil 1152c.

The first coil 1152a may be located to face the first magnet 1151a. Accordingly, the first coil 1152a may be located in the first housing hole 1121a of the first housing side unit 1121 as described above. In addition, the second coil 1152b may be located to face the second magnet 1151b. Accordingly, the second coil 1152b may be located in the second housing hole 1122a of the second housing side unit 1122 as described above.

The second camera actuator according to an embodiment may provide the best optical characteristics by minimizing occurrence of a decent or tilt phenomenon when OIS is implemented by controlling rotation of the mover 1130 in the first axis (X-axis) direction or the second axis (Y-axis) direction by the electromagnetic force between the driving magnet 1151 and the driving coil 1152.

In addition, according to an embodiment, as the limitation in the size of the actuator can be resolved by implementing OIS through the tilting guide unit 1141 of the rotating unit 1140 disposed between the first housing 1120 and the mover 1130, it is possible to provide an ultra-slim ultra-small camera actuator and a camera module including the same.

The first substrate unit 1154 may include a first substrate side unit 1154a, a second substrate side unit 1154b, and a third substrate side unit 1154c.

The first substrate side unit 1154a and the second substrate side unit 1154b may be disposed to face each other. In addition, the third substrate side unit 1154c may be located between the first substrate side unit 1154a and the second substrate side unit 1154b.

In addition, the first substrate side unit 1154a may be located between the first housing side unit and the shield can, and the second substrate side unit 1154b may be located between the second housing side unit and the shield can. In addition, the third substrate side unit 1154c may be located between the third housing side unit and the shield can, and may be the bottom surface of the first substrate unit 1154.

The first substrate side unit 1154a may be coupled and electrically connected to the first coil 1152a. In addition, the first substrate side unit 1154a may be coupled and electrically connected to the first hall sensor 1153a.

The second substrate side unit 1154b may be coupled and electrically connected to the second coil 1152b. In addition, it should also be understood that the second substrate side unit 1154b may also be coupled and electrically connected to the first hall sensor.

The third substrate side unit 1154c may be coupled and electrically connected to the third coil 1152c. In addition, the third substrate side unit 1154c may be coupled and electrically connected to the second hall sensor 1153b.

The yoke unit 1155 may include a third yoke 1155a, a fourth yoke 1155b, and a fifth yoke 1155c. The third yoke 1155a may be located inside the first mounting groove and coupled to the first magnet 1151a. In addition, the fourth yoke 1155b may be located inside the second mounting groove and coupled to the second magnet 1151b. In addition, the fifth yoke 1155c may be located inside the third mounting groove and coupled to the third magnet 1151c. The third to fifth yokes 1155a to 1155c allow the first to third magnets 1151a to 1151c to be easily mounted in the first to third mounting grooves to be coupled to the housing.

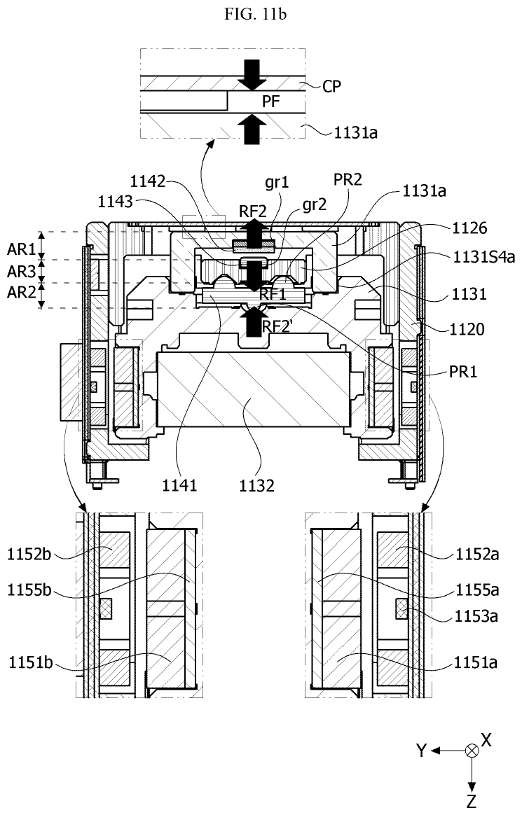

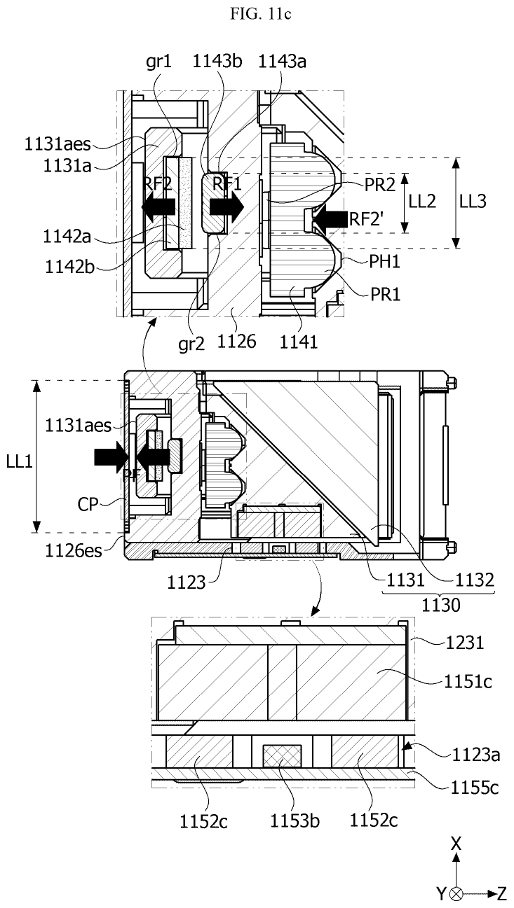

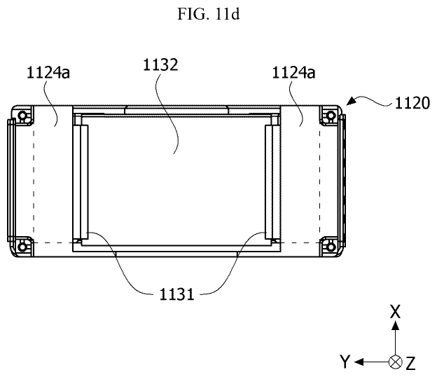

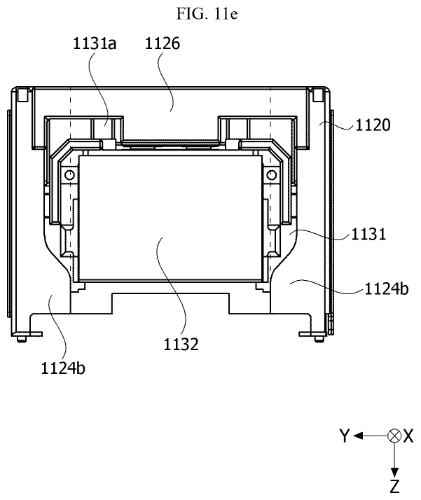

FIG. 11a is a perspective view showing a first camera actuator according to an embodiment, FIG. 11b is a view taken along the line PP′ in FIG. 11a, FIG. 11c is a view taken along the line QQ′ in FIG. 11a, FIG. 11d is a rear view showing a first camera actuator according to an embodiment, and FIG. 11e is a top view showing a first camera actuator according to an embodiment.

Referring to FIGS. 11a to 11c, the first coil 1152a may be located on the first housing side unit 1121, and the first magnet 1151a may be located on the first holder outer side surface 1131S1 of the holder 1131. Accordingly, the first coil 1152a and the first magnet 1151a may be located to face each other. The first magnet 1151a may be at least partially overlapped with the first coil 1152a in the second direction (Y-axis direction).

In addition, the second coil 1152b may be located on the second housing side unit 1122, and the second magnet 1151b may be located on the second holder outer side surface 1131S2 of the holder 1131. Accordingly, the second coil 1152b and the second magnet 1151b may be located to face each other. The second magnet 1151b may be at least partially overlapped with the second coil 1152b in the second direction (Y-axis direction).

In addition, the first coil 1152a and the second coil 1152b may be overlapped in the second direction (Y-axis direction), and the first magnet 1151a and the second magnet 1151b may be overlapped in the second direction (Y-axis direction).

Through the configuration like this, as the electromagnetic force applied to the outer side surface of the holder (the first holder outer side surface and the second holder outer side surface) may be located on the parallel axis in the second direction (Y-axis direction), X-axis tilting may be performed accurately and precisely.

In addition, the second protrusion units PR2a and PR2b of the tilting guide unit 1141 may be in contact with the first member 1126 of the first housing 1120. The second protrusion unit PR2 may be mounted inside the second protrusion groove PH2 formed on one side surface of the first member 1126. In addition, when performing X-axis tilting, the second protrusion units PR2a and PR2b may be the reference axis (or rotation axis) of the tilting. Accordingly, the tilting guide unit 1141 and the mover 1130 may move along the second direction.

In addition, the first hall sensor 1153a may be located outside for electrical connection and coupling to the first substrate unit 1154 as described above. However, it is not limited to this position.

In addition, the third coil 1152c may be located on the third housing side unit 1123, and the third magnet 1151c may be located on the third holder outer side surface 1131S3 of the holder 1131. The third coil 1152c may be at least partially overlapped with the third magnet 1151c in the first direction (X-axis direction). Accordingly, strength of the electromagnetic force between the third coil 1152c and the third magnet 1151c may be controlled easily.

The tilting guide unit 1141 may be located on the fourth holder outer side surface 1131S4 of the holder 1131 as described above. In addition, the tilting guide unit 1141 may be mounted inside the fourth mounting groove 1131S4a of the fourth holder outer side surface. As described above, the fourth mounting groove 1131S4a may include the first region AR1, the second region AR2, and the third region AR3 as described above.

The second member 1131a may be disposed in the first region AR1, and the second member 1131a may include the first groove gr1 formed on the inner side surface. In addition, the second magnetic body 1142 is disposed in the first groove gr1 as described above, and the repulsive force RF2 generated by the second magnetic body 1142 may be transferred RF2′ to the fourth mounting groove 1131S4a of the holder 1131 through the second member 1131a. Accordingly, the holder 1131 may apply force to the tilting guide unit 1141 in the same direction as the repulsive force RF2 generated by the second magnetic body 1142.

The first member 1126 may be disposed in the second region AR2. The first member 1126 may include the second groove gr2 facing the first groove gr1. In addition, the first member 1126 may include the second protrusion groove PH2 disposed on a surface corresponding to the second groove gr2. In addition, the repulsive force RF1 generated by the first magnetic body 1143 may be applied to the first member 1126. Accordingly, the first member 1126 and the second member 1131a may press the tilting guide unit 1141 disposed between the first member 1126 and the holder 1131 through the generated repulsive forces RF1 and RF2′. Accordingly, even after the holder tilts with respect to the X axis or Y axis by the current applied to the first and second coils or the third coil 1152c, coupling between (or positions of) the holder 1131, the first housing 1120, and the tilting guide unit 1141 can be maintained.

The tilting guide unit 1141 may be disposed in the third region AR3. The tilting guide unit 1141 may include the first protrusion unit PR1 and the second protrusion unit PR2 as described above. At this point, the first protrusion unit PR1 and the second protrusion unit PR2 may be disposed on the second surface 1141b and the first surface 1141a of the base BS, respectively. In this way, in another embodiment described below, the first protrusion unit PR1 and the second protrusion unit PR2 may be diversely located on the facing surfaces of the base.

The first protrusion groove PH1 may be located in the fourth mounting groove 1131S4a. In addition, the first protrusion unit PR1 of the tilting guide unit 1141 may be accommodated in the first protrusion groove PH1. Accordingly, the first protrusion unit PR1 may be in contact with the first protrusion groove PH1. The maximum diameter of the first protrusion groove PH1 may correspond to the maximum diameter of the first protrusion unit PR1. This may be equally applied to the second protrusion groove PH2 and the second protrusion unit PR2. Through the configuration like this, the first axis tilting may occur easily with respect to the first protrusion unit PR1, and the second axis tilting may occur easily with respect to the second protrusion unit PR2, and the radius of tilting can be improved.

In addition, as the tilting guide unit 1141 is disposed in parallel with the second member 1131a and the first member 1126 in the third direction (Z-axis direction), the tilting guide unit 1141 may be overlapped with the optical member 1132 in the first direction (X-axis direction). More specifically, in the embodiment, the first protrusion unit PR1 may be overlapped with the optical member 1132 in the first direction (X-axis direction). Furthermore, at least a portion of the first protrusion unit PR1 may be overlapped with the third coil 1152c or the third magnet 1151c in the first direction (X-axis direction). That is, in the camera actuator according to the embodiment, each protrusion unit, which is the central axis of tilting, may be located to be adjacent to the center of gravity of the mover 1130. Therefore, the tilting guide unit may be located to be adjacent to the center of gravity of the holder. Therefore, as the camera actuator according to the embodiment may minimize the moment value that tilts the holder and may also minimize the amount of current applied to the coil unit or the like to tilt the holder, power consumption and reliability of the device can be improved.

In addition, the second magnetic body 1142 and the first magnetic body 1143 may not be overlapped with the third coil 1152c or the optical member 1132 in the first direction (X-axis direction). In other words, in the embodiment, the second magnetic body 1142 and the first magnetic body 1143 may be spaced apart from the third coil 1152c or the optical member 1132 in the third direction (Z-axis direction). Therefore, the magnetic force transferred from the second magnetic body 1142 and the first magnetic body 1143 to the third coil 1152c can be minimized. Accordingly, the camera actuator according to the embodiment may easily perform up and down driving (Y-axis tilt) and minimize power consumption.

Furthermore, as described above, the second hall sensor 1153b located inside the third coil 1153c may detect a change in the magnetic flux, and according thereto, position sensing between the third magnet 1151c and the second hall sensor 1153b may be performed. At this point, the offset voltage of the second hall sensor 1153b may be changed according to the influence of the magnetic field formed by the second magnetic body 1142 and the first magnetic body 1143.

In the first camera actuator according to the embodiment, the second member 1131a, the second magnetic body 1142, the first magnetic body 1143, the first member 1126, the tilting guide unit 1141, and the holder 1131 may be disposed in order from the outermost side surface in the third direction. However, since the second magnetic body is located inside the second member and the first magnetic body is located inside the first member, they may be disposed in order of the second member, the first member, the tilting guide unit, and the holder.

In addition, as an embodiment, the separation distance of the second magnetic body 1142 and the first magnetic body 1143 from the holder 1131 (or the optical member 1132) in the third direction may be larger than the separation distance to the tilting guide unit 1141. Therefore, the second hall sensor 1153b under the holder 1131 may also be disposed to be spaced apart from the second magnetic body 1142 and the first magnetic body 1143 by a predetermined distance. Accordingly, as the influence of the magnetic field formed by the second magnetic body 1142 and the first magnetic body 1143 is minimized, the second hall sensor 1153b may prevent the hall voltage from being positively or negatively concentrated and saturated. That is, this configuration allows the hall electrode to have a range in which hall calibration can be performed. Furthermore, although the temperature is also affected by the electrode of the hall sensor, and the resolution of the camera lens varies according to the temperature, in the embodiment, as the case of concentrating the hall voltage positively or negatively is prevented, and compensation for the resolution of the lens is also performed accordingly, decrease of resolution can be prevented easily.

In addition, a circuit design for compensating for an offset in the output (i.e., hall voltage) of the second hall sensor 1153b may also be achieved easily.

In addition, according to the embodiment, a portion of the tilting guide unit 1141 may be located outside the fourth holder outer side surface compared to the fourth holder outer side surface 1131.

The tilting guide unit 1141 may be mounted inside the fourth mounting groove 1131S4a with respect to the base, excluding the first protrusion unit PR1 and the second protrusion unit PR2. In other words, the length of the base in the third direction (Z-axis direction) may be smaller than the length of the fourth mounting groove 1131S4a in the third direction (Z-axis direction). Through the configuration like this, miniaturization can be achieved easily.

In addition, the maximum length of the tilting guide unit 1141 in the third direction (Z-axis direction) may be longer than the length of the fourth mounting groove 1131S4a in the third direction (Z-axis direction). Accordingly, as described above, the end portion of the second protrusion unit PR2 may be located between the fourth holder outer side surface and the first member 1126. That is, at least a portion of the second protrusion unit PR2 may be located in the opposite direction of the third direction (Z-axis direction) compared to the holder 1131. In other words, the holder 1131 may be spaced apart from the end portion of the second protrusion unit PR2 (the portion in contact with the second protrusion groove) by a predetermined distance in the third direction (Z-axis direction).

In addition, the front surface 1131aes of the second member 1131a according to the embodiment may be spaced apart from the front surface 1126es of the first member 1126. In particular, the front surface 1131aes of the second member 1131a according to the embodiment may be located on the front surface 1126es of the first member 1126 toward the third direction (Z-axis direction). Alternatively, the front side 1131aes of the second member 1131a according to the embodiment may be located inside the front side 1126es of the first member 1126. To this end, the first member 1126 may have a structure extended and bent toward the inside. In addition, a portion of the second member 1131a may be located in a groove formed by the extended and bent structure of the first member 1126 described above.

Through the configuration like this, as the second member 1131a is located inside the first member 1126, space efficiency can be improved, and miniaturization can be implemented. Furthermore, although driving (tilting or rotation of the mover 1130) is performed by electromagnetic force, contact with surrounding elements can be blocked as the second member 1131a does not protrude toward the outside of the first member 1126. Accordingly, reliability can be improved.

In addition, a predetermined separation space may exist between the second magnetic body 1142 and the first magnetic body 1143. In other words, the second magnetic body 1142 and the first magnetic body 1143 may face each other with the same polarity.

Further observing FIGS. 11d and 11e, in the first camera actuator according to the embodiment, the first magnetic body may be located in the first housing 1120, and the second magnetic body may be located in the mover 1130.

As described above, according to the embodiment, the first magnetic body and the second magnetic body are disposed to face each other to generate a repulsive force. The repulsive force is a holding force, and the position between the first housing 1120 and the mover 1130 can be maintained by the repulsive force.

More specifically, the first member 1126 may include the second groove gr2 disposed on the outer side surface. The first magnetic body 1143 may be located in the second groove gr2. In addition, the second groove gr2 may be located on the opposite side (or opposite surface) of the second protrusion groove and the first member 1126.

In addition, the second member 1131a may include the first groove gr1 facing the second groove gr2. The first groove gr1 may be located on the inner side surface of the second member 1131a. In addition, a second magnetic body 1142 may be located in the first groove gr1.

In addition, the first member 1126 may be disposed on one side of the first housing 1120. In addition, the second member 1131a may penetrate the first member 1126 and come into contact with the holder 1131 to be coupled to the holder 1131. Accordingly, the tilting guide unit 1141 may be disposed between the first member 1126 and the mover (or holder 1131).

In addition, the second magnetic body 1142, the first magnetic body 1143, and the tilting guide unit 1141 may be sequentially disposed along the optical axis direction (Z-axis direction). Furthermore, the second magnetic body 1142, the first magnetic body 1143, and the tilting guide unit 1141 may be overlapped along the optical axis direction (Z-axis direction).

Furthermore, the plate CP may be located on the outer side surface of the first member 1126. Accordingly, the plate CP, the second magnetic body 1142, and the first magnetic body 1143 may be disposed sequentially along the optical axis direction.

In addition, the length LL1 of the plate CP in the first direction (X-axis direction) may be longer than the length LL2 of the second magnetic body 1142 in the first direction (X-axis direction). In addition, the length LL2 of the second magnetic body 1142 in the first direction (X-axis direction) may be different from the length LL3 of the first magnetic body 1143 in the first direction (X-axis direction). For example, the length LL2 of the second magnetic body 1142 in the first direction (X-axis direction) may be longer than the length LL3 of the first magnetic body 1143 in the first direction (X-axis direction). In addition, the area XY of the plate CP may be larger than the area (XY plane) of the first member 1126 or the area (XY plane) of the second member 1131a. Furthermore, the plate CP may be a non-magnetic body as described above. Accordingly, the plate CP may suppress inflow of foreign substances into the first member 1126, the second member 1131a, the first magnetic body 1143, and the second magnetic body 1142 disposed inside the first housing 1120.

In addition, the plate CP may be made of a magnetic body. At this point, the plate CP may form a magnetic force together with the second magnetic body 1142. For example, an attractive force may be formed between the plate CP and the second magnetic body 1142. For example, the plate CP may form an attractive force together with the second magnetic body 1142 as a yoke. Accordingly, the attractive force formed between the plate CP and the second magnetic body 1142 may reinforce the repulsive force described above. Accordingly, the holding force between the mover and the housing may be further increased. In addition, reliability of the first camera actuator can be improved by the improved holding force. For example, the surface (or area) 1142a of the second magnetic body 1142 facing the first magnetic body 1143 may have a polarity the same as that of one surface 1143b of the first magnetic body 1143. In addition, the surface 1142b of the second magnetic body 1142 facing the plate CP may have a polarity different from that of the plate CP. At this point, the plate CP may be made of a magnetic body. Furthermore, the other surface 1143a of the second magnetic body 1142 may have a polarity different from that of one surface 1143b. This is described based on the case where the first magnetic body 1143 and the second magnetic body 1142 are magnets.

Through the configuration like this, the repulsive force between the second magnetic body 1142 and the first magnetic body 1143 may be further increased by the plate CP. In other words, an attractive force PF may be generated between the second magnetic body 1142 and the plate CP. Furthermore, the plate CP is made of a magnetic body such as metal, and may block leakage of magnetic flux. For example, the plate CP may prevent leakage flux generated by the first magnetic body 1143 or the second magnetic body 1142. Therefore, the plate CP may improve electrical reliability of the first camera actuator.

In addition, in the housing wall unit 1124, the wall unit 1124a may not be overlapped with the optical member 1132 along the optical axis direction. In addition, in the housing wall unit 1124, the wall unit 1124a may be misaligned with the optical member 1132 along the optical axis direction.

In addition, the housing wall unit 1124 may be overlapped with the holder in the optical axis direction (Z-axis direction). Accordingly, although the mover, i.e., the holder, tilts, the movement may be limited by the housing wall unit 1124 for the sake of hand-shake prevention function. Furthermore, the impact that occurs as the housing wall unit 1124 and the holder collide with each other may not occur in the first member or the second member. Therefore, reliability of the first and second members can be improved.

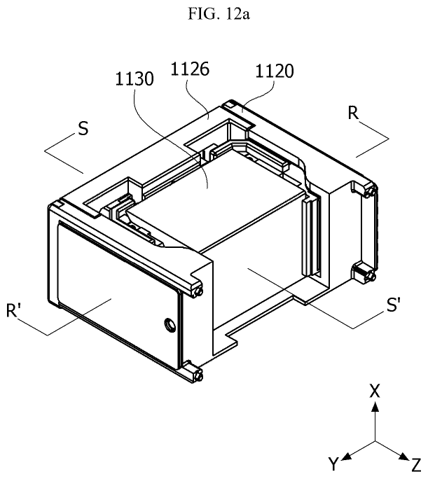

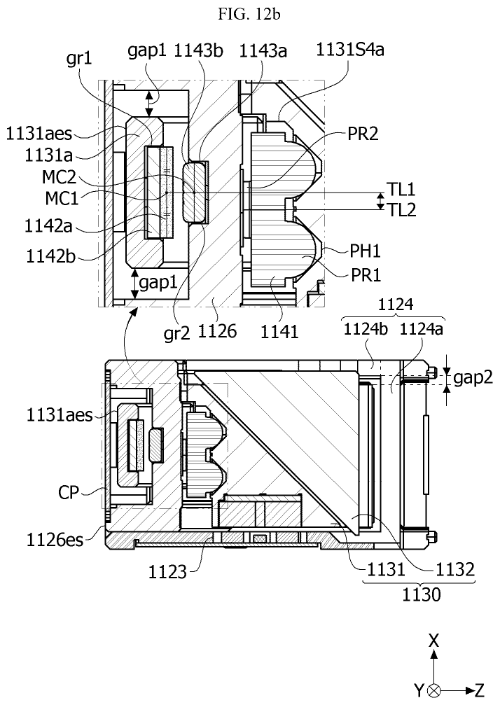

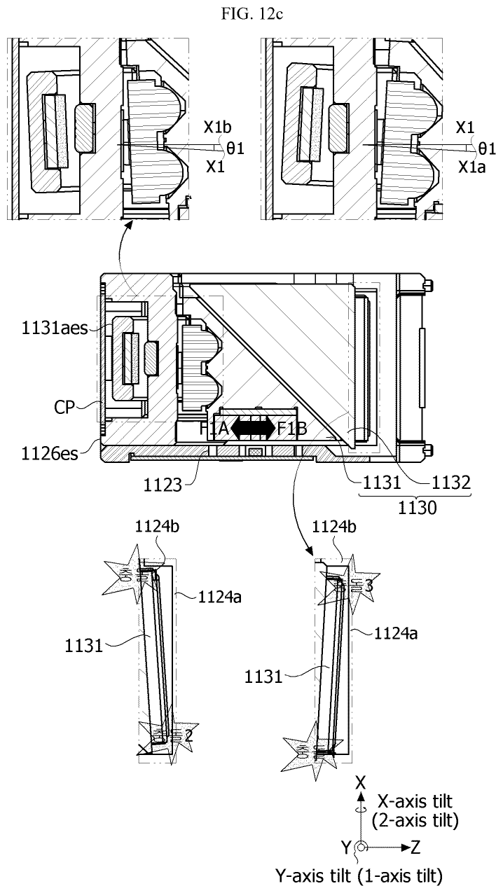

FIG. 12a is a perspective view showing a first camera actuator according to an embodiment, FIG. 12b is a view taken along the line SS′ in FIG. 12a, and FIG. 12c is an exemplary view showing movement of the camera actuator shown in FIG. 12b.

Referring to FIGS. 12a to 12c, Y-axis tilting may be performed in the first camera actuator according to an embodiment. That is, OIS can be implemented by rotating in the first direction (X-axis direction).

As an embodiment, the third magnet 1151c disposed on the bottom of the holder 1131 may form electromagnetic force together with the third coil 1152c and tilt or rotate the mover 1130 in the second direction (Y-axis direction).

Specifically, the repulsive force between the second magnetic body 1142 and the first magnetic body 1143 may be transferred to the second member 1131a and the first member 1126, and finally transferred to the tilting guide unit 1141 disposed between the first member 1126 and the holder 1131. Accordingly, the tilting guide unit 1141 may be pressed by the mover 1130 and the first housing 1120 by the repulsive force described above.

In addition, the second protrusion unit PR2 may be supported by the first member 1126. At this point, as an embodiment, the tilting guide unit 1141 may rotate or tilt using the second protrusion unit PR2 protruding toward the first member 1126 as the reference axis (or rotation axis), i.e., in the second direction (Y-axis direction). In other words, the tilting guide unit 1141 may rotate or tilt in the first direction (X-axis direction) using the second protrusion unit PR2 protruding toward the first member 1126 as the reference axis (or rotation axis).

For example, OIS can be implemented by rotating the mover 1130 in the X-axis direction at a first angle θ1 (X1→X1a) by the first electromagnetic force F1A and F1B between the third magnet 1151c disposed in the third mounting groove and the third coil 1152c disposed on the third substrate side unit.

On the contrary, OIS can be implemented by rotating the mover 1130 in a direction opposite to the X-axis direction at a first angle θ1 (X1→X1b) by the first electromagnetic force F1A and F1B between the third magnet 1151c disposed in the third mounting groove and the third coil 1152c disposed on the third substrate side unit.

The first angle θ1 may be ±1° to ±3°. However, it is not limited thereto.

Hereinafter, in the first camera actuator according to various embodiments, the electromagnetic force may move the mover by generating force in the described direction, or may move the mover in the described direction although the force is generated in a different direction. That is, the direction of the described electromagnetic force means the direction of the force generated by the magnet and the coil to move the mover. For example, the first electromagnetic force F1A and F1B may act in the third direction or in a direction opposite to the third direction.

In addition, the center MC1 of the second magnetic body 1142 and the center MC2 of the first magnetic body 1143 may be disposed in parallel along the third direction (Z-axis direction). In other words, the center line TL1 connecting the center MC1 of the second magnetic body 1142 and the center MC2 of the first magnetic body 1143 may be parallel to the third direction (Z-axis direction).

In addition, the bisector line TL2 that bisects the second protrusion unit PR2 and corresponds to the third direction (Z-axis direction) may be parallel to the center line TL1 (or bisector line). In other words, the bisector line TL2 may be a line that bisects the second protrusion unit PR2 in the first direction (X-axis direction), and may be provided in plurality.

As an embodiment, the bisector line TL2 may be disposed to be spaced apart from the center line TL1 in the first direction (X-axis direction). The bisector line TL2 may be located above the center line TL1. Through the configuration like this, the separation distance to the third coil 1152c or the third magnet 1151c increases, and the holder may tilt more accurately in two axes. Furthermore, the position of the holder may be maintained to be the same even when current is not applied to the coil.

More specifically, since the center MC1 of the second magnetic body 1142 and the center MC2 of the first magnetic body 1143 are spaced apart from the bisector line TL2 in the first direction (X-axis direction), the force (e.g., repulsive force) between the second magnetic body 1142 and the first magnetic body 1143 may act to be apart from the bisector line TL2 corresponding to the optical axis in the first direction (X-axis direction). In addition, a momentum is generated in the mover 1130 by the force. However, when the center MC1 of the second magnetic body 1142 and the center MC2 of the first magnetic body 1143 are located on the bisector line TL2, there is a problem in that positions of the tilting guide unit and the second magnetic body 1142 are not maintained while the calibration is performed after tilting. That is, since the camera actuator according to the embodiment does not allow the center MC1 of the second magnetic body 1142 and the center MC2 of the first magnetic body 1143 to be disposed on the bisector line TL2, the positions of the tilting guide unit and the second magnetic body 1142 can be maintained after tilting or rotation.

As another embodiment, the center MC1 of the second magnetic body 1142 and the center MC2 of the first magnetic body 1143 may be disposed to be spaced apart from each other in the first direction (X-axis direction).

In addition, the center MC1 of the second magnetic body 1142 and the center MC2 of the first magnetic body 1143 may not be located on the bisector line TL2. For example, the center MC1 of the second magnetic body 1142 and the center MC2 of the first magnetic body 1143 may be located above the bisector line TL2.

Therefore, the separation distance to the third coil 1152c or the third magnet 1151c increases, and the holder may tilt more accurately in two axes. Furthermore, the position of the holder may be maintained to be the same even when current is not applied to the coil.

In addition, the length of the second magnetic body 1142 may be different from the length of the first magnetic body 1143 in the first direction (X-axis direction).

As an embodiment, the area of the second magnetic body 1142 combined with the second member 1131a and tilted together with the mover 1130 may be larger than the area of the first magnetic body 1143. For example, the length of the second magnetic body 1142 in the first direction (X-axis direction) may be longer than the length of the first magnetic body 1143 in the first direction (X-axis direction). In addition, the length of the second magnetic body 1142 in the second direction (Y-axis direction) may be longer than the length of the first magnetic body 1143 in the second direction (Y-axis direction). In addition, the first magnetic body 1143 may be located within an imaginary straight line that extends both ends of the second magnetic body 1142 in the third direction.

Through the configuration like this, when tilting or rotation is performed, although a magnetic body on one side (e.g., the second magnetic body) tilts, it is easy to prevent generation of a force, other than a vertical force, by the tilt. That is, although the second magnetic body tilts up and down together with the mover 1130, it may not receive a force (e.g., a repulsive force or an attractive force) opposing the tilt from the first magnetic body 1143. Therefore, driving efficiency can be improved.

In addition, according to the embodiment, the distance gap2 between the housing extension unit 1126b and the holder 1131 may be smaller than the distance gap1 between the first member 1126 and the second member 1131a (the first and second extension units). At this point, the distance gap2 between the housing extension unit 1126b and the holder 1131 may be a length in the first direction (the X-axis direction). In addition, the distance gap1 between the first member 1126 and the second member 1131a (the first and second extension units) may also be a length in the first direction (the X-axis direction).

In addition, when the housing wall unit (wall unit or housing extension unit) is in contact with the holder 1131, the housing (excluding the housing wall unit) may be spaced apart from the holder 1131 by a predetermined distance. In other words, when the holder 1131 tilts, the holder 1131 may primarily collide with the housing wall unit. Accordingly, reliability of the housing 1120 and the holder 1131 can be improved. Specifically, when the housing wall unit (wall unit or housing extension unit) is in contact with the holder 1131, the first member 1126 may be spaced apart from the second member 1131a by a predetermined distance. Therefore, the impact applied to the first member 1126 and the second member 1131a can be eliminated.

As an embodiment, when the holder 1131 tilts, the holder 1131 may collide with the housing wall unit or the housing in a plurality of areas sequentially or simultaneously.

When the holder 1131 tilts, the holder 1131 may primarily collide with the wall unit (collision 2, collision 3) and secondarily collide with the housing extension unit or the third housing side unit (or wall unit) (collision 1, collision 4). Accordingly, the third housing side unit may be in contact with the housing wall unit. In addition, the length of the third housing side unit in the optical axis direction may be longer than the length of the optical member 1132 in the optical axis direction. Through the configuration like this, the impact between the holder and the housing according to the tilt does not occur in the first member and the second member, and the impact absorption efficiency can be improved.

In addition, when the holder 1131 tilts, the holder 1131 may primarily collide with the housing extension unit or the third housing side unit (or wall unit) (collision 1, collision 4) and secondarily collide with the wall unit (collision 2, collision 3). Accordingly, the third housing side unit may be in contact with the housing wall unit. In the same way, the length of the third housing side unit in the optical axis direction may be longer than the length of the optical member 1132 in the optical axis direction. Through the configuration like this, the impact between the holder and the housing according to the tilt does not occur in the first member and the second member, and the impact absorption efficiency can be improved.

In addition, when the holder 1131 tilts, the holder 1131 may collide with the housing extension unit or the third housing side unit (or wall unit) simultaneously in a plurality of areas (collision 1 and collision 2 occur simultaneously, or collision 3 and collision 4 occur simultaneously).

Furthermore, according to the configuration described above, although the mover 1130 rotates (X1→X1a or X1b) along the X-axis at the first angle θ1 by the first electromagnetic force F1A and F1B as described above, collision between the first member 1126 and the second member 1131a may not occur. That is, collision between the holder 1131 and the housing wall unit 1124 may occur preferentially. Therefore, as the collision between the first member 1126 and the second member 1131a is suppressed, reliability of the first member 1126 and the second member 1131a, of which the positions are maintained with respect to each other, for OIS implementation can be improved. Accordingly, reliability of the first camera actuator can be improved.

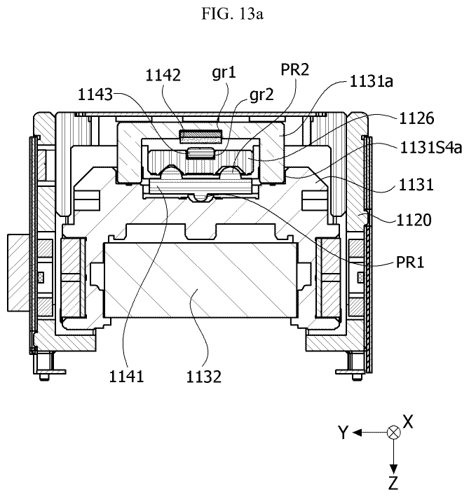

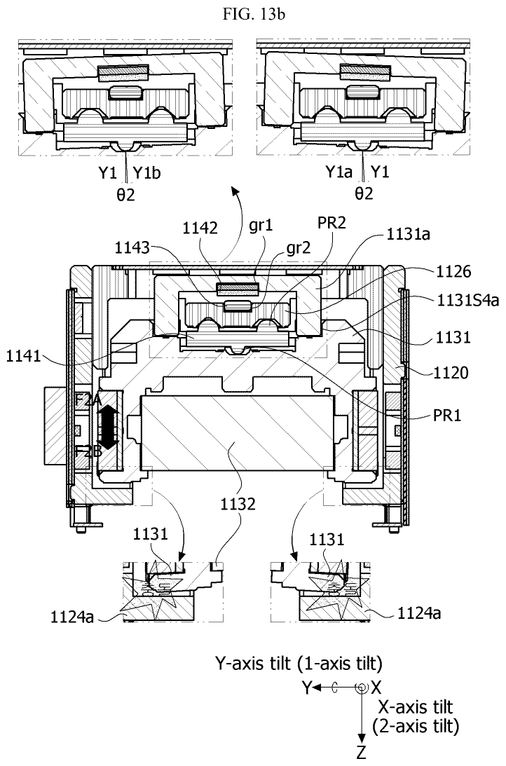

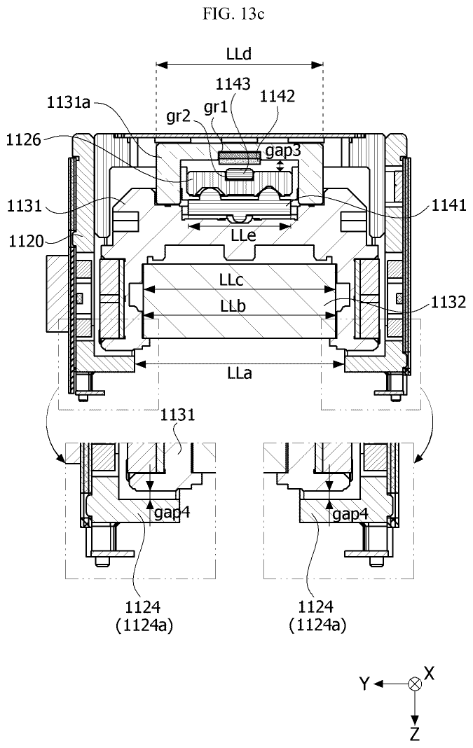

FIG. 13a is a view taken along the line RR′ in FIG. 12a, FIG. 13b is an exemplary view showing movement of the camera actuator shown in FIG. 13a, and FIG. 13c is a view showing collision of a housing wall unit with respect to movement of the first camera actuator shown in FIG. 13a.

Referring to FIGS. 13a and 13b, X-axis tilting may be performed. That is, OIS may be implemented while the mover 1130 tilts or rotates in the Y-axis direction.

As an embodiment, the first magnet 1151a and the second magnet 1151b disposed in the holder 1131 form electromagnetic force together with the first coil 1152a and the second coil 1152b, respectively, to tilt or rotate the tilting guide unit 1141 and the mover 1130 with respect to the first direction (X-axis direction).

Specifically, the repulsive force between the second magnetic body 1142 and the first magnetic body 1143 may be transferred to the first member 1126 and the holder 1131, and ultimately transferred to the tilting guide unit 1141 disposed between the holder 1131 and the first member 1126. Accordingly, the tilting guide unit 1141 may be pressed by the mover 1130 and the first housing 1120 by the repulsive force described above.

In addition, the 1-1st protrusion unit PR1a and the 1-2nd protrusion unit PR1b may be spaced apart in the first direction (X-axis direction) and supported by the first protrusion groove PH1 formed in the fourth mounting groove 1131S4a of the holder 1131. In addition, as an embodiment, the tilting guide unit 1141 may rotate or tilt the first protrusion unit PR1 protruding toward the holder 1131 (e.g., toward the third direction) using the first protrusion unit PR1 as the reference axis (or rotation axis), i.e., with respect to the first direction (X-axis direction).

For example, OIS can be implemented by rotating the mover 1130 in the Y-axis direction at a second angle θ2 (Y1→Y1a) by the second electromagnetic force F2A and F2B between the first and second magnets 1151a and 1151b disposed in the first mounting groove and the first and second coils 1152a and 1152b disposed on the first and second substrate side units. In addition, OIS can be implemented by rotating the mover 1130 in the Y-axis direction at a second angle θ2 (Y1→Y1b) by the second electromagnetic force F2A and F2B between the first and second magnets 1151a and 1151b disposed in the first mounting groove and the first and second coils 1152a and 1152b disposed on the first and second substrate side units. The second angle θ2 may be ±1°to 3°. However, it is not limited thereto.

In addition, as described above, the electromagnetic force generated by the first and second magnets 1151a and 1151b and the first and second coils 1152a and 1152b may act in the third direction or in a direction opposite to the third direction. For example, the electromagnetic force may be generated at the left side of the mover 1130 in the third direction (Z-axis direction) and act at the right side of the mover 1130 in a direction opposite to the third direction (Z-axis direction). Accordingly, the mover 1130 may rotate with respect to the first direction. Or, it may move along the second direction.

In this way, as the second actuator according to the embodiment controls rotation of the mover 1130 in the first direction (X-axis direction) or the second direction (Y-axis direction) by the electromagnetic force between the driving magnet in the holder and the driving coil disposed in the first housing, occurrence of a decent or tilt phenomenon can be minimized, and the best optical characteristics can be provided when OIS is implemented. In addition, as described above, ‘Y-axis tilt’ means rotating or tilting in the first direction (X-axis direction), and ‘X-axis tilt’ means rotating or tilting in the second direction (Y-axis direction).

According to an embodiment, the wall unit 1124a of the housing wall unit 1124 may not be overlapped with the optical member 1132 along the optical axis direction. That is, the wall unit 1124a of the housing wall unit 1124 may be misaligned with the optical member 1132 along the optical axis direction. In addition, the distance LLa between adjacent wall units 1124a in the second direction may be larger than the length LLb of the mounting surface in the second direction in the holder 1131. In addition, the distance LLa between adjacent wall units 1124a in the second direction may be larger than the length LLc of the optical member 1132 in the second direction. Accordingly, as collision between the optical member 1132 and the wall unit 1124a may be prevented, damage to the optical member 1132 can be prevented in advance. Furthermore, light emitted through the optical member 1132 may not be blocked by the wall unit 1124a.

As a modified embodiment, the housing wall unit 1124 may be partially overlapped with the optical member 1132 along the optical axis direction. At this point, the housing wall unit 1124 and the optical member 1132 may not be in contact with each other. In other words, even when the mover tilts, the housing wall unit 1124 and the optical member 1132 may not be in contact with each other. In addition, even when the mover tilts to the maximum, the housing wall unit 1124 and the optical member 1132 may be spaced apart from each other.

In addition, the housing wall unit 1124 or the wall unit 1124a may be overlapped with the first magnet 1151a and the second magnet 1151b along the optical axis direction (Z-axis direction). Accordingly, the impact generated by the first magnet 1151a and the second magnet 1151b with a relatively large weight can be easily absorbed by the wall unit 1124a.

In addition, the distance LLa between the adjacent wall units 1124a in the second direction may be larger than the length LLd of the second member 1131a in the second direction. In addition, the distance LLa between the adjacent wall units 1124a in the second direction may be larger than the length LLe of the tilting guide unit 1141 in the second direction. Accordingly, the housing wall unit 1124 may not be overlapped with the second member 1131a in the optical axis direction (Z-axis direction). The housing wall unit 1124 may be misaligned with the second member 1131a in the optical axis direction (Z-axis direction).

Through the configuration like this, the effective area for the optical member 1132 may be maximized. In addition, miniaturization of the camera actuator can be achieved while the holder 1131 has a small rotation radius for driving of OIS.

As an embodiment, the distance between the first magnetic body 1143 and the second magnetic body 1142 may be larger than the distance between the holder 1131 and the housing wall unit 1124. In addition, even when the holder 1131 tilts, the distance between the first groove and the second groove may be larger than the distance between the holder 1131 and the housing wall unit 1124. Furthermore, even when the holder 1131 tilts and the housing wall unit and the holder 1131 are in contact, the first groove and the second groove may be spaced apart from each other. For example, the distance gap3 between the first magnetic body 1143 and the second magnetic body 1142 may be larger than the distance gap4 between the holder 1131 and the wall unit 1124a. Through the configuration like this, although the holder 1131 moves due to the movement or impact of the holder 1131, collision may primarily occur between the holder 1131 and the housing wall unit 1124. Accordingly, impact to the first member and the second member, which generate a holding force for rotation, can be suppressed. Therefore, reliability of the first member and the second member is improved, and reliability of the first camera actuator may also be improved.

In addition, when the housing wall unit (wall unit or housing extension unit) is in contact with the holder 1131, the housing (excluding the housing wall unit) may be spaced apart from the holder 1131 by a predetermined distance. In other words, when the holder 1131 tilts, the holder 1131 may primarily collide with the housing wall unit. Accordingly, reliability of the housing 1120 and the holder 1131 can be improved. Specifically, when the housing wall unit (wall unit or housing extension unit) is in contact with the holder 1131, the first member 1126 may be spaced apart from the second member 1131a by a predetermined distance. Therefore, the impact applied to the first member 1126 and the second member 1131a can be eliminated.

In addition, the housing wall unit 1124 may not be overlapped with the first magnetic body 1143 or the second magnetic body 1142 along the optical axis direction.

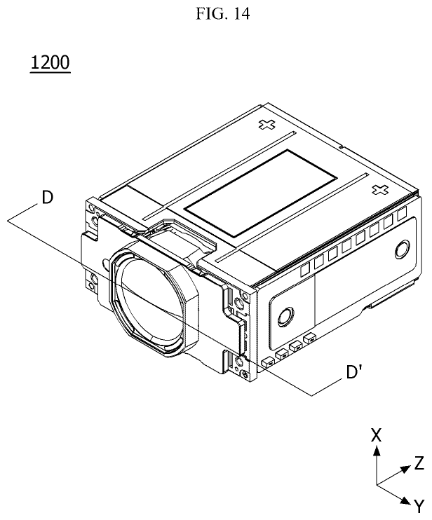

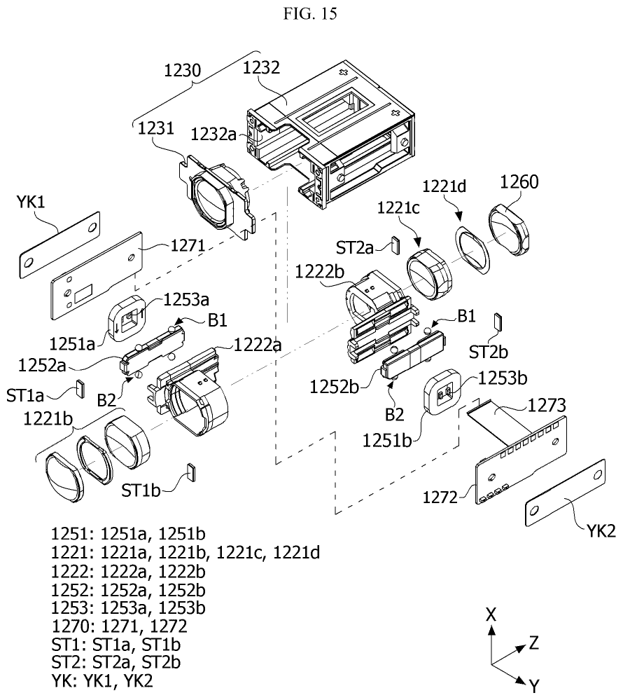

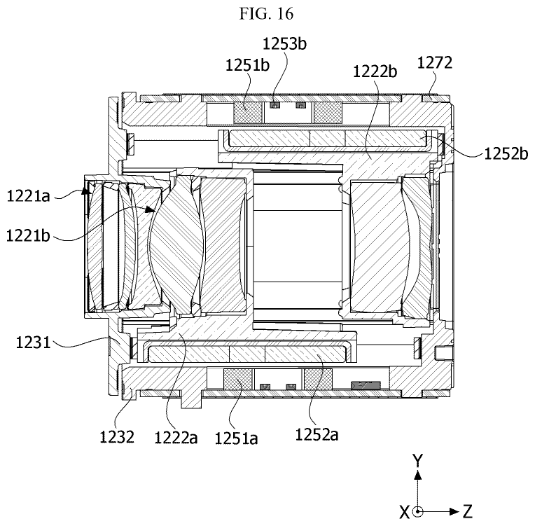

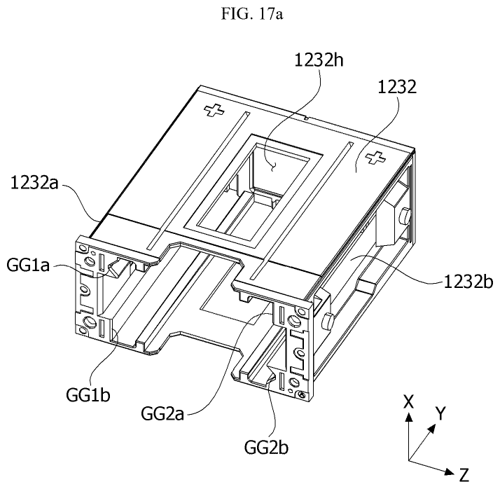

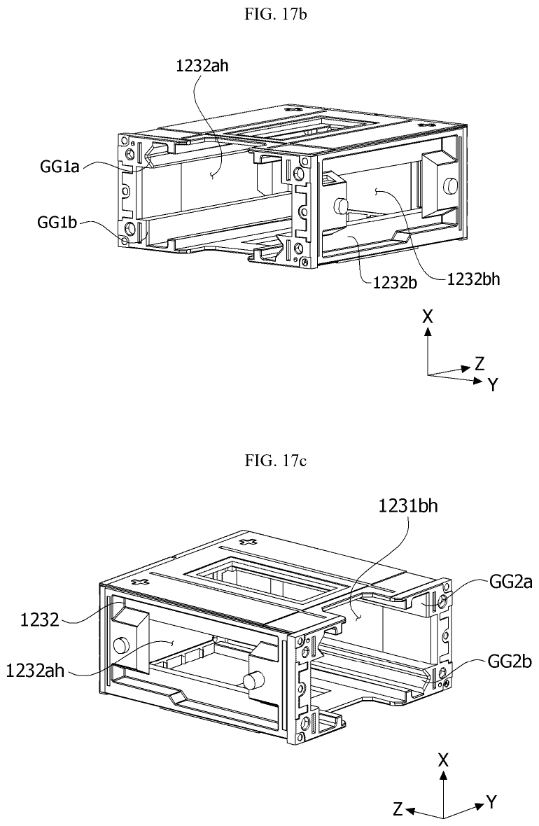

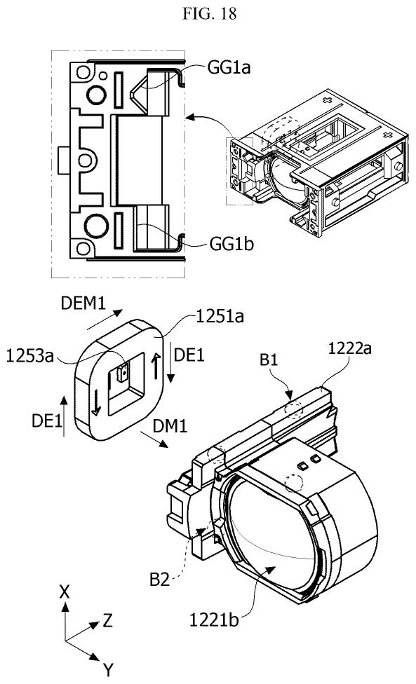

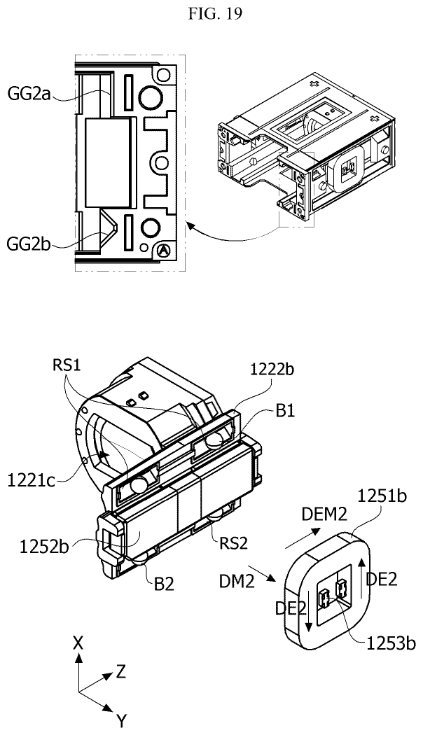

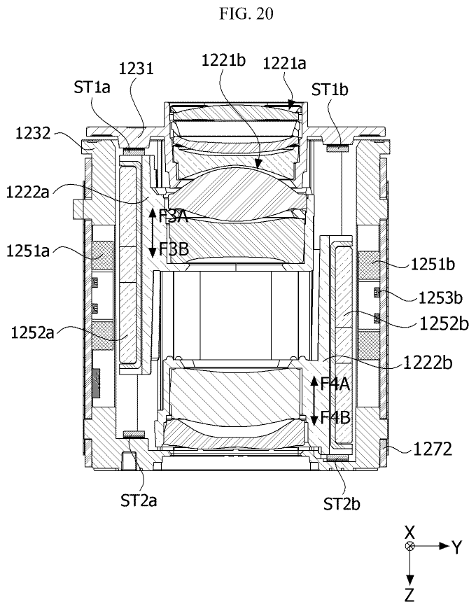

FIG. 14 is a perspective view showing a second camera actuator according to an embodiment, FIG. 15 is an exploded perspective view showing a second camera actuator according to an embodiment, FIG. 16 is a view taken along the line DD′ in FIG. 14, FIGS. 17a, 17b, and 17c are perspective views showing a second housing in a second camera actuator according to an embodiment, FIGS. 18 and 19 are views each explaining the operation of a lens assembly according to an embodiment, and FIG. 20 is a view explaining the operation of a second camera actuator according to an embodiment.

Referring to FIGS. 14 to 16, the second camera actuator 1200 according to an embodiment may include a lens unit 1220, a second housing 1230, a second driving unit 1250, a base unit 1260, a second substrate unit 1270, a bonding member 1280, a stopper unit ST, and a yoke unit YK. Furthermore, the second camera actuator 1200 may further include a second shield can (not shown), an elastic unit (not shown), and a bonding member (not shown).

The second shield can (not shown) may be located in an area (e.g., the outermost side) of the second camera actuator 1200 to surround the components described below (the lens unit 1220, the second housing 1230, the second driving unit 1250, the base unit 1260, the second substrate unit 1270, and the image sensor IS).

The second shield can (not shown) may block or reduce electromagnetic waves generated from the outside. Accordingly, occurrence of malfunction in the second driving unit 1250 can be reduced.

The lens unit 1220 may be located inside the second shield can (not shown). The lens unit 1220 may move along the third direction (Z-axis direction or optical axis direction). Accordingly, the AF function and zooming function described above may be performed.

In addition, the lens unit 1220 may be located inside the second housing 1230. Accordingly, at least a portion of the lens unit 1220 may move inside the second housing 1230 along the optical axis direction or the third direction (Z-axis direction).

Specifically, the lens unit 1220 may include a lens group 1221 and a moving assembly 1222.

First, the lens group 1221 may include one or more lenses. In addition, although the lens group 1221 be provided in plurality, it will be described below assuming that the lens group 1221 includes one lens.

The lens group 1221 is coupled to the moving assembly 1222 and may move in the third direction (Z-axis direction) by the electromagnetic force generated by the fourth magnet 1252a and the fifth magnet 1252b coupled to the moving assembly 1222.

As an embodiment, the lens group 1221 may include a first lens group 1221a, a second lens group 1221b, and a third lens group 1221c. The first lens group 1221a, the second lens group 1221b, and the third lens group 1221c may be disposed sequentially along the optical axis direction. Furthermore, the lens group 1221 may further include a fourth lens group 1221d. The fourth lens group 1221d may be disposed at the rear end of the third lens group 1221c.

The first lens group 1221a may be coupled and fixed to the 2-1st housing. In other words, the first lens group 1221a may not move along the optical axis direction.

The second lens group 1221b may be coupled to the first lens assembly 1222a and move in the third direction or the optical axis direction. Magnification adjustment may be performed by the movement of the first lens assembly 1222a and the second lens group 1221b.

The third lens group 1221c may be coupled to the second lens assembly 1222b and move in the third direction or the optical axis direction. Focus adjustment or auto-focusing may be performed by the movement of the third lens group 1221c.

However, it is not limited to the number of lens groups, and the fourth lens group 1221d described above may be omitted, or additional lens groups other than the fourth lens group 1121d may be further disposed.

The moving assembly 1222 may include an opening area surrounding the lens group 1221. The moving assembly 1222 is interchangeable with the lens assembly. In addition, the moving assembly 1222 may be coupled to the lens group 1221 in various ways. In addition, the moving assembly 1222 may include grooves on the side surfaces, and may be coupled to the fourth magnet 1252a and the fifth magnet 1252b through the grooves. Coupling members or the like may be applied to the grooves.

In addition, the moving assembly 1222 may be coupled to elastic units (not shown) at the top and rear ends. Accordingly, the moving assembly 1222 may be supported by the elastic units (not shown) while moving in the third direction (Z-axis direction). That is, the position of the moving assembly 1222 may be maintained in the third direction (Z-axis direction). The elastic units (not shown) may be formed of various elastic elements such as a plate spring or the like.

The moving assembly 1222 may be located inside the second housing 1230 and include a first lens assembly 1222a and a second lens assembly 1222b.

The area where the third lens group is mounted in the second lens assembly 1222b may be located at the rear end of the first lens assembly 1222a. In other words, the area where the third lens group 1221c is mounted in the second lens assembly 1222b may be located between the area where the second lens group 1221b is mounted in the first lens assembly 1222a and the image sensor.

The first lens assembly 1222a and the second lens assembly 1222b may be mounted inside the 2-2nd housing. For example, a recess in which a ball is disposed in the first lens assembly 1222a may be located to face the first side unit. In addition, a recess in which a ball is disposed in the second lens assembly 1222b may be located to face the second side unit. This will be described below in detail.

In addition, second driving magnets may be mounted on the outer side surfaces of the first lens assembly 1222a and the second lens assembly 1222b. For example, the fifth magnet 1252b may be mounted on the outer side surface of the second lens assembly 1222b. The fourth magnet 1252a may be mounted on the outer side surface of the first lens assembly 1222a.

The second housing 1230 may be disposed between the lens unit 1220 and the second shield can (not shown). In addition, the second housing 1230 may be disposed to surround the lens unit 1220.

The second housing 1230 may include a 2-1st housing 1231 and a 2-2nd housing 1232. The 2-1st housing 1231 may be coupled to the first lens group 1221a and may also be coupled to the first camera actuator described above. The 2-1st housing 1231 may be located in front of the 2-2nd housing 1232.

In addition, the 2-2nd housing 1232 may be located at the rear end of the 2-1st housing 1231. The lens unit 1220 may be mounted inside the 2-2nd housing 1232.

The second housing 1230 (or the 2-2nd housing 1232) may have a hole formed in each side unit. The fourth coil 1251a and the fifth coil 1251b may be disposed in the holes. The holes may be located to correspond to the grooves of the moving assembly 1222 described above.

As an embodiment, the second housing 1230 (in particular, the 2-2nd housing 1232) may include a first side unit 1232a and a second side unit 1232b. The first side unit 1232a and the second side unit 1232b may be located to correspond to each other. For example, the first side unit 1232a and the second side unit 1232b may be disposed symmetrically with respect to the third direction. Second driving coils 1251 may be located on the first side unit 1232a and the second side unit 1232b. In addition, second substrate units 1270 may be mounted on the outer side surfaces of the first side unit 1232a and the second side unit 1232b. In other words, a first substrate 1271 may be located on the outer side surface of the first side unit 1232a, and a second substrate 1272 may be located on the outer side surface of the second side unit 1232b.

In addition, as another example, first and second guide grooves facing the recesses (mounting grooves in which the first and second balls are mounted) of the first lens assembly 1222a may be located on the first side unit. In addition, the first and second guide grooves facing the recesses of the second lens assembly 1222b may be located on the second side unit. At this point, it may be a structure in which a separate member (e.g., a guide unit) including the first and second guide grooves is coupled to the 2-2nd housing 1232. However, in the present embodiment, it will be described based on an integrated structure in which the first and second guide grooves are formed in the 2-2nd housing 1232. Furthermore, as shown in other examples, the first guide unit and the second guide unit may be located to correspond to each other. For example, the first guide unit and the second guide unit may be located to face each other with respect to the third direction (Z-axis direction). In addition, the first guide unit and the second guide unit may be at least partially overlapped with each other in the second direction (Y-axis direction).

The first guide unit and the second guide unit may include at least one groove (e.g., guide groove) or recess. In addition, a first ball B1 or a second ball B2 may be mounted in the groove or recess. Accordingly, the first ball B1 or the second ball B2 may move in the third direction (Z-axis direction) inside the guide groove of the first guide unit or the guide groove of the second guide unit.

Alternatively, the first ball B1 or the second ball B2 may move in the third direction along a rail formed inside the first side unit 1232a of the second housing 1230 or a rail formed inside the second side unit 1232b of the second housing 1230.

Therefore, the first lens assembly 1222a and the second lens assembly 1222b may move in the third direction.

According to an embodiment, the first ball B1 may be disposed on the top of the first lens assembly 1222a or the second lens assembly 1222b. In addition, the second ball B2 may be disposed on the bottom of the first lens assembly 1222a or the second lens assembly 1222b. For example, the first ball B1 may be located above the second ball B2. Therefore, according to the position, the first ball B1 may be at least partially overlapped with the second ball B2 along the first direction (X-axis direction).

In addition, the 2-2nd housing 1232 may include first guide grooves GG1a and GG2a facing a first recess RS1. In addition, the 2-2nd housing 1232 may include second guide grooves GG1b and GG2b facing a second recess RS2. The first guide grooves GG1a and GG2a and the second guide grooves GG1b and GG2b may be grooves extended in the third direction (Z-axis direction). In addition, the first guide grooves GG1a and GG2a and the second guide grooves GG1b and GG2b may be grooves of different shapes. For example, the first guide grooves GG1a and GG2a may be grooves with an inclined side, and the second guide grooves GG1b and GG2b may be grooves with a side perpendicular to the bottom surface.

The fourth magnet and the fourth coil may be located on the first side unit. The fifth magnet and the fifth coil may be located on the second side unit. In addition, the fifth magnet 1252b may be located to face the fifth coil 1251b. In addition, the fourth magnet 1252a may be located to face the fourth coil 1251a.

The elastic unit (not shown) may include a first elastic member (not shown) and a second elastic member (not shown). The first elastic member (not shown) may be coupled to the top surface of the moving assembly 1222. The second elastic member (not shown) may be coupled to the bottom surface of the moving assembly 1222. In addition, the first elastic member (not shown) and the second elastic member (not shown) may be formed as a plate spring as described above. In addition, the first elastic member (not shown) and the second elastic member (not shown) may provide elasticity for moving the moving assembly 1222. However, it is not limited to the locations described above, and the elastic unit may be disposed at various positions.

In addition, the second driving unit 1250 may provide a driving force for moving the lens unit 1220 in the third direction (Z-axis direction). This second driving unit 1250 may include a second driving coil 1251 and a second driving magnet 1252. Furthermore, the second driving unit 1250 may further include a second hall sensor unit. The second hall sensor unit 1253 includes at least one fourth hall sensor 1253a and may be located inside or outside the second driving coil 1251.

The moving assembly may move in the third direction (Z-axis direction) by the electromagnetic force formed between the second driving coil 1251 and the second driving magnet 1252.

The second driving coil 1251 may include a fourth coil 1251a and a fifth coil 1251b. The fourth coil 1251a and the fifth coil 1251b may be disposed in the holes formed on the side unit of the second housing 1230. In addition, the fourth coil 1251a and the fifth coil 1251b may be electrically connected to the second substrate unit 1270. Accordingly, the fourth coil 1251a and the fifth coil 1251b may be supplied with current or the like through the second substrate unit 1270.

The second driving magnet 1252 may include the fourth magnet 1252a and the fifth magnet 1252b. The fourth magnet 1252a and the fifth magnet 1252b may be disposed in the grooves of the moving assembly 1222 described above and may be located to correspond to the fourth coil 1251a and the fifth coil 1251b.

The base unit 1260 may be located between the lens unit 1220 and the image sensor IS. Components such as a filter or the like may be fixed in the base unit 1260. In addition, the base unit 1260 may be disposed to surround the image sensor described above. As the image sensor is free from foreign substances or the like through the configuration like this, reliability of the device can be improved. However, in some drawings shown below, it will be described by omitting the base unit. However, it may not be limited to this structure.

In addition, the second camera actuator 1200 may be a zoom actuator and an Auto Focusing (AF) actuator. For example, the second camera actuator may support one or a plurality of lenses and perform at least one function among an auto-focusing function and a zooming function by moving the lenses according to a control signal of a predetermined control unit.

In addition, the second camera actuator may be a fixed zoom or a continuous zoom. For example, the second camera actuator may provide movement of the lens group 1221.

In addition, the second camera actuator may be configured of a plurality of lens assemblies. For example, the second camera actuator may be disposed to include one or more among a third lens assembly (not shown) and a guide pin (not shown), in addition to the first lens assembly 1222a and the second lens assembly 1222b. The descriptions provided above may be applied to these. Accordingly, the second camera actuator may perform a high-magnification zooming function through the second driving unit. For example, the first lens assembly 1222a and the second lens assembly 1222b may be moving lenses that move through the second driving unit and a guide pin (not shown), and the third lens assembly (not shown) may be a fixed lens, but it is not limited thereto. For example, the third lens assembly (not shown) may perform the function of a focator that forms an image at a specific point, and the first lens assembly may perform the function of a variator that forms again the image formed by the third lens assembly (not shown), which is a focator, at another point. Meanwhile, in the first lens assembly, the change in the magnification may be large as the distance to the subject or the image distance has changed significantly, and the first lens assembly, which is a variator, may play an important role for changing the focal length or the magnification of the optical system. Meanwhile, the image point where an image is formed in the first lens assembly, which is a variator, may change slightly according to the position. Accordingly, the second lens assembly may perform a position compensation function for the image formed by the variator. For example, the second lens assembly may act as a compensator that accurately forms the image point where the image is formed in the second lens assembly 1222b, which is a variator, at an actual image sensor position. However, the configuration of the present embodiment will be described based on the drawings described below.

The image sensor may be located inside or outside the second camera actuator. As an embodiment, as illustrated, the image sensor may be located outside the second camera actuator. For example, the image sensor may be located on the circuit board. The image sensor may receive light and convert the received light into an electrical signal. In addition, the image sensor may be formed of a plurality of pixels in the form of an array. In addition, the image sensor may be located on the optical axis.

The second substrate unit 1270 may be in contact with the side unit of the second housing. For example, the second substrate unit 1270 may be located on the outer side surface (first side surface) of the first side unit and the outer side surface (second side surface) of the second side unit of the second housing, particularly, the 2-2nd housing, and may be in contact with the first side surface and the second side surface.

The stopper unit ST includes a first stopper ST1 disposed at one end and a second stopper ST2 disposed at the other end in the 2-2nd housing 1232. The first stopper ST1 and the second stopper ST2 may be disposed sequentially along the optical axis direction.

Furthermore, a plurality of first stoppers ST1 may be disposed on the moving path of the first lens assembly and the moving path of the second lens assembly, respectively. For convenience, they will be described as a 1-1st stopper ST1a and a 1-2nd stopper ST1b. In the same way, a plurality of second stoppers ST2 may be disposed on the moving path of the first lens assembly and the moving path of the second lens assembly, respectively. In addition, they will be described as a 2-1st stopper ST2a and a 2-2nd stopper ST2b.

The 1-1st stopper ST1a and the 2-1st stopper ST2a may be located on the moving path of the first lens assembly. The 1-2nd stopper ST1b and the 2-2nd stopper ST2b may be located on the moving path of the second lens assembly.

The 1-1st stopper ST1a and the 1-2nd stopper ST1b may be overlapped in the second direction. Alternatively, the 1-1st stopper ST1a and the 1-2nd stopper ST1b may be misaligned in the second direction.

In addition, the 2-1st stopper ST2a and the 2-2nd stopper ST2b may be misaligned in the second direction. The distance between the 1-1st stopper ST1a and the 2-1st stopper ST2a in the third direction may be smaller than the distance between the 1-2nd stopper ST1b and the 2-2nd stopper ST2b. This is a configuration reflecting the point that the movable distance (stroke) of the first lens assembly is smaller than the movable distance (stroke) of the second lens assembly.

As an embodiment, the second yoke unit or the yoke unit YK may be disposed outside the second driving unit. For example, the yoke unit YK may be disposed outside the fourth and fifth coils. The second yoke unit YK may include a first yoke YK1 and a second yoke YK2.

The first yoke YK1 and the second yoke YK2 may be disposed to face each other. For example, the first yoke YK1 and the second yoke YK2 may be located to correspond to each other with respect to the optical axis.

The first yoke YK1 may be located to be adjacent to the fourth coil 1251a. The second yoke YK2 may be located to be adjacent to the fifth coil 1251b. The fourth coil 1251a and the fifth coil 1251b may be located inside the first yoke YK1 and the second yoke YK2. In addition, the first yoke YK1, the fourth coil 1251a, the fifth coil 1251b, and the second yoke YK2 may be disposed sequentially in one direction (e.g., the second direction). The first yoke YK1 may form an attractive force together with the fourth magnet. In addition, the second yoke YK2 may form an attractive force together with the fifth magnet. Accordingly, posture maintenance of the first and second lens assemblies may be performed.

Furthermore, thickness of the first yoke YK1 and the second yoke YK2 may vary in some areas. Through the configuration like this, the magnetic force generated by the fourth and fifth magnets or the fourth and fifth coils may be suppressed not to affect other magnets and coils. For example, the first yoke YK1 may suppress the magnetic force generated by the fourth magnet not to be applied to the fifth magnet and the fifth coil.

Referring to FIGS. 17a, 17b, and 17c, as described above, the second housing 1230 (in particular, the 2-2nd housing 1232) may include a first side unit 1232a and a second side unit 1232b. The first side unit 1232a and the second side unit 1232b may be located to correspond to each other. For example, the first side unit 1232a and the second side unit 1232b may be disposed symmetrically with respect to the third direction. The second driving coils may be located on the first side unit 1232a and the second side unit 1232b. In addition, the second substrate unit may be mounted on the outer side surfaces of the first side unit 1232a and the second side unit 1232b. The second substrate unit may be located outside the driving coil and electrically connected to the driving coil.

For example, the first substrate may be located on the outer side surface of the first side unit 1232a, and the second substrate may be located on the outer side surface of the second side unit 1232b.

Furthermore, first guide grooves GG1a and GG1b, on which the first ball and the second ball are mounted, may be located on the inner side surface of the first side unit 1232a. The first guide grooves GG1a and GG1b may face the first recess and the second recess described above. In the same way, second guide grooves GG2a and GG2b, on which the first ball and the second ball are mounted, may be located on the inner side surface of the second side unit 1232b. The first guide grooves GG1a and GG1b may face the first recess and the second recess described above.

Furthermore, the first side unit 1232a may include a first side unit hole 1232ah. The fourth magnet may be located in the first side unit hole 1232ah. Furthermore, the length of the first side unit hole 1232ah may be shorter than the length of the fourth coil in the first direction.

In addition, the second side unit 1232b may include a second side unit hole 1232bh. The fifth magnet may be located in the second side unit hole 1232bh. Furthermore, the length of the second side unit hole 1232bh may be shorter than the length of the fifth coil in the first direction.

Furthermore, the 2-2nd housing 1232 may include a housing hole 1232h disposed at either the top or the bottom. Through the housing hole 1232h, coupling may be easily performed or inspection (e.g., vision inspection) on the first lens assembly and the second lens assembly may be performed.

In addition, the first guide grooves GG1a and GG1b located on the first side unit 1232a may be extended in the third direction. Furthermore, the first guide grooves GG1a and GG1b may have shapes different from each other. For example, any one GG1a of the first guide grooves may be an inclined groove, and the other one GG1b may be a flat structure. This may be equally applied to the second guide grooves GG2a and GG2b. As the first and second balls may be mounted in the inclined groove and the flat structure, the first lens assembly or the second lens assembly may move along the optical axis direction.

Referring to FIGS. 18 and 19, in a camera device according to an embodiment, as the electromagnetic force DEM1 is generated between the fourth magnet 1252a and the fourth coil 1251a, the first lens assembly 1222a may move along the rail located on the inner side surface of the housing through the first ball B1 and the second ball B2 in a direction parallel to the optical axis, i.e., in the third direction (Z-axis direction), or in a direction opposite to the third direction.

Specifically, in the camera device according to the embodiment, the fourth magnet 1252a may be provided in the first lens assembly 1222a, for example, in a vertical magnetization method. For example, in the embodiment, both the N pole and the S pole of the fourth magnet 1252a may be located to face the fourth coil 1251a. Accordingly, the N pole and the S pole of the fourth magnet 1252a may be respectively disposed to correspond to a region, in which current flows in the X-axis direction or in a direction opposite thereto, in the fourth coil 1251a.

In the embodiment, when a magnetic force is applied from the N pole of the fourth magnet 1252a in a direction opposite to the second direction (Y-axis direction), and a current DE1 flows in the fourth coil 1251a corresponding to the N pole in a direction opposite to the first direction (X-axis direction), electromagnetic force DEM1 may act in the third direction (Z-axis direction) according to the interaction of the electromagnetic force (e.g., Fleming's left-hand rule).

In addition, in the embodiment, when a magnetic force is applied from the S pole of the fourth magnet 1252a in the second direction (Y-axis direction), and a current DE1 flows in the fourth coil 1251a corresponding to the S pole in the first direction (X-axis direction), electromagnetic force DEM1 may act in the Z-axis direction according to the interaction of the electromagnetic force.

At this point, since the fourth coil 1251a is fixed to the side unit of the second housing, the first lens assembly 1222a, in which the fourth magnet 1252a is disposed, may move in a direction opposite to the Z-axis direction by the electromagnetic force DEM1 along the current direction. That is, the second driving magnet may move in the opposite direction of the electromagnetic force applied to the second driving coil. In addition, the direction of the electromagnetic force may be changed according to the current of the coil and the magnetic force of the magnet.

Accordingly, the first lens assembly 1222a may move along the rail located on the inner side surface of the housing through the first ball B1 and the second ball B2 in the third direction or in a direction parallel to the optical axis direction (in both directions). At this point, the electromagnetic force DEM1 may be controlled in proportion to the current DE1 applied to the fourth coil 1251a.

The first lens assembly 1222a or the second lens assembly 1222b may include a first recess RS1 in which the first ball B1 is mounted. In addition, the first lens assembly 1222a or the second lens assembly 1222b may include a second recess RS2 in which the second ball B2 is mounted. The length of the first recess RS1 may be set in advance in the optical axis direction (Z-axis direction). In addition, the length of the second recess RS2 may be set in advance in the optical axis direction (Z-axis direction). Accordingly, the moving distances of the first ball B1 and the second ball B2 may be adjusted in the optical axis direction inside each recess. In other words, the first recess RS1 or the second recess RS2 may be stoppers of the first and second balls B1 an B2.

In addition, in the camera device according to the embodiment, the fifth magnet 1252b may be provided in the second lens assembly 1222b, for example, in a vertical magnetization method. For example, in the embodiment, both the N pole and the S pole of the fifth magnet 1252b may be located to face the fifth coil 1251b. Accordingly, the N pole and the S pole of the fifth magnet 1252b may be respectively disposed to correspond to a region, in which current flows in the X-axis direction or a direction opposite thereto, in the fifth coil 1251b.

In the embodiment, when a magnetic force DM2 is applied from the N pole of the fifth magnet 1252b in the second direction (Y-axis direction), and a current DE2 flows in the fifth coil 1251b corresponding to the N pole in the first direction (X-axis direction), electromagnetic force DEM2 may act in the third direction (Z-axis direction) according to the interaction of the electromagnetic force (e.g., Fleming's left-hand rule).

In addition, in the embodiment, when a magnetic force is applied from the S pole of the fifth magnet 1252b in a direction opposite to the second direction (Y-axis direction) and a current DE2 flows in the fifth coil 1251b corresponding to the S pole in a direction opposite to the first direction (X-axis direction), electromagnetic force DEM2 may act in the Z-axis direction according to the interaction of the electromagnetic force.

At this point, since the fifth coil 1251b is fixed to the side unit of the second housing, the second lens assembly 1222b, in which the fifth magnet 1252b is disposed, may move in a direction opposite to the Z-axis direction by the electromagnetic force DEM2 along the current direction. For example, as described above, the direction of the electromagnetic force may be changed according to the current of the coil and the magnetic force of the magnet. Accordingly, the second lens assembly 1222b may move along the rail located on the inner side surface of the second housing through the second ball B2 in a direction parallel to the third direction (Z-axis direction). At this point, the electromagnetic force DEM2 may be controlled in proportion to the current DE2 applied to the fifth coil 1251b.

Referring to FIG. 20, in the camera device according to the embodiment, the second driving unit may provide driving forces F3A, F3B, F4A, and F4B that move the first lens assembly 1222a and the second lens assembly 1222b of the lens unit 1220 along the third direction (Z-axis direction). As described above, the second driving unit may include the second driving coil 1251 and the second driving magnet 1252. In addition, the lens unit 1220 may move along the third direction (Z-axis direction) by the electromagnetic force formed between the second driving coil 1251 and the second driving magnet 1252.

At this point, the fourth coil 1251a and the fifth coil 1251b may be disposed in the holes formed in the side units (e.g., the first side unit and the second side unit) of the second housing 1230. In addition, the fifth coil 1251b may be electrically connected to the first substrate 1271. The fourth coil 1251a may be electrically connected to the second substrate 1272. Accordingly, the fourth coil 1251a and the fifth coil 1251b may receive a driving signal (e.g., current) from a driving driver on the circuit board of the circuit board 1300 through the second substrate unit 1270.

At this point, the first lens assembly 1222a, on which the fourth magnet 1252a is mounted, may move along the third direction (Z-axis direction) by the electromagnetic force F3A and F3B between the fourth coil 1251a and the fourth magnet 1252a. In addition, the second lens group 1221b mounted on the first lens assembly 1222a may also move along the third direction.

In addition, the second lens assembly 1222b, on which the fifth magnet 1252b is mounted, may move along the third direction (Z-axis direction) by the electromagnetic force F4A and F4B between the fifth coil 1251b and the fifth magnet 1252b. In addition, the third lens group 1221c mounted on the second lens assembly 1222b may also move along the third direction.

Accordingly, as described above, the focal length or magnification of the optical system may be changed by the movement of the second lens group 1221b and the third lens group 1221c. As an embodiment, the magnification may be changed by the movement of the second lens group 1221b. In other words, zooming may be performed. In addition, the focus may be adjusted by the movement of the third lens group 1221c. In other words, auto-focusing may be performed. According to the configuration like this, the second camera actuator may be a fixed zoom or a continuous zoom.

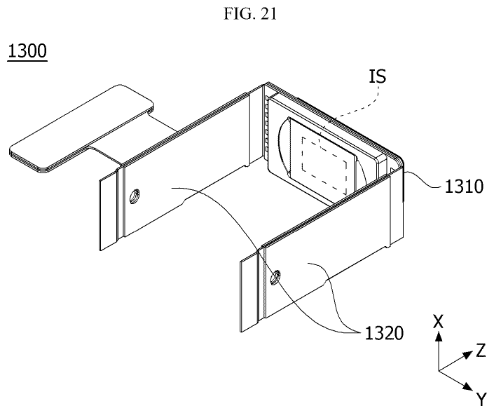

FIG. 21 is a schematic view showing a circuit board according to an embodiment.

Referring to FIG. 21, the circuit board 1300 according to an embodiment as described above may include a first circuit board unit 1310 and a second circuit board unit 1320. The first circuit board unit 1310 may be located on the bottom of the base and coupled to the base. In addition, an image sensor IS may be disposed on the first circuit board unit 1310. In addition, the first circuit board unit 1310 and the image sensor IS may be electrically connected. That is, the base may be located at the rear end of the second camera actuator, and the image sensor and the circuit board (first circuit board unit) may be located at the rear end of the base. The base may include a filter (e.g., infrared or the like).

In addition, the second circuit board unit 1320 may be located on the side unit of the base. In particular, the second circuit board unit 1320 may be located on the first side unit of the base. Accordingly, the second circuit board unit 1320 may be located to be adjacent to the fourth coil, which is located adjacent to the first side unit, so that electrical connection may be made easily. In addition, the second circuit board unit 1320 may be located on the second side unit. In this way, the second circuit board unit 1320 may be provided in plurality. However, it is not limited thereto, and may be located on only any one of the first side unit and the second side unit.

In addition, the circuit board 1300 may additionally include a fixed substrate (not shown) located on the side surface. Accordingly, although the circuit board 1300 is made of a flexible material, it may be coupled to the base while maintaining rigidity by the fixed substrate.

The second circuit board unit 1320 of the circuit board 1300 may be located on the side unit of the second driving unit 1250. The circuit board 1300 may be electrically connected to the first driving unit and the second driving unit. For example, the electrical connection may be made by SMT. However, the present invention is not limited to this method.

The circuit board 1300 may include circuit boards having wiring patterns that can be connected electrically, such as a rigid printed circuit board (rigid PCB), a flexible printed circuit board (flexible PCB), and a rigid flexible printed circuit board (rigid flexible PCB), but it is not limited to these types.

In addition, the circuit board 1300 may be electrically connected to other camera modules inside the terminal or a processor of the terminal. Through this, the camera actuator described above and the camera device including the same may transmit and receive various signals within the terminal.

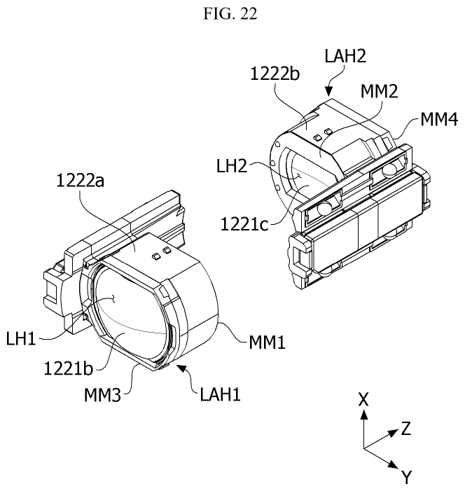

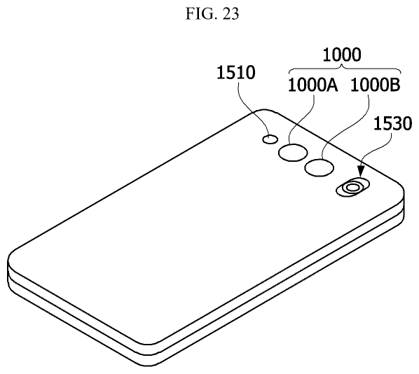

FIG. 22 is a perspective view showing a first lens assembly, a first bonding member, a second bonding member, and a second lens assembly according to an embodiment.

Referring to FIG. 22, the first lens assembly 1222a and the second lens assembly 1222b may be disposed to be spaced apart from each other in the optical axis direction (Z-axis direction). In addition, the first lens assembly 1222a and the second lens assembly 1222b may move along the optical axis direction (Z-axis direction) by the second driving unit. For example, an auto-focusing or zooming function may be performed by the movement of the first lens assembly 1222a and the second lens assembly 1222b.

In addition, the first lens assembly 1222a may include a first lens holder LAH1 that holds and combines the second lens group 1221b. The first lens holder LAH1 may be coupled to the second lens group 1221b. In addition, the first lens holder LAH1 may include a first lens hole LH1 for accommodating the second lens group 1221b. That is, the second lens group 1221b including at least one lens may be disposed in the first lens hole LH1. The first lens holder LAH1 is the same as the accommodation unit (e.g., the first accommodation unit, the second accommodation unit) described below, and is interchangeably used.

In addition, the second lens assembly 1222b may include a second lens holder LAH2 that holds and combines the third lens group 1221c. In addition, the second lens holder LAH2 may include a second lens hole LH2 for accommodating the third lens group 1221c. That is, at least one lens may be disposed in the second lens hole LH2.

As an embodiment, the first lens assembly 1222a and the second lens assembly 1222b may include outer side surfaces adjacent to each other. The first lens assembly 1222a may include a first outer side surface MM1, and the second lens assembly 1222b may include a second outer side surface MM2. The first outer side surface MM1 may be the bottom surface of the first lens holder LAH1 with respect to the optical axis direction (Z-axis direction). In addition, the third outer side surface MM3 described below may be the top surface of the first lens holder LAH1. In addition, the second outer side surface MM2 may be the top surface of the second lens holder LAH2, and the fourth outer side surface MM4 may be the bottom surface of the second lens holder LAH2.

In addition, the first outer side surface MM1 may be at least partially overlapped with the second outer side surface MM2 in the optical axis direction (Z-axis direction). As an embodiment, the first to fourth outer side surfaces MM1 to MM4 may be at least partially overlapped with each other in the optical axis direction (Z-axis direction).

For example, the bonding member (not shown) may be in contact with at least one among the first outer side surface MM1 and the second outer side surface MM2.

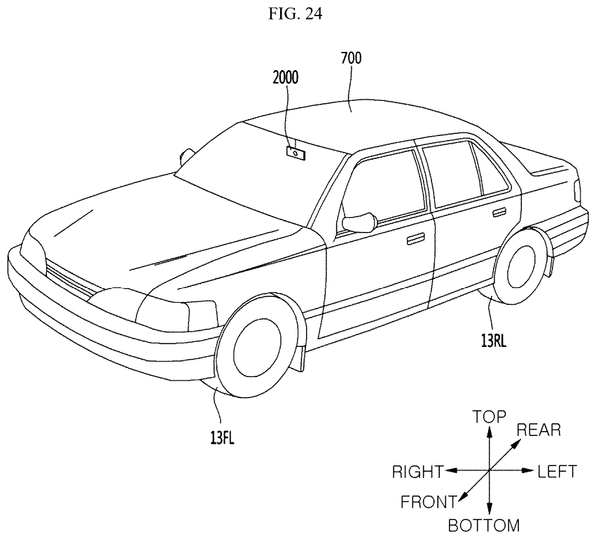

FIG. 23 is a perspective view showing a mobile terminal to which a camera module according to an embodiment is applied.

As shown in FIG. 23, the mobile terminal 1500 of the embodiment may include a camera module 1000, a flash module 1530, and an auto-focusing device 1510 provided on the rear side.

The camera module 1000 may include an image capturing function and an auto-focusing function. For example, the camera module 1000 may include an auto-focusing function using an image.

The camera module 1000 processes still or moving image frames obtained by an image sensor in a shooting mode or a video call mode.

The processed image frame may be displayed on a predetermined display unit and stored in the memory. A camera (not shown) may also be disposed on the front side of the mobile terminal body.

For example, the camera module 1000 may include a first camera module 1000A and a second camera module 1000B, and OIS may be implemented together with the AF or zooming function by the first camera module 1000A.

The flash module 1530 may include a light-emitting element that emits light inside thereof. The flash module 1530 may be operated by the camera operation of the mobile terminal or by control of a user.

The auto-focusing device 1510 may include one of a package of a surface-emitting laser device as a light-emitting unit.

The auto-focusing device 1510 may include an auto-focusing function using a laser. The auto-focusing device 1510 may be mainly used in a condition where the auto-focusing function using an image of the camera module 1000 is degraded, such as proximity capturing in less than 10 m or a dark environment.

The auto-focusing device 1510 may include a light emitting unit having a vertical cavity surface emitting laser (VCSEL) semiconductor device and a light receiving unit that converts light energy into electrical energy, such as a photodiode.

FIG. 24 is a perspective view showing a vehicle to which a camera module according to an embodiment is applied.

For example, FIG. 24 is an exterior view showing a vehicle equipped with a vehicle driving assistance device to which the camera module 1000 according to an embodiment is applied.

Referring to FIG. 24, a vehicle 700 of the embodiment may be equipped with wheels 13FL and 13FR that rotate by a power source, and a predetermined sensor. The sensor may be a camera sensor 2000, but it is not limited thereto.

A camera 2000 may be a camera sensor to which the camera module 1000 according to an embodiment is applied. The vehicle 700 according to the embodiment may acquire image information through the camera sensor 2000 that captures front images or surrounding images, and may determine a situation unable to identify a lane using the image information and generate a virtual lane when the lane is not identified.

For example, the camera sensor 2000 may acquire front images by capturing the front side of the vehicle 700, and a processor (not shown) may acquire image information by analyzing the objects included in the front images.

For example, when objects such as lanes, adjacent vehicles, traffic obstacles, and center dividers, curbs, street trees, and the like corresponding to indirect road markings are acquired from the images captured by the camera sensor 2000, the processor may detect these objects and put them into the image information. At this point, the processor may acquire distance information from the objects detected by the camera sensor 2000, and further supplement the image information.

The image information may be information on the objects captured from the images. The camera sensor 2000 may include an image sensor and an image processing module.

The camera sensor 2000 may process still images or moving images obtained by the image sensor (e.g., CMOS or CCD).

The image processing module may process still images or moving images acquired through the image sensor, extract necessary information, and transfer the extracted information to the processor.

At this point, the camera sensor 2000 may include a stereo camera to improve accuracy of measuring the objects and further secure information such as the distance between the vehicle 700 and the objects, but it is not limited thereto.

Although it has been described focusing on the embodiments, they are only examples and do not limit the present invention. Those skilled in the art will appreciate that various modifications and applications not exemplified above are possible without departing from the essential characteristics of the present invention. For example, each component specifically shown in the embodiments may be implemented by way of modification. In addition, differences related to such modifications and applications should be interpreted as being included in the scope of the present invention defined in the appended claims.

1. A camera actuator comprising:
a housing;
a mover including a holder and an optical member disposed on the holder;
a driving unit configured to move the mover; and
a tilting guide unit disposed between the housing and the mover and configured to guide tilting of the mover, wherein
the housing includes a housing wall unit disposed on a side unit corresponding to a light-emitting surface of the optical member,
the optical member changes a path of light from a first direction to a second direction, and
the housing wall unit is at least partially overlapped with the holder along the second direction.

2. The camera actuator according to claim 1, comprising:
a first magnetic body disposed in the housing; and
a second magnetic body disposed to face the first magnetic body, wherein
the tilting guide unit is pressed toward the mover by a repulsive force of the first magnetic body and the second magnetic body.

3. The camera actuator according to claim 2, wherein the housing includes a first member disposed on one side; the mover includes a second member penetrating the first member; and the tilting guide unit is disposed between the first member and the mover.

4. The camera actuator according to claim 3, wherein the first member includes a second groove located on an outer side surface, the second member includes a first groove facing the second groove, the first magnetic body is disposed in the second groove, and the second magnetic body is disposed in the first groove.

5. The camera actuator according to claim 4, wherein the second magnetic body, the first magnetic body, and the tilting guide unit are sequentially disposed along the second direction.

6. The camera actuator according to claim 4, wherein a distance between the first magnetic body and the second magnetic body is larger than a distance between the holder and the housing wall unit.

7. The camera actuator according to claim 4, comprising a plate disposed on an outer side of the first member.

8. The camera actuator according to claim 7, wherein an area of the plate is larger than an area of the first member or an area of the second member, and the plate is a non-magnetic body.

9. The camera actuator according to claim 7, wherein the plate is a magnetic body, and the second magnetic body has a polarity the same as that of the first magnetic body on a side facing the first magnetic body, and has a polarity different from that of the plate on a side facing the plate.

10. The camera actuator according to claim 1, wherein the housing wall unit is not overlapped with the optical member along the second direction.

11. The camera actuator according to claim 1, wherein the driving unit includes a first magnet, a second magnet facing the first magnet, and a third magnet disposed between the second magnet and the second magnet.

12. The camera actuator according to claim 1, wherein the housing wall unit is overlapped with at least one among the first magnet and the second magnet along the second direction.

13. The camera actuator according to claim 3, wherein the housing wall unit is not overlapped with the second member in the second direction.

14. The camera actuator according to claim 3, wherein the housing wall unit includes a housing extension unit extended to a top of the holder.

15. The camera actuator according to claim 14, wherein a distance between the housing extension unit and the holder is smaller than a distance between the first member and the second member.

16. The camera actuator according to claim 3, wherein, when the housing wall unit is in contact with the holder, the first member is separated from the second member.

17. The camera actuator according to claim 11, wherein the holder includes a first holder outer side surface adjacent to the first magnet and a second holder outer side surface adjacent to the second magnet, and the housing wall unit is overlapped with the first holder outer side surface or the second holder outer side surface in the second direction.

18. The camera actuator according to claim 4, wherein the housing wall unit is not overlapped with the first magnetic body and the second magnetic body in the second direction.

19. A camera actuator comprising:
a housing;
a mover including a holder and an optical member disposed on the holder;
a driving unit configured to move the mover; and
a tilting guide unit disposed between the housing and the mover and configured to guide tilting of the mover,
wherein the housing includes a first member disposed on one side,
wherein the mover includes a second member penetrating the first member,
wherein the camera actuator comprises a plate disposed in the first member,
wherein the camera actuator comprises a first magnetic body disposed in the first member; and a second magnetic body disposed in the second member to face the first magnetic body, and
wherein the tilting guide unit is pressed toward the mover by a repulsive force of the first magnetic body and the second magnetic body.

20. The camera actuator according to claim 19,
wherein the plate is adjacent to the second magnetic body rather than the first magnetic body, and forms an attractive force with the second magnetic body.
